(19) United States
(12) Patent Application Publication
(10) Pub. No.: US 2024/0384130 A1
(43) Pub. Date: Nov. 21, 2024

(54) COATED ARTICLES, METHODS OF MAKING COATED ARTICLES, AND METHODS OF MAKING COMPOSITIONS

(71) Applicant: CORNING INCORPORATED, CORNING, NY (US)

(72) Inventors: HUAYUN DENG, PAINTED POST, NY (US); MINGQIAN HE, HORSEHEADS, NY (US); JENNY KIM, SUNNYVALE, CA (US); LINGKE LI, SHANGHAI (CN); XIN LI, SHANGHAI (CN); YANG LI, PAINTED POST, NY (US); JENNIFER LYNN LYON, WATKINS GLEN, NY (US); KEVIN ROBERT MCCARTHY, HORSEHEADS, NY (US); WEIJUN NIU, PAINTED POST, NY (US); ARTHUR LAWRENCE WALLACE, PAINTED POST, NY (US); HONGXIANG WANG, SHANGHAI (CN); ARLIN LEE WEIKEL, MANSFIELD, PA (US); YING ZHANG, HORSEHEADS, NY (US)

(21) Appl. No.: 18/285,944

(22) PCT Filed: Apr. 6, 2022
(86) PCT No.: PCT/US2022/023644

§ 371 Date: Oct. 6, 2023

Related U.S. Application Data
(60) Provisional application No. 63/299,052, filed on Jan. 13, 2022.
(60) Provisional application No. 63/277,625, filed on Nov. 10, 2021.
(60) Provisional application No. 63/172,250, filed on Apr. 8, 2021.

(51) Int. Cl. C09D 183/08; C08G 77/26; C08G 77/46

(52) U.S. Cl. CPC C09D 183/08; C08G 77/26; C08G 77/46

(57) ABSTRACT

Coated articles can comprise a coating disposed over a first major surface of a substrate. The coating comprises a plurality of functionalized oligomeric silsesquioxanes and a pencil hardness of about 5H or more. In aspects, the coating comprises a linker terminated with a first functional group and a second functional group. In aspects, the coating comprises a silane coupling agent attaching the coating to the first major surface. Methods of making a coated article comprise depositing a layer comprise a plurality of functionalized oligomeric silsesquioxanes over a first major surface of a substrate and curing the layer to form the coating. Methods of forming a composition comprise reacting a plurality of functionalized oligomeric silsesquioxanes with a linker terminated with a first functional group at a first end of the linker and a second functional group at a second end of the linker opposite the first end of the linker.

This application claims the benefit of priority under 35 U.S.C. § 119 of U.S. Provisional Application Ser. No. 63/299,052 filed on Jan. 13, 2022, U.S. Provisional Application Ser. No. 63/277,625 filed on Nov. 10, 2021 and U.S. Provisional Application Ser. No. 63/172,250 filed on Apr. 8, 2021, the contents of each of which are relied upon and incorporated herein by reference in their entireties.

### FIELD

The present disclosure relates generally to coated articles, methods of making coated articles, and methods of making compositions and, more particularly, to coated articles and methods of making the same comprising a pencil hardness and methods of making a composition comprising a plurality of functionalized oligomeric silsesquioxanes.

### BACKGROUND

Foldable substrates are commonly used, for example, in display applications, for example, liquid crystal displays (LCDs), electrophoretic displays (EPD), organic light-emitting diode displays (OLEDs), plasma display panels (PDPs), or the like.

It is known to provide coating comprising organic materials on portions of foldable displays and/or foldable protective covers. For example, such organic materials can provide antibacterial, easy-to-clean, and/or hydrophilic functionality. However, organic coatings can have durability issues, for example, being susceptible to abrasion and/or hardness.

There is a desire to develop foldable displays as well as foldable protective covers to mount on foldable displays. Foldable displays and foldable covers should have good impact and puncture resistance. At the same time, foldable displays and foldable covers should have small minimum bend radii (e.g., about 10 millimeters (mm) or less).

Consequently, there is a need to develop coatings and coated articles comprising a coating and a substrate (e.g., glass-based substrates, ceramic-based substrates) for display apparatus and/or foldable apparatus that have high transparency, low haze, low minimum bend radii, and good impact and puncture resistance.

### SUMMARY

There are set forth herein compositions, coatings, and coated articles comprising a plurality of functionalized oligomeric silsesquioxanes and methods of making the same. The coated articles can function as foldable substrates and the coatings and/or coated articles can be incorporated into foldable displays. The plurality of functionalized oligomeric silsesquioxanes can provide good scratch resistance and/or a high pencil hardness (e.g., about 5H or more, about 7H or more, about 9H or more). Providing the plurality of functionalized oligomeric silsesquioxanes can react with the first functional group and/or the second functional group of a linker (e.g., polymer). An extent of functionalization of plurality of the functionalized oligomeric silsesquioxanes can facilitate the bonding of the polymer to two different functionalized oligomeric silsesquioxanes of the plurality of functionalized oligomeric silsesquioxanes. Providing the coating on a substrate increases a durability of the coated article, for example, by filling and/or protecting surface flaws in the substrate from damage. Additionally, the substrate may comprise a glass-based substrate and/or a ceramic-based substrate to enhance a puncture resistance and/or an impact resistance. Further, the glass-based substrate and/or ceramic-based substrate may be chemically strengthened to further enhance impact resistance and/or puncture resistance of the coated article while simultaneously facilitating good bending performance.

Compositions can comprise a linker (e.g., polymer) with functional groups at opposite ends of the polymer, where the functional groups reacted with functionalized oligomeric silsesquioxanes. The linker can comprise a polymer, which can reduce (e.g., prevent) aggregation of the plurality of functionalized oligomeric silsesquioxanes, which can provide good optical properties (e.g., high transmittance, low haze) and, as a coating, good durability and/or good adhesion to a substrate. Providing a linker (e.g., polymer) comprising an oxygen atom in a backbone of the linker (e.g., polymer) can increase a flexibility of the linker, the resulting composition, and the resulting coating, which can increase the ultimate elongation, durability, and/or impact resistance (e.g., pen drop height). Providing a linker comprising a polymer with a number-average molecular weight (Mn) in a range from about 400 Daltons to about 30,000 Daltons can prevent agglomeration of the functionalized oligomeric silsesquioxanes attached thereto while reducing entanglement of the polymers, which can inhibit manufacturability of the resulting coating and/or coated article. Providing a low mol ratio (e.g., about 0.06 or less) of the linker (e.g., polymer) to the plurality of functionalized oligomeric silsesquioxanes can produce polymers bonded to two functionalized oligomeric silsesquioxanes, which can achieve the benefits described above. Providing a polymer with a glass transition temperature outside of an operating range (e.g., outside of an operating range from about −20° C. to about 60°) of a coated article can enable the coated article to have consistent properties across the operating range. Providing a reactive diluent (e.g., linker not bonded to a functionalized oligomeric silsesquioxane until curing after the composition is disposed on the substrate) can be used to tune a viscosity of the composition, which can facilitate even application and/or enable lower-cost application techniques while reducing the overall cost of the composition and/or coating.

Providing a linker comprising one or more amine and/or anhydride functional groups can provide a coating with good adhesion (e.g., about 4B or more as formed; about 4B or more after being maintained for 10 days in a 50% relative humidity, 25° C. environment; and/or about 4B or more after being maintained from 10 days in a 95% relative humidity, 65° C. environment) to the substrate whether or not a silane coupling agent is used. Providing curing catalyst can increase a hardness of the resulting coating. Providing a composition comprising trimethylolpropane oxetane can increase a hardness of the resulting coating. Coatings can be hydrophobic, have a low dynamic coefficient of friction (i.e., about 0.8 or less, for example, about 0.5 or less), good abrasion resistance, and/or function as an easy to clean (ETC) coating.

Forming the layer from a substantially solvent-free composition can increase its curing rate, which can decrease processing time. Further, a solvent-free composition can reduce (e.g., decrease, eliminate) the use of rheology modifiers and increase composition homogeneity, which can increase the optical transparency (e.g., transmittance) of the resulting coating. Providing a coating method comprising a solvent can enable a wide variety of compositions to be used to form the coating. Further, curing the layer to form the coating by irradiating the layer for a short period of time, which can increase processing efficiency and reduce manufacturing costs. Moreover, a solvent-free composition can decrease an incidence of visual defects, for example bubbles from volatile gases as any solvent evaporates, in the resulting coating. Providing additional functionalized oligomeric silsesquioxanes with the composition to form the layer can further increase the hardness of the resulting coating and/or coated article. Providing compositions free from a photoinitiator (e.g., thermally curable compositions) can be free from yellowing issues. Providing a silane-coupling agent can increase an adhesion of the coating to the substrates (e.g., glass-based substrate, polymer-based substrate). Additionally, the coating can comprise high transmittance (e.g., about 90% or more), low haze (e.g., about 0.5% or less), and/or low yellowing index (e.g., about 0.6 or less). Providing a composition substantially free and/or free of nanoparticles (e.g., silica nanoparticles, alumina nanoparticles) can reduce processing issues (e.g., agglomeration, aggregation, phase separation) with the composition, improve optical properties (e.g., maintain low haze and/or high transmittance even after aging at elevated temperature and/or humidity) of the coating and/or the resulting coating and/or coated article, and reduce mechanical properties (e.g., hardness, modulus, strain) of the resulting coating and/or coated article compared to a corresponding composition, coating, and/or coated article comprising a plurality of functionalized oligomeric silsesquioxanes without nanoparticles (e.g., silica nanoparticles, alumina nanoparticles).

Some example aspects of the disclosure are described below with the understanding that any of the features of the various aspects may be used alone or in combination with one another.
Aspect 1. A coated article comprising:
a substrate comprising a first major surface; and
a coating disposed over the first major surface comprising a plurality of functionalized oligomeric silsesquioxanes, a first functionalized oligomeric silsesquioxane of the plurality of functionalized oligomeric silsesquioxanes is bonded to a second functionalized oligomeric silsesquioxane of the plurality of functionalized oligomeric silsesquioxanes by a linker terminated with a first functional group at a first end of the linker and a second functional group at a second end of the linker opposite the first end of the linker,
wherein the coating comprises a pencil hardness of about 5H or more.
Aspect 2. The coated article of aspect 1, further comprising a silane coupling agent attaching the coating to the first major surface.
Aspect 3. The coated article of aspect 2, wherein the silane coupling agent is selected from a group consisting of (3-triethoxysilyl)propylsuccinic anhydride, (3-mercaptopropyl)trimethoxysilane, and 2-(3,4-epoxycyclohexyl)ethyltrimethoxysilane.
Aspect 4. The coated article of any one of aspects 1-3, wherein the coating comprises an adhesion to the substrate of about 1B or more after 10 days in a 95% relative humidity, 65° C. environment.
Aspect 5. A coated article comprises a substrate comprising:
a substrate comprising a first major surface;
a coating disposed over the first major surface comprising a plurality of functionalized oligomeric silsesquioxanes includes a first functionalized oligomeric silsesquioxane and a second functionalized oligomeric silsesquioxane; and
a silane coupling agent attaching the coating to the first major surface, the silane coupling agent is selected from a group consisting of a (3-triethoxysilyl)propylsuccinic anhydride, (3-mercaptopropyl)trimethoxysilane, and 2-(3,4-epoxycyclohexyl)ethyltrimethoxysilane,
wherein the coating comprises an adhesion to the substrate of about 1B or more after 10 days in a 95% relative humidity, 65° C. environment, and the coating comprises a pencil hardness of about 5H or more.
Aspect 6. The coated article of aspect 5, wherein the first functionalized oligomeric silsesquioxane is bonded to the second functionalized oligomeric silsesquioxane by a linker terminated with a first functional group at a first end of the linker and a second functional group at a second end of the linker opposite the first end of the linker.
Aspect 7. The coated article of any one of aspects 4-6, wherein the adhesion of the coating to the substrate is about 3B or more after 10 days in the 95% relative humidity, 65° C. environment.
Aspect 8. The coated article of any one of aspects 1-4 or 6 inclusive, wherein the first functional group is the same as the second functional group.
Aspect 9. The coated article of any one of aspects 1-4, 6, or 8 inclusive, wherein the first functional group is selected from a group consisting of alcohols, acrylates, epoxies, and ureidos, and the second functional group is selected from a group consisting of alcohols, acrylates, epoxies, and ureidos.
Aspect 10. The coated article of any one of aspects 1-4, 6, or 8 inclusive, wherein the first functional group is selected from a group consisting of acid alcohols, anhydrides, amides, amines, alcohols, chlorides, cyanides, epoxies, thiols, and magnesium halides, and/or the second functional group is selected from a group consisting of acid alcohols, anhydrides, amides, amines, alcohols, chlorides, cyanides, epoxies, thiols, and magnesium halides.
Aspect 11. The coated article of aspect 10, wherein the first functional group and/or the second functional group comprise an amine.
Aspect 12. The coated article of aspect 11, wherein the first functional group and/or the second functional group comprise an aminopropyl functional group.
Aspect 13. The coated article of aspect 10, wherein the first functional group and/or the second functional group comprises an epoxy.
Aspect 14. The coated article of aspect 10, wherein the first functional group and/or the second functional group comprises an anhydride.
Aspect 15. The coated article of any one of aspects 13-14, wherein the coating further comprises a curing catalyst comprising a tertiary amine or an imidazole.
Aspect 16. The coated article of aspect 15, wherein the curing catalyst comprises 2,4,6-tris(dimethylaminoethyl)phenol.
Aspect 17. The coated article of any one of aspects 15-16, wherein the coating comprises the curing catalyst in an amount from about 0.3 wt % to about 1.1 wt %.
Aspect 18. The coated article of any one of aspects 13-17, wherein the coating further comprises trimethylolpropane oxetane in an amount from about 5 wt % to about 30 wt %.
Aspect 19. The coated article of aspect 18, wherein a ratio of an amount of the linker in wt % to the amount of trimethylolpropane oxetane in wt % is in a range from about 1 to about 3.3.
Aspect 20. The coated article of any one of aspects 13-19, wherein the linker comprises a plurality of linkers, a ratio of the plurality of linkers on a mol basis to the plurality of functionalized oligomeric silsesquioxanes on a mol basis is in a range from about 0.6 to about 1.0.
Aspect 21. The coated article of any one of aspects 1-4, 6, or 8-19 inclusive, wherein the linker comprises a plurality of linkers, a ratio of the plurality of linkers on a mol basis to the plurality of functionalized oligomeric silsesquioxanes on a mol basis is about 0.06 or less.
Aspect 22. The coated article of any one of aspects 1-4, 6, or 8-21 inclusive, wherein the coating comprises the linker in an amount from about 15 wt % to about 50 wt %.
Aspect 23. The coated article of any one of aspects 1-4, 6, or 8-22 inclusive, wherein a backbone of the linker comprises an oxygen atom.
Aspect 24. The coated article of any one of aspects 1-4, 6, or 8-22 inclusive, wherein the linker comprises a polymer.
Aspect 25. The coated article of aspect 24, wherein the first functional group and/or the second functional group is different than a normal terminal functional group of the polymer.
Aspect 26. The coated article of any one of aspects 24-25, wherein the polymer is substantially free of urethanes, acrylates, and/or polycarbonates.
Aspect 27. The coated article of any one of aspects 24-26, wherein the polymer comprises an oxygen atom in a backbone of the polymer. The oxygen atom is in a plurality of monomers of the polymer.
Aspect 28. The coated article of any one of aspects 24-27, wherein the polymer comprises poly(dimethylsiloxane) and/or poly(propylene oxide).
Aspect 29. The coated article of any one of aspects 24-28, wherein the polymer comprises a number average molecular weight in a range from about 400 Daltons to about 30,000 Daltons.
Aspect 30. The coated article of any one of aspects 1-29, wherein the plurality of functionalized oligomeric silsesquioxanes comprises a plurality of functionalized polyhedral oligomeric silsesquioxanes (POSS), the first functionalized oligomeric silsesquioxane comprises a first functionalized POSS of the plurality of functionalized POSS, and the second functionalized oligomeric silsesquioxane comprises a second functionalized POSS of the plurality of functionalized POSS.
Aspect 31. The coated article of any one of aspects 1-30, wherein the first functionalized oligomeric silsesquioxane and/or the second functionalized oligomeric silsesquioxane is functionalized by a glycidyl functional group or an epoxycyclohexyl functional group.
Aspect 32. The coated article of aspect 31, wherein the glycidyl functional group comprises a 3-glycidyloxypropyl functional group.
Aspect 33. The coated article of any one of aspects 1-32, wherein the pencil hardness of the coating is about 9H.
Aspect 34. The coated article of any one of aspects 1-33, wherein the coating comprises an average transmittance of about 90% or more averaged over optical wavelengths in a range from 400 nanometers to 700 nanometers.
Aspect 35. The coated article of aspect 34, wherein the average transmittance of the coating is in a range from about 92% to about 94%.
Aspect 36. The coated article of any one of aspects 1-35, wherein the coating comprises a haze of about 0.5% or less.
Aspect 37. The coated article of aspect 36, wherein the haze of the coating is in a range from about 0.1% to about 0.3%.
Aspect 38. The coated article of any one of aspects 1-37, wherein the coating is substantially free of crystals visible under 100× magnification.
Aspect 39. The coated article of any one of aspects 1-38, wherein the coating is substantially free of fluorine-based compounds.
Aspect 40. The coated article of any one of aspects 1-39, wherein the coating further comprises silica nanoparticles and/or alumina nanoparticles.
Aspect 41. The coated article of any one of aspects 1-39, wherein the coating is free of nanoparticles.
Aspect 42. The coated article of any one of aspects 1-41, wherein the coating further comprises a third functionalized oligomeric silsesquioxane of the plurality of functionalized oligomeric silsesquioxanes directly bonded to a fourth functionalized oligomeric silsesquioxane of the plurality of functionalized oligomeric silsesquioxanes.
Aspect 43. The coated article of any one of aspects 1-42, wherein a contact angle of deionized water on the coating is in a range from about 650 to about 1100.
Aspect 44. The coated article of aspect 43, wherein the contact angle is in a range from about 90° to about 105°.
Aspect 45. The coated article of any one of aspects 1-44, wherein a dynamic coefficient of friction of the coating is in a range from about 0.3 to about 0.8.
Aspect 46. The coated article of aspect 45, wherein the dynamic coefficient of friction is in a range from about 0.3 to about 0.5.
Aspect 47. The coated article of any one of aspects 1-46, wherein the coating comprises a yellowing index of about 0.6 or less.
Aspect 48. The coated article of aspect 47, wherein the yellowing index of the coating is in a range from about 0.45 to about 0.55.
Aspect 49. The coated article of any one of aspects 1-48, wherein the coated article withstands 10 days in a 95% relative humidity, 65° C. environment without visible delamination or visible cracking.
Aspect 50. The coated article of any one of aspects 1-49, wherein the coating comprises a Young's modulus of about 500 MegaPascals or more.
Aspect 51. The coated article of aspect 50, wherein the Young's modulus of the coating is in a range from about 800 MPa to about 2,000 MPa.
Aspect 52. The coated article of any one of aspects 1-51, wherein the coating comprises a tensile strength of about 2 MegaPascals or more.
Aspect 53. The coated article of any one of aspects 1-52, wherein the coating comprises an ultimate elongation of about 3% or more.
Aspect 54. The coated article of aspect 53, wherein the ultimate elongation of the coating is in a range from about 4% to about 20%.
Aspect 55. The coated article of any one of aspects 1-54, wherein the coating comprises a third major surface facing the first major surface and a fourth major surface opposite the third major surface, a coating thickness defined between the third major surface and the fourth major surface is in a range from about 1 micrometer to about 200 micrometers.
Aspect 56. The coated article of aspect 55, wherein the coating thickness is in a range from about 3 micrometers to about 30 micrometers.
Aspect 57. The coated article of any one of aspects 1-56, wherein the substrate comprises a glass-based substrate and/or a ceramic-based substrate.
Aspect 58. The coated article of any one of aspects 1-57, wherein the substrate comprises a substrate thickness measured between the first major surface and a second major surface opposite the first major surface. The substrate thickness is in a range from about 25 micrometers to about 300 micrometers.
Aspect 59. The coated article of aspect 58, wherein the coated article achieves a parallel plate distance in a range from about 3 millimeters to about 10 millimeters.
Aspect 60. The coated article of aspect 58, wherein the coated article achieves a parallel plate distance of 4 millimeters.
Aspect 61. The coated article of any one of aspects 58-60, wherein the coated article can withstand a pen drop from a height of 15 centimeters.
Aspect 62. A method of making a coated article comprising: depositing a layer comprising a plurality of functionalized oligomeric silsesquioxanes over a first major surface of a substrate, a first functionalized oligomeric silsesquioxane of the plurality of functionalized oligomeric silsesquioxanes is bonded to a second functionalized oligomeric silsesquioxane of the plurality of functionalized oligomeric silsesquioxanes by a linker terminated with a first functional group at a first end of the linker and a second functional group at a second end of the linker opposite the first end of the linker; and curing the layer to form the coating.
Aspect 63. The method of aspect 62, wherein the first functional group is selected from a group consisting of acid alcohols, anhydrides, amides, amines, alcohols, chlorides, cyanides, epoxies, thiols, and magnesium halides, and the second functional group is selected from a group consisting of acid alcohols, anhydrides, amides, amines, alcohols, chlorides, cyanides, epoxies, thiols, and magnesium halides.
Aspect 64. The method of aspect 63, wherein the first functional group and/or the second functional group comprises an amine.
Aspect 65. The method of aspect 64, wherein the first functional group and/or the second functional group comprises an aminopropyl functional group.
Aspect 66. The method of any one of aspects 62-65, wherein the first functional group is the same as the second functional group.
Aspect 67. The method of any one of aspects 62-66, wherein the plurality of functionalized oligomeric silsesquioxanes comprises another functionalized oligomeric silsesquioxane that is not bonded to the linker, the first major surface, or another functionalized oligomeric silsesquioxane of the plurality of functionalized oligomeric silsesquioxanes prior to the curing.
Aspect 68. The method of any one of aspects 62-67, wherein the layer comprises a reactive diluent. The reactive diluent reacts with another functionalized oligomeric silsesquioxane of the plurality of functionalized silsesquioxanes during the curing.
Aspect 69. The method of aspect 68, wherein the reactive diluent comprises a third functional group and a fourth functional group, and the linker is bonded to a functionalized oligomeric silsesquioxane of the plurality of functionalized oligomeric silsesquioxanes by the third functional group.
Aspect 70. A method of making a coated article comprising:
depositing a layer over a first major surface of a substrate, the layer comprising a plurality of functionalized oligomeric silsesquioxanes and a linker, the linker comprising a reactive diluent; and
curing the layer to form the coating, wherein the linker reacts with the plurality of functionalized oligomeric silsesquioxanes to bond a first functionalized oligomeric silsesquioxane of the plurality of functionalized oligomeric silsesquioxanes to a second functionalized oligomeric silsesquioxane of the plurality of functionalized silsesquioxanes, the linker comprising a third functional group bonded to the first functionalized oligomeric silsesquioxane and a fourth functional group bonded to a second functionalized oligomeric silsesquioxane.
Aspect 71. The method of any one of aspects 69-70, wherein the third functional group is selected from a group consisting of acid alcohols, acrylates, anhydrides, alcohols, epoxies, isocyanates, and ureidos, and/or the fourth functional group is selected from a group consisting of acid alcohols, acrylates, anhydrides, alcohols, epoxies, isocyanates, and ureidos.
Aspect 72. The method of any one of aspects 69-71, wherein the third functional group is the same as the fourth functional group.
Aspect 73. The method of any one of aspects 68-72, wherein the reactive diluent comprises three or more reactive functional groups.
Aspect 74. The method of any one of aspects 68-73, wherein the layer comprises the reactive diluent in an amount from about 15 wt % to about 50 wt %.
Aspect 75. The method of any one of aspects 62-74, wherein the curing the layer comprises impinging the layer with radiation, the layer further comprises a photoinitiator.
Aspect 76. The method of aspect 75, wherein the photoinitiator comprises a cationic photoinitiator.
Aspect 77. The method of aspect 75, wherein the photoinitiator comprises a free radical photoinitiator.
Aspect 78. The method of any one of aspects 75-77, wherein the impinging the material with radiation comprises impinging the material with ultraviolet light with a total energy density in a range from about 2 Joules per centimeter square (J/cm²) to about 15 J/cm².
Aspect 79. The method of any one of aspects 62-78, wherein the depositing the layer comprising depositing particles on the first major surface.
Aspect 80. A method of making a coated article comprising:
depositing a layer over a first major surface of a substrate, the layer comprising a plurality of functionalized oligomeric silsesquioxanes and a linker, the linker terminated with a first functional group at a first end of the linker and a second functional group at a second end of the linker opposite the first end of the linker, the first functional group and the second functional group each selected from a group consisting of amine and anhydride functional groups; and
curing the layer to form the coating, wherein the linker reacts with the plurality of functionalized oligomeric silsesquioxanes to bond a first functionalized oligomeric silsesquioxane of the plurality of functionalized oligomeric silsesquioxanes to a second functionalized oligomeric silsesquioxane of the plurality of functionalized silsesquioxanes.
Aspect 81. The method of aspect 80, wherein the coating further comprises a curing catalyst comprising a tertiary amine or an imidazole.
Aspect 82. The method of aspect 81, wherein the curing catalyst comprises 2,4,6-tris(dimethylaminoethyl)phenol.
Aspect 83. The method of any one of aspects 81-82, wherein the layer comprises the curing catalyst in an amount from about 0.3 wt % to about 1.1 wt %.
Aspect 84. The method of any one of aspects 80-83, wherein the coating further comprises trimethylolpropane oxetane in an amount from about 5 wt % to about 30 wt %.
Aspect 85. The method of aspect 84, wherein a ratio of an amount of the linker in wt % to the amount of trimethylolpropane oxetane in wt % is in a range from about 1 to about 3.3.
Aspect 86. The method of any one of aspects 80-85, wherein the linker comprises a plurality of linkers, a ratio of the plurality of linkers on a mol basis to the plurality of functionalized oligomeric silsesquioxanes on a mol basis is in a range from about 0.6 to about 1.0.
Aspect 87. The method of any one of aspects 62-74 or 80-86 inclusive, wherein the layer comprises a viscosity in a range from about 0.01 Pascals-seconds to about 6 Pascal-seconds.
Aspect 88. The method of any one of aspects 62-74 or 80-87 inclusive, wherein the depositing the layer comprises spin coating.
Aspect 89. The method of any one of aspects 62-74 or 80-88 inclusive, wherein the depositing the layer comprising drawing an applicator bar across the first major surface.
Aspect 90. The method of any one of aspects 62-74 or 80-89 inclusive, wherein the curing the layer comprises heating the layer.
Aspect 91. The method of aspect 90, wherein heating the layer comprising heating the layer at a temperature in a range from about 60° C. to about 150° C. for a period of time in a range from about 30 minutes to about 8 hours.
Aspect 92. The method of aspect 90, wherein heating the layer comprising heating the layer at a temperature in a range from about 75° C. to about 250° C. for a period of time in a range from about 15 minutes to about 4 hours.
Aspect 93. The method of aspect 90, wherein the heating the layer comprises heating the layer at a temperature in a range from about 100° C. to about 175° C. for a period of time in a range from about 15 minutes to about 120 minutes.
Aspect 94. The method of any one of aspects 62-93, wherein the plurality of functionalized oligomeric silsesquioxanes comprises a plurality of functionalized polyhedral oligomeric silsesquioxanes (POSS), the first functionalized oligomeric silsesquioxane comprises a first functionalized POSS of the plurality of functionalized POSS, and the second functionalized oligomeric silsesquioxane comprises a second functionalized POSS of the plurality of functionalized POSS.
Aspect 95. The method of any one of aspects 62-94, wherein the first functionalized oligomeric silsesquioxane and/or the second functionalized oligomeric silsesquioxane is functionalized by a glycidyl functional group or an epoxycyclohexyl functional group.
Aspect 96. The method of aspect 95, wherein the glycidyl functional group comprises a 3-glycidyloxypropyl functional group.
Aspect 97. The method of any one of aspects 62-96, wherein a backbone of the linker comprises an oxygen atom.
Aspect 98. The method of any one of aspects 62-97, wherein the linker comprises a polymer.
Aspect 99. The method of aspect 98, wherein the polymer comprises an oxygen atom in a backbone of the polymer, and the oxygen atom is in a plurality of monomers of the polymer.
Aspect 100. The method of any one of aspects 98-99, wherein the first functional group and/or the second functional group is different than a normal terminal functional group of the polymer.
Aspect 101. The method of any one of aspects 98-100, wherein the polymer comprises poly(dimethylsiloxane) and/or poly(propylene oxide).
Aspect 102. The method of any one of aspects 98-101, wherein the polymer comprises a number average molecular weight in a range from about 400 Daltons to about 30,000 Daltons.
Aspect 103. The method of any one of aspects 98-102, wherein the polymer is substantially free of urethanes, acrylates, and/or polycarbonates.
Aspect 104. The method of any one of aspects 62-103, wherein the coating is substantially free of fluorine-based compounds.
Aspect 105. The method of any one of aspects 62-104, wherein the coating further comprises silica nanoparticles and/or alumina nanoparticles.
Aspect 106. The method of any one of aspects 62-104, wherein the coating is free of nanoparticles.
Aspect 107. The method of any one of aspects 62-106, wherein the coating further comprises a third functionalized oligomeric silsesquioxane of the plurality of functionalized oligomeric silsesquioxanes directly bonded to a fourth functionalized oligomeric silsesquioxane of the plurality of functionalized oligomeric silsesquioxanes.
Aspect 108. The method of any one of aspects 62-107, further comprising depositing a silane coupling agent on the first major surface prior to the depositing the layer.
Aspect 109. The method of aspect 108, wherein the silane coupling agent comprises a mercapto-functionalized silane.
Aspect 110. The method of any one of aspects 62-109, wherein the layer further comprises a silane coupling agent.
Aspect 111. The method of aspect 108 or aspect 110, wherein the silane coupling agent is selected from a group consisting of (3-triethoxysilyl)propylsuccinic anhydride, (3-mercaptopropyl)trimethoxysilane, and 2-(3,4-epoxycyclohexyl)ethyltrimethoxysilane.
Aspect 112. The method of aspect 108 or aspect 110, wherein the silane coupling agent comprises a functional group selected from a group consisting of epoxy and amine.
Aspect 113. The method of any one of aspects 108-112, wherein the coating comprises an adhesion to the substrate of about 1B or more after 10 days in a 95% relative humidity, 65° C. environment.
Aspect 114. The method of aspect 113, wherein the adhesion of the coating to the substrate is about 3B or more after 10 days in the 95% relative humidity, 65° C. environment.
Aspect 115. The method of any one of aspects 62-114, wherein the coating comprises a pencil hardness of about 5H or more.
Aspect 116. The method of aspect 115, wherein the pencil hardness of the coating is about 9H.
Aspect 117. The method of any one of aspects 62-116, wherein the coating comprises an average transmittance of about 90% or more averaged over optical wavelengths in a range from 400 nanometers to 700 nanometers.
Aspect 118. The method of aspect 117, wherein the average transmittance is a range from about 92% to about 94%.
Aspect 119. The method of any one of aspects 62-118, wherein the coating comprises a haze of about 0.5% or less.
Aspect 120. The method of aspect 119, wherein the haze is in a range from about 0.1% to about 0.3%.
Aspect 121. The method of any one of aspects 62-120, wherein the coating is substantially free of crystals visible under 100× magnification.
Aspect 122. The method of any one of aspects 62-121, wherein a contact angle of deionized water on the coating is in a range from about 65° to about 1100.
Aspect 123. The method of aspect 122, wherein the contact angle is in a range from about 90° to about 105°.
Aspect 124. The method of any one of aspects 62-123, wherein a dynamic coefficient of friction of the coating is in a range from about 0.3 to about 0.8.
Aspect 125. The method of aspect 124, wherein the dynamic coefficient of friction is in a range from about 0.3 to about 0.5.
Aspect 126. The method of any one of aspects 62-125, wherein the coating comprises a yellowing index of about 0.6 or less.
Aspect 127. The method of any one of aspects 62-126, wherein the coated article withstands 10 days in a 95% relative humidity, 65° C. environment without visible delamination or visible cracking.
Aspect 128. The method of any one of aspects 62-127, wherein the coating comprises a Young's modulus of about 500 MegaPascals or more.
Aspect 129. The method of any one of aspects 62-128, wherein the coating comprises a tensile strength of about 2 MegaPascals or more.
Aspect 130. The method of any one of aspects 62-129, wherein the coating comprises an ultimate elongation of about 3% or more.
Aspect 131. The method of any one of aspects 62-130, wherein the coating comprises a third major surface facing the first major surface and a fourth major surface opposite the third major surface, a coating thickness defined between the third major surface and the fourth major surface is in a range from about 1 micrometer to about 200 micrometers.
Aspect 132. The method of aspect 131, wherein the coating thickness is in a range from about 3 micrometers to about 30 micrometers.
Aspect 133. The method of any one of aspects 62-132, wherein the substrate comprises a glass-based substrate and/or a ceramic-based substrate.
Aspect 134. The method of aspect 133, wherein the coated article achieves a parallel plate distance in a range from about 3 millimeters to about 10 millimeters.
Aspect 135. The method of aspect 133, wherein the coated article achieves a parallel plate distance of 4 millimeters.
Aspect 136. The method of any one of aspects 133-135, wherein the coated article can withstand a pen drop from a height of 15 centimeters.
Aspect 137. A method of forming a composition comprising: reacting a plurality of functionalized oligomeric silsesquioxanes with a linker terminated with a first functional group at a first end of the linker and a second functional group at a second end of the linker opposite the first end of the linker, wherein a functionalized portion of a first functionalized oligomeric silsesquioxane of the plurality of functionalized oligomeric silsesquioxanes reacts with the first functional group of the linker, a functionalized portion of a second functionalized oligomeric silsesquioxane of the plurality of functionalized oligomeric silsesquioxanes reacts with the second functional group of the linker.
Aspect 138. The method of aspect 137, wherein the linker comprises a plurality of linkers, a ratio of the plurality of polymers on a mol basis to the plurality of functionalized oligomeric silsesquioxanes on a mol basis is about 0.06 or less.
Aspect 139. The method of aspect 137, wherein the composition comprises the linker in an amount from about 15 wt % to about 50 wt %.
Aspect 140. The method of claim 137, wherein the linker comprises a plurality of linkers, a ratio of the plurality of linkers on a mol basis to the plurality of functionalized oligomeric silsesquioxanes on a mol basis is in a range from about 0.6 to about 1.0.
Aspect 141. The method of any one of aspects 137-140, wherein the reacting is substantially solvent-free.
Aspect 142. The method of any one of aspects 137-140, wherein the reacting further comprises a solvent selected from a group consisting of butyl acetate, propyl acetate, and acetonitrile.
Aspect 143. The method of aspect 142, further comprising removing the solvent after the reacting.
Aspect 144. The method of any one of aspects 137-143, wherein the composition is substantially visually transparent.
Aspect 145. The method of any one of aspects 137-144, wherein the plurality of functionalized oligomeric silsesquioxanes comprises a plurality of functionalized polyhedral oligomeric silsesquioxanes (POSS), the first functionalized oligomeric silsesquioxane comprises a first functionalized POSS of the plurality of functionalized POSS, and the second functionalized oligomeric silsesquioxane comprises a second functionalized POSS of the plurality of functionalized POSS.
Aspect 146. The method of any one of aspects 137-145, wherein the first functionalized oligomeric silsesquioxane and/or the second functionalized oligomeric silsesquioxane is functionalized by a glycidyl functional group.
Aspect 147. The method of aspect 146, wherein the glycidyl functional group comprises a 3-glycidyloxypropyl functional group.
Aspect 148. The method of any one of aspects 137-147, wherein the first functional group is selected from a group consisting of acid alcohols, anhydrides, amides, amines, alcohols, chlorides, cyanides, epoxies, thiols, and magnesium halides, and the second functional group is selected from a group consisting of acid alcohols, anhydrides, amides, amines, alcohols, chlorides, cyanides, epoxies, thiols, and magnesium halides.
Aspect 149. The method of aspect 148, wherein the first functional group and/or the second functional group comprise an amine.
Aspect 150. The method of aspect 149, wherein the first functional group and/or the second functional group comprise an aminopropyl functional group.
Aspect 151. The method of any one of aspects 137-147, wherein the first functional group and/or the second functional group comprises an epoxy.
Aspect 152. The method of any one of aspects 137-147, wherein the first functional group and/or the second functional groups comprises an anhydride.
Aspect 153. The method of any one of aspects 137-152, wherein the coating further comprises a curing catalyst comprising a tertiary amine or an imidazole.
Aspect 154. The method of aspect 153, wherein the curing catalyst comprises 2,4,6-tris(dimethylaminoethyl)phenol.
Aspect 155. The method of any one of aspects 152-154, wherein the composition comprises the curing catalyst in an amount from about 0.3 wt % to about 1.1 wt %.
Aspect 156. The method of any one of aspects 151-155, wherein the coating further comprises trimethylolpropane oxetane in an amount from about 5 wt % to about 30 wt %.
Aspect 157. The method of aspect 156, wherein a ratio of an amount of the linker in wt % to the amount of trimethylolpropane oxetane in wt % is in a range from about 1 to about 3.3.
Aspect 158. The method of aspects 137-157, wherein the first functional group is selected from a group consisting of acid alcohols, acrylates, anhydrides, alcohols, epoxies, isocyanates, and ureidos, and the second functional group is selected from a group consisting of acid alcohols, acrylates, anhydrides, alcohols, epoxies, isocyanates, and ureidos.
Aspect 159. The method of any one of aspects 137-158, wherein the first functional group is the same as the second functional group.
Aspect 160. The method of any one of aspects 137-159, wherein a backbone of the linker comprises an oxygen atom.
Aspect 161. The method of any one of aspects 137-159, wherein the linker comprises a polymer.
Aspect 162. The method of aspect 161, wherein the first functional group and/or the second functional group is different than a normal terminal functional group of the polymer.
Aspect 163. The method of any one of aspects 161-162, wherein the polymer is substantially free of urethanes, acrylates, and/or polycarbonates.
Aspect 164. The method of any one of aspects 161-162, wherein the polymer comprises an oxygen atom in a backbone of the polymer, and the oxygen atom is in a plurality of monomers of the polymer.
Aspect 165. The method of any one of aspects 161-164, wherein the polymer comprises poly(dimethylsiloxane) and/or poly(propylene oxide).
Aspect 166. The method of any one of aspects 161-165, wherein the polymer comprises a number average molecular weight in a range from about 400 Daltons to about 30,000 Daltons.
Aspect 167. The method of any one of aspects 137-166, wherein the coating is substantially free of fluorine-based compounds.
Aspect 168. The method of any one of aspects 137-167, wherein the coating further comprises silica nanoparticles and/or alumina nanoparticles.
Aspect 169. The method of any one of aspects 137-167, wherein the coating is free of nanoparticles.
Aspect 170. The method of any one of aspects 137-169, wherein the coating further comprises a third functionalized oligomeric silsesquioxane of the plurality of functionalized oligomeric silsesquioxanes directly bonded to a fourth functionalized oligomeric silsesquioxane of the plurality of functionalized oligomeric silsesquioxanes.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### BRIEF DESCRIPTION OF THE DRAWINGS

The above and other features and advantages of aspects of the present disclosure are better understood when the following detailed description is read with reference to the accompanying drawings, in which:

FIGS. 1-3 are schematic views of example coated articles in a flat configuration according to aspects, wherein a schematic view of the folded configuration may appear as shown in FIG. 4;

FIG. 4 is a schematic view of an example coated article of aspects of the disclosure in a folded configuration wherein a schematic view of the flat configuration may appear as shown in FIGS. 1-3;

FIGS. 5-7 are cross-sectional views of a testing apparatus to determine the minimum parallel plate distance of example modified coated articles along line 5-5 of FIG. 4;

FIGS. 8-10 schematically show reactions to form a material of a coating and/or a coated article in accordance with aspects of the disclosure;

FIG. 11 is a schematic plan view of an example consumer electronic device according to aspects;

FIG. 12 is a schematic perspective view of the example consumer electronic device of FIG. 11;

FIG. 13 is a flow chart illustrating example methods of making coatings and/or coated articles in accordance with the aspects of the disclosure; and

FIGS. 14-19 schematically illustrate steps in methods of making a coated article in accordance with aspects of the disclosure.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

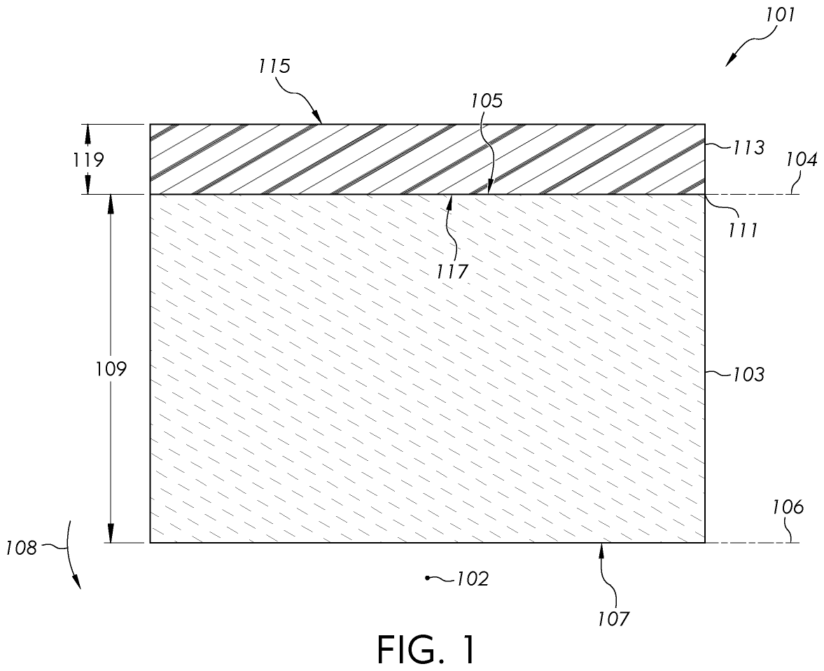

The compositions and/or coatings of aspects of the disclosure can be used, for example, in a coated article 101, 201, 301, 401, 601, and/or 701 illustrated in FIGS. 1-3 and 5-7, respectively. However, it is to be understood that the compositions, coatings, and/or coated articles are not limited to such applications and can be used in other applications. Unless otherwise noted, a discussion of features of aspects of one composition, coating, or coated article can apply equally to corresponding features of any aspect of the disclosure. For example, identical part numbers throughout the disclosure can indicate that, in some aspects, the identified features are identical to one another and that the discussion of the identified feature of one aspect, unless otherwise noted, can apply equally to the identified feature of any other aspect of the disclosure.

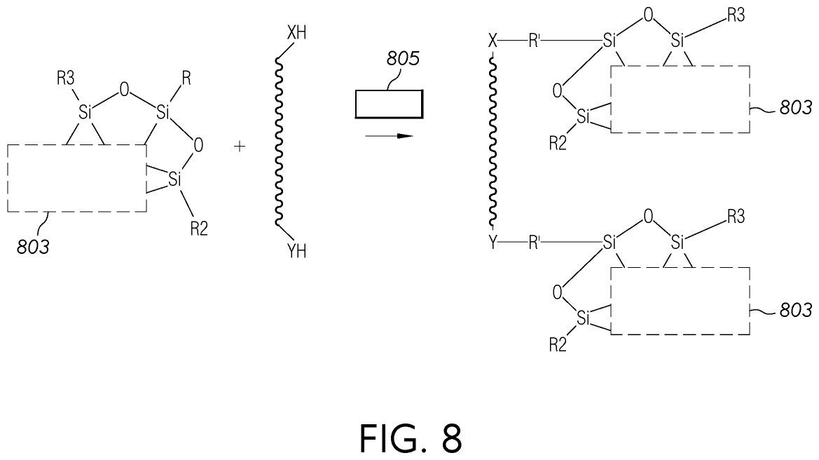

Aspects of the disclosure can comprise compositions. Compositions can comprise a plurality of functionalized oligomeric silsesquioxanes. As used herein a functionalized oligomeric silsesquioxane means an organosilicon compound comprises at least two monomers represented as RSiO_{1.5}, where there are three oxygen atoms with each oxygen atom shared with another monomer bonded thereto and R is a functional group that “functionalizes” an oligomeric silsesquioxane to form the functionalized oligomeric silsesquioxane, although the R of one monomer need not be the same as the R of another monomer. In aspects, a number of the RSiO_{1.5} monomers in the functionalized oligomeric silsesquioxane can be a whole number of 4 or more, 6 or more, 8 or more, 50 or less, 30 or less, 20 or less, 16 or less, about 12 or less, or 10 or less. In aspects, a number of the RSiO_{1.5} monomers in the functionalized oligomeric silsesquioxane can be a whole number in a range from 4 to 50, 4 to 30, 4 to 20, 6 to 20, 6 to 16, 6 to 12, 8 to 12, 8 to 10, or any range or subrange therebetween. For example, the far left compound of FIGS. 8-10 show examples of functionalized oligomeric silsesquioxanes.

In aspects, the functionalized oligomeric silsesquioxane can further comprise any number of RSiO₂ monomers in addition to the RSiO_{1.5} monomeric units discussed above, where again the R can vary between monomers of either or both the RSiO₂ monomers and RSiO_{1.5} monomers. In further aspects, a RSiO₂ monomer can be a terminal monomer, meaning that it is connected to only one other monomer. For simplicity, these “terminal monomers” will be referred to as RSiO₂ with the understanding that terminal RSiO₂ monomers can refer to either RSiO_{3.5}, RSiO_{2.5}, R₂SiO_{3.5}, R₂SiO_{2.5}, R₂SiO_{1.5}, R₃SiO_{3.5}, R₃SiO_{2.5}, R₃SiO_{1.5}, or R₃SiO_{0.5}, where a first R of a single terminal monomer can be the same or different another (e.g., one, all) R of the same single terminal monomer. In further aspects, a RSiO₂ monomer can be bonded to two other monomers. For example, a RSiO₂ monomer can be bonded to another RSiO₂ and a RSiO_{1.5} monomer or two RSiO_{1.5} monomers. For simplicity, “non-terminal RSiO₂ monomers” can refer to either RSiO₃, RSiO₂, R₂SiO₃, or R₂SiO₂, where a first R of a single “non-terminal RSiO₂” monomer can be the same or different another (e.g., one, all) R of the same single “non-terminal RSiO₂ monomer.” In further aspects, the number of RSiO₂ monomers can be less than or equal to the number of RSiO_{1.5} monomers. For example, when the number of RSiO₂ monomers is 4 and the number of the RSiO_{1.5} monomers is 4 or more, a ladder-type functionalized oligomeric silsesquioxane can be formed, where each of the RSiO_{1.5} monomers is connected to two other RSiO_{1.5} monomers and either a RSiO_{1.5} monomer or a RSiO₂ monomer. In even further aspects, the far left compound of FIG. 8 can comprise a ladder-type functionalized oligomeric silsesquioxanes, for example, when box 803 makes the Si atom bonded to the R group and the Si atom bonded to the R2 group non-terminal RSiO₂ monomers, the R3 group an RSiO_{1.5} monomer, and the box 803 comprises three or more additional RSiO_{1.5} monomers and two more RSiO₂ monomers, which can be terminal or non-terminal.

In further aspects, the functionalized oligomeric silsesquioxane can comprise from 1 to 3 of RSiO₂ monomers (e.g., 1, 2, 3). In even further aspects, an adjacent pair of RSiO_{1.5} monomers can be connected to each other by two or more non-overlapping paths, where each path comprises at least one monomer other than the adjacent pair of RSiO_{1.5} monomers and the first path is connected to the second path without passing through the adjacent pair of monomers. For example, an open-cage functionalized oligomer silsesquioxane can comprise the adjacent pair of RSiO_{1.5} monomers connected to each other by two or more non-overlapping paths and the first path is connected to the second path without passing through the adjacent pair of monomers while also comprising from 1 to 3 of RSiO₂ monomers. In even further aspects, the far left compound of FIG. 8 can comprise an open-cage functionalized oligomer silsesquioxane, for example, when box 803 makes one or more of the Si atoms shown into an RSiO_{1.5} monomer such that a total number of RSiO₂ monomers is from 1 to 3, an adjacent pair of RSiO_{1.5} monomers is connected to each other by two or more non-overlapping paths, and the first path is connected to the second path without passing through the adjacent pair of monomers.

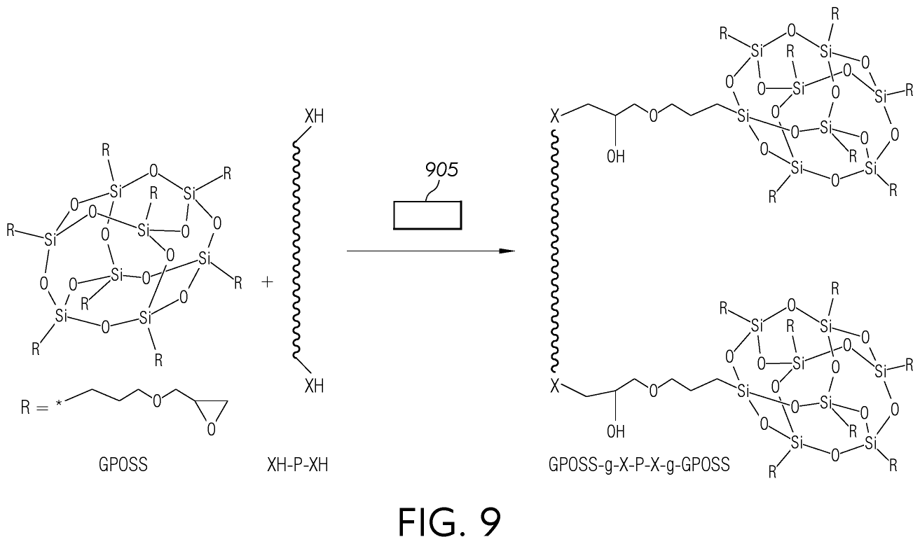

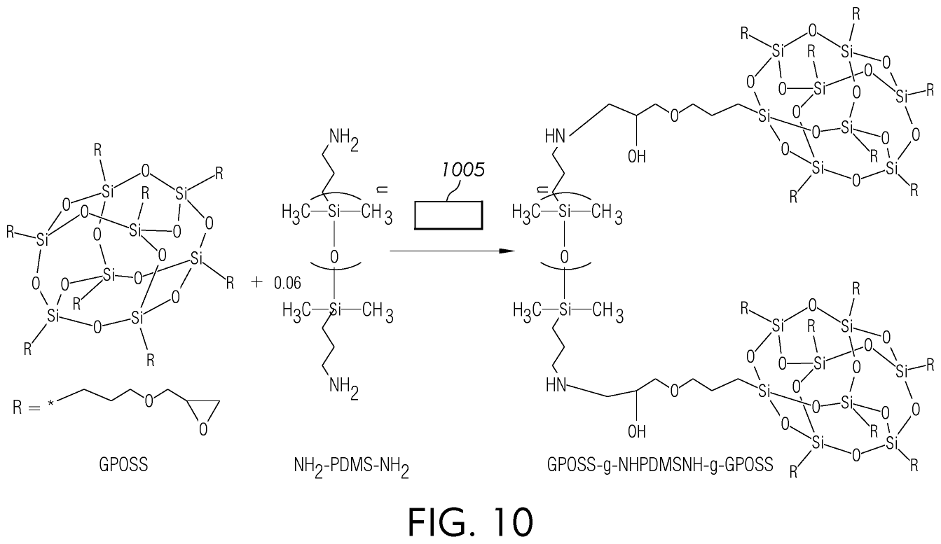

In aspects, the functionalized oligomeric silsesquioxane can consist of RSiO_{1.5} monomers. As used herein, a polyhedral oligomeric silsesquioxane (POSS) refers to a functionalized oligomer silsesquioxane consisting of RSiO_{1.5} monomers. Exemplary aspects of functionalized POSS can comprise 6, 8, 10, or 12 RSiO_{1.5} monomers, although other aspects are possible. For example, functionalized oligomeric silsesquioxane consisting of 8 RSiO_{1.5} monomers is an octahedral functionalized POSS (e.g., polyoctahedral silsesquioxane). As shown in FIGS. 9-10, the far left compound is a functionalized POSS, namely, an octahedral functionalized POSS.

In aspects, functionalized oligomeric silsesquioxanes can be formed from condensation reactions of silane. As used herein a condensation reaction produces an R₂O byproduct, where R can include any of the R units discussed below and can further comprise hydrogen (e.g., with a hydroxyl or water byproduct). For example, silanes (e.g., R₃OSi) can be reacted to form terminal RSiO₂ monomers. For example, a terminal RSiO₂ monomer can react with another RSiO₂ monomer (e.g., terminal, non-terminal) to form an RSiO_{1.5} monomer as an oxygen atom of one monomer forms a bond with a silicon atom of another monomer, producing the condensation byproduct. It is to be understood that the RSiO_{1.5} silsesquioxane monomers are different from siloxane monomers, which can include M-type siloxane monomers (e.g., R₃SiO_{0.5}), D-type siloxane monomers (e.g., R₂SiO₂), and/or silica-type siloxane monomers (SiO₂).

Functionalized oligomeric silsesquioxanes can be functionalized by one or more functional groups. As used herein, a functional group functionalizing the functionalized oligomeric silsesquioxane can exclude hydrogen, bisphenols, and/or fluorine-containing functional groups. In aspects, the functional group functionalizing the functionalized oligomeric silsesquioxane can exclude isocyanates, alkenes, and/or alkynes. In aspects, a functional group for the functionalized oligomeric silsesquioxane can comprise epoxies, a glycidyls, oxiranes, thiols, anhydrides, isocyanates, acrylates, and methacrylates. In further aspects, the functional group for the functionalized oligomeric silsesquioxane can be a glycidyl functional group or an epoxycyclohexyl functional group. Throughout the disclosure, a functionalized POSS that is functionalized by a glycidyl group is referred to as GPOSS. Exemplary aspects of glycidyl functional groups include amine glycidyls, alkyl glycidyls (e.g., glycidylpropyl), ether glycidyls (e.g., glycidyloxy), siloxane glycidyls (e.g., glycidyldimethyoxy), and combinations thereof (e.g., glycidyloxypropyl, glycidyloxypropyldimethylsiloxy). Commercially available examples of GPOSS include 3-glycidyloxypropyl functionalized POSS (e.g., EP0408 (Hybrid Plastics), EP0409 (Hybrid Plastics)), 3-glycidylpropoxy functionalized POSS (e.g., 560624 (Sigma Aldrich)), and 3-glycidyloxypropyldimethysiloxy (e.g., 593869 (Sigma Aldrich)). For example, the compound on the left in FIGS. 9-10 is a GPOSS, namely, 3-glycidyloxypropyl functionalized POSS. Exemplary aspects of epoxy functional groups include epoxy, alkyl epoxy (e.g., epoxyethyl, epoxypropyl), and cycloalkyl epoxy (e.g., epoxycyclohexyl). A commercially available example of epoxy functionalized POSS includes (3,4, epoxycyclohexyl)ethyl functionalized POSS (e.g., 560316 (Sigma Aldrich)). Example aspects of thiols include mercapto alkyl (e.g., mercaptopropyl), for example, the commercially available 3-mercaptopropyl functionalized POSS (e.g., 560375 (Sigma Aldrich), TH1550 (Hybrid Polymers), TH1555 (Hybrid Polymers). Example aspects of anhydrides include maleic anhydride, succinic anhydride, acetic anhydride, and alkyl anhydrides (e.g., ethanoic anhydride, propanoic anhydride). Example aspects of isocyanates include isocyanate, alkyl isocyanate (e.g., isocyanatomethyl, isocyanatohexyl), cycloalkyl isocyanate (e.g., isophorone isocyanate, isocyanatocyclohexyl), and combinations thereof. Example aspects of acrylates include acrylate, alkyl acrylates (e.g., acrylopropyl, acryloisobutyl), and cycloalkyl acrylates (acrylocyclohexyl). Commercially available examples of acylate functionalized POSS include acrylopropyl functionalized POSS (e.g., MA0736 (Hybrid Polymers) and acryloisobutyl functionalized POSS (e.g., MA0701 (Hybrid Polymers)). Example aspects of methacrylates include methacrylate, alkyl methacrylates (e.g., methacrylomethyl, methacrylopropyl), cycloalkyl methacrylates (e.g., methacrylocyclopentyl), and combinations thereof (e.g., (propylmethacryl)cyclopentyl). Commercially available examples of methacrylate functionalized POSS include methylmethacrylate functionalized POSS (e.g., MA0706 (Hybrid Polymers), MA0716 (Hybrid Polymers), MA0718 (Hybrid Polymers)), methacrylopropyl functionalized POSS (e.g., 534633 (Sigma Aldrich), MA0702 (Hybrid Polymers), MA0735 (Hybrid Polymers), MA0719 (Hybrid Polymers)), and (propylmethacryl)cyclopentyl functionalized POSS (e.g., 560340 (Sigma Aldrich). Example aspects of alkenes include allyl, vinyl, alkyl vinyl (e.g., vinylpropyl), cycloalkene (e.g., cyclohexenyl) aromatic (e.g., vinylphenyl), siloxane vinyl (e.g., vinylsiloxy), and combinations thereof (e.g., vinyldiphenylsiloxy, (cyclohexenyl)ethyldimethylsiloxy). Commercially available aspects of alkene functionalized POSS include allyl functionalized POSS (e.g., OL1118 (Hybrid Polymers), vinyldiphenylsiloxy (e.g., 527300 (Sigma Aldrich)), vinyl functionalized POSS (e.g., 475424 (Sigma Aldrich), 560367 (Sigma Aldrich), OL1170 (Hybrid Polymers), OL1123 (Hybrid Polymers)), trivinylsiloxy functionalized POSS (527327 (Sigma Aldrich)), and 2-(4-cyclohexyenyl)ethyldimethylsilyoxy functionalized POSS (e.g., 593974 (Sigma Aldrich)). Providing a linker comprising one or more amine and/or anhydride functional groups can provide a coating with good adhesion (e.g., about 4B or more as formed; about 4B or more after being maintained for 10 days in a 50% relative humidity, 25° C. environment; and/or about 4B or more after being maintained from 10 days in a 95% relative humidity, 65° C. environment) to the substrate whether or not a silane coupling agent is used.

As shown in FIGS. 8-10, the locations where the functionalized oligomeric silsesquioxane can be functionalized are denoted as R-groups (e.g., R, R2, R3). As used herein, the functionalized oligomeric silsesquioxane is functionalized by at least one of the functional groups listed in the previous paragraph. In aspects, the functionalized oligomeric silsesquioxane (e.g., functionalized POSS) can comprise two or more R-groups comprising a functional group listed in the previous paragraph for functionalizing the oligomeric silsesquioxane. In further aspects, substantially every R-group of the functionalized oligomeric silsesquioxane can comprise a functional group listed in the previous paragraph for functionalizing the oligomeric silsesquioxane. In even further aspects, all of the R-groups comprising a functional group listed in the previous paragraph can comprise the same functional group. In even further aspects, the functionalized oligomeric silsesquioxane can be functionalized by two or more different functional groups listed in the previous paragraph. In further aspects, with reference to FIG. 8, the functionalized oligomeric silsesquioxane can be functionalized by a first functional group (R) selected from the list in the previous paragraph and a second functional group (R2) selected from the list in the previous paragraph, where R is different from R2. In further aspects, one or more of the R-groups can comprise a functional group other than those listed in the previous paragraph. For example, other potential R-groups include hydrogen, alkyls, cycloalkyls, alcohols, and amines. In even further aspects, with reference to FIG. 8, a third functional group (R3) of the functionalized oligomeric silsesquioxane can comprise hydrogen or an alkyl, cycloalkyl, alcohol, or amine functional group without comprising one of the functional groups listed in the previous paragraph.

Throughout the disclose, an effective diameter of a molecule (e.g., functionalized oligomeric silsesquioxane) is measured using dynamic light scattering in accordance with ISO 22412:2017. In aspects, an effective diameter of a functionalized oligomeric silsesquioxane of the plurality of functionalized oligomeric silsesquioxanes can be about 20 nm or less, about 15 nm or less, about 10 nm or less, about 6 nm or less, about 1 nm or more, about 2 nm or more, or about 4 nm or more. In aspects, an effective diameter of a functionalized oligomeric silsesquioxane of the plurality of oligomeric silsesquioxanes can be in a range from about 1 nm to about 20 nm, from about 1 nm to about 15 nm, from about 2 nm to about 15 nm, from about 2 nm to about 10 nm, from about 4 nm to about 10 nm, from about 4 nm to about 6 nm, from about 1 nm to about 6 nm, from about 2 nm to about 6 nm, or any range or subrange therebetween. In further aspects, a mean effective diameter of the plurality of functionalized oligomeric silsesquioxanes can be within one or more of the ranges for the effective diameter of a functionalized oligomeric silsesquioxane discussed above. In further aspects, substantially all and/or all of the functionalized oligomeric silsesquioxanes of the plurality of functionalized oligomeric silsesquioxanes can be within one or more of the ranges for the effective diameter of a functionalized oligomeric silsesquioxane discussed above.

Compositions, coatings, and coated articles of the aspects of the disclosure can comprise a linker (e.g., polymer). In aspects, as shown in FIG. 8 as the middle compound, the linker can comprise a first functional group at a first end (e.g., X) and a second functional group at the second end (e.g., X) opposite the first end. In further aspects, as shown in FIG. 9, the first functional group can be the same as the second functional group (e.g., first functional group X and second functional group X). In further aspects, the second functional group can be different than the second functional group. In further aspects, as shown in FIGS. 8-10, the linker can comprise a polymer. Providing a polymer comprising a first functional group a first end opposite a second end comprising a second functional group can reduce (e.g., prevent) aggregation of the plurality of functionalized oligomeric silsesquioxanes, which can provide good optical properties (e.g., high transmittance, low haze) and, as a coating, good durability and/or good adhesion to a substrate.

As used herein, the first functional group and/or the second functional group can exclude hydrogen, bisphenols, and/or fluorine-containing functional groups. In aspects, the first functional group and/or the second functional group can exclude isocyanates, alkenes, and/or alkynes. In aspects, the first functional group and/or the second functional group can comprise acid alcohols, alcohols, anhydrides, amides, amines, chlorides, cyanides, epoxies, thiols, magnesium halides excluding fluorine, and/or alkenes. In further aspects, the first functional group and/or the second functional group can comprise acid alcohols, alcohols, anhydrides, amides, and/or amines. In even further aspects, the first functional group can comprise an amine. In still further aspects, the first functional group and the second functional group can both comprise amines. An exemplary aspect of an amine functional group comprises aminopropyl. Exemplary aspects of amines include primary alkyl amines (e.g., aminopropyl), secondary alkyl amines (methylaminopropyl, ethylaminoisobutyl), primary cycloalkyl amines (e.g., aminocyclohexyl, hexanediamine, trimethylhexamethylenediamine, isophoronediamine, 4,4′-methylene-bis[2-methylcyclohexylamaine], 4,7,10-trioxa-1,13-tridecanediamine), secondary cycloalkyl amines (e.g., methylaminocyclohexyl), and combinations thereof. In still further aspects, the first functional group and/or the second functional group can comprise an anhydride. Exemplary aspects of anhydrides include maleic anhydride, succinic anhydride, acetic anhydride, methylhexadydrophthalic anhydride, and alkyl anhydrides (e.g., ethanoic anhydride, propanoic anhydride). In further aspects, the first functional group and/or the second functional group can comprise an epoxy. Exemplary aspects of epoxies include epoxy, alkyl epoxy (e.g., epoxyethyl, epoxypropyl), and cycloalkyl epoxy (e.g., epoxycyclohexyl). For purposes of the first functional group and/or the second functional group, glycidyls are considered a type of epoxy. Exemplary aspects of acid alcohols include carboxyls, alkyl carboxyls (e.g., propionic acid, stearic acid), cycloalkyl carboxyls (e.g., carboxyl cyclohexyl), aromatic carboxyls (e.g., benzoic acid), and combinations thereof. Exemplary aspects of alcohols include hydroxyl, alkyl alcohols (e.g., ethoxy), cycloalkyl alcohols (e.g., hydroxycyclohexyl), geminal diols (e.g., methyldiol), and vicinal diols (e.g., 1,2-ethyldiol), and combinations thereof. Exemplary aspects of amides include amide, alkyl amides (amidopropyl), and cycloalkyl amides (e.g., amidocyclohexyl), and combinations thereof. Exemplary aspects of chlorides include chloride, acid chlorides (e.g., acyl chloride), alkyl chlorides (e.g., chloropropyl), and combinations thereof. Exemplary aspects of cyanides include cyano, alkyl cyanides (e.g., cyanopropyl), cycloalkyl cyanides (cyanocyclohexyl), and combinations thereof. Exemplary aspects of thiols include mercapto, mercapto alkyl (e.g., mercaptopropyl), mercapto cycloalkyl (e.g., mercaptocyclohexyl), and combinations thereof. Exemplary aspects of magnesium halides (e.g., Grignard reagent) include magnesium bromide and magnesium chloride. Example aspects of alkenes include allyl, vinyl, alkyl vinyl (e.g., vinylpropyl), cycloalkene (e.g., cyclohexenyl) aromatic (e.g., vinylphenyl), siloxane vinyl (e.g., vinylsiloxy), and combinations thereof (e.g., vinyldiphenylsiloxy, (cyclohexenyl)ethyldimethylsiloxy). It is to be understood that a first functional group and/or a second functional group can comprise multiple functional groups, for example, an amine can comprise multiple amine functionalities (e.g., diamine, triamine).

In aspects, the linker (e.g., polymer) can comprise another functional group in addition to the first functional group and the second functional group. In further examples, the linker can comprise a polymer comprising a branched polymer with more than two ends, for example, a star polymer or a dendrimer polymer. In further aspects, a number of functional groups on the polymer can be substantially equal to the number of chain ends (e.g., number of arms in star polymer or dendrimer polymer, number of branches plus 2 in a branched polymer).

Throughout the disclosure, a “normal terminal functional group” of a polymer refers to a functional group that would be present at an end of the polymer during the polymerization process. For example, a normal terminal functional group of a polyethylene would be an alkene (e.g., allyl), a normal terminal functional group of a polyamide would be an amine and/or a carboxylic acid, a normal terminal functional group of polydimethylsiloxane would be a silane. In aspects, the first functional group and/or the second functional group can be the same as the normal terminal functional group of the polymer. In aspects, the first group and/or the second functional group can be different than the normal terminal functional group of the polymer. In further aspects, the first functional group can be different than the normal terminal functional group of the polymer and the second functional group can be different than the normal terminal group of the polymer. For example, the polymer can be polydimethylsiloxane with a first functional group comprising an amine and a second functional group comprising an amine.

The polymer can comprise a glass transition (Tg) temperature. As used herein, the glass transition temperature, a storage modulus at a range of temperatures, a storage modulus (e.g., at a glassy plateau), and a loss modulus (e.g., at a glass plateau) are measured using Dynamic Mechanical Analysis (DMA) with an instrument, for example, the DMA 850 from TA Instruments. The samples for the DMA analysis comprise a film secured by a tension clamp. As used herein, the storage modulus refers to the in-phase component of a response of the polymer or polymer-based material to the dynamic testing. Throughout the disclosure, the modulus of elasticity of a polymer or polymer-based material refers to the storage modulus of the polymer or polymer-based material because, without wishing to be bound by theory, the in-phase component of the response is attributed to the elastic portion of a viscoelastic material. As used herein, the loss modulus refers to the out-of-phase component of a response to the polymer or polymer-based material during the dynamic testing. Without wishing to be bound by theory, the loss modulus can correspond to the viscous component of a viscoelastic material. As used herein, the glass transition temperature corresponds to a maximum value of a tan delta, which is a ratio of the loss modulus to the storage modulus. In aspects, the glass transition temperature can be outside of an operating range (e.g., from about −20° C. to about 60°) of the coated article. In aspects, the glass transition temperature of the polymer-based portion can be about 0° C. or less, about −20° C. or less, about −40° C. or less, about −140° C. or more, about −80° C. or more, or about −60° C. or more. In aspects, the glass transition temperature of the polymer can be in a range from about −120° C. to about 0° C., from about −120° C. to about −20° C., from about −80° C. to about −20° C., from about −80° C. to about −40° C., from about −80° C. to about −60° C., or any range or subrange therebetween. In aspects, the glass transition temperature of the polymer can be about 60° C. or more, about 80° C. or more, about 100° C. or more, about 200° C. or less, about 160° C. or less, or about 120° C. or less. In aspects, the glass transition temperature of the polymer can be in a range from about 60° C. to about 200° C., from about 60° C. to about 160° C., from about 80° C. to about 160° C., from about 80° C. to about 120° C., from about 80° C. to about 100° C., or any range or subrange therebetween. Providing a polymer-based portion with a glass transition temperature outside of an operating range (e.g., from about 0° C. to about 40° C., from about −20° C. to about 60° C.) can enable consistent properties across the operating range.

In aspects, the polymer can comprise one or more of a polyamide-based polymer, a polyimide-based polymer, a silicone-based polymer, an acrylate-based polymer, an epoxy-based polymer, a thiol-containing polymer, polycarbonate, or a polyurethane-based polymer. In even further aspects, the silicone-based polymer can comprise a silicone elastomer. Exemplary aspects of a silicone elastomer include PP2-OE50 available from Gelest and LS 8941 available from NuSil. In even further aspects, the polymer can comprise one or more of an optically transparent: an acrylic (e.g., polymethylmethacrylate (PMMA)), an epoxy, a silicone, and/or a polyurethane. Examples of epoxies include bisphenol-based epoxy resins, novolac-based epoxies, cycloaliphatic-based epoxies, and glycidylamine-based epoxies. In further aspects, the polymer can comprise one or more of a polyolefin, a polyamide, a halide-containing polymer (e.g., polyvinylchloride or a fluorine-containing polymer), a polyether, a cellulose derivative, an elastomer, a urethane, phenolic resin, parylene, polyethylene terephthalate (PET), or polyether ether ketone (PEEK). Example aspects of polyolefins include low molecular weight polyethylene (LDPE), high molecular weight polyethylene (HDPE), ultrahigh molecular weight polyethylene (UHMWPE), and polypropylene (PP). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA) (e.g., perfluoroalkoxyethylene), fluorinated ethylene propylene (FEP) polymers, and ethylene tetrafluoro ethylene (ETFE) polymers. Example aspects of elastomers include rubbers (e.g., polybutadiene, polyisoprene, chloroprene rubber, butyl rubber, nitrile rubber) and block copolymers (e.g., styrene-butadiene, high-impact polystyrene, poly(dichlorophosphazene)). Exemplary aspects of linkers comprising polymers include amine-terminated polydimethylsiloxane, a polycaprolactone, and an amine-terminated poly(propylene glycol).

The polymer can comprise a number-average molecular weight (Mn). As used herein, a number average molecular weight is calculated for a polymer by summing the products of a molecular weight and the fraction of polymers with that molecular weight. Throughout the disclosure, molecular weights of polymers are measured using high-pressure liquid chromatography. In aspects, the polymer can comprise a number-average molecular weight (Mn) of about 300 Daltons or more, about 400 Daltons or more, about 700 Daltons or more, about 1,000 Daltons or more, about 2,000 Daltons or more, about 100,000 Daltons or less, about 60,000 Daltons or less, about 30,000 Daltons or less, about 20,000 Daltons or less, about 10,000 Daltons or less, or about 5,000 Daltons or less. In aspects, the polymer can comprise a number-average molecular weight (Mn) in a range from about 300 Daltons to about 100,000 Daltons, from about 400 Daltons to about 100,000 Daltons, from about 400 Daltons to about 50,000 Daltons, from about 400 Daltons to about 30,000 Daltons, from about 700 Daltons to about 30,000 Daltons, from about 700 Daltons to about 20,000 Daltons, from about 1,000 Daltons to about 20,000 Daltons, from about 1,000 Daltons to about 10,000 Daltons, from about 2,000 Daltons to about 10,000 Daltons, from about 2,000 Daltons to about 5,000 Daltons, or any range or subrange therebetween. Providing a polymer comprising a molecular weight in a range from about 400 Daltons to about 30,000 Daltons can prevent agglomeration of the functionalized oligomeric silsesquioxanes attached thereto while reducing entanglement of the polymers, which can inhibit manufacturability of the resulting coating and/or coated article.

In aspects, the linker (e.g., polymer) can comprise an oxygen atom in a backbone of the linker. As used herein, an atom is in a backbone of a linker (e.g., polymer) when, excluding any functional groups at the end(s) of the linker (e.g., polymer), a longest chain of covalently bonded atoms in the linker (e.g., polymer) comprises an oxygen atom. In further aspects, the linker can comprise a polymer comprising an oxygen atom in the back of the polymer and the oxygen atom is in a plurality of monomers of the polymer. Exemplary aspects of such polymers include poly(ethylene oxide), poly(propylene oxide), poly(hydroxyethyl methacrylate), poly(lactic acid), poly(caprolactone), poly(glycolic acid), poly(hydroxy butyrate), poly(dimethyl siloxane), cellulose, poly(ethylene terephthalate), and derivatives and/or copolymers thereof. In even further aspects, the polymer can comprise poly(dimethylsiloxane) and/or poly(propylene oxide). Exemplary aspects of linkers that are not polymers include difunctional hexanecarboxylate (e.g., Celloxide 2021P (Daicel)), difunctional ethylene glycol (e.g., ethylene glycol diglycidyl ether), difunctional diethylene glycol (e.g., diethylene glycol diglycidyl ether), difunctional cyclohexanediol (e.g., 1,2-cyclohexanediol diglycidyl ether), neopentyl glycol (e.g., neopentyl glycol diglycidyl ether), trifunctional trimethoxypropane (e.g., trimethylolpropane triglycidyl ether), tetrafunctional erythritol (e.g., pentaerythritol glycidyl ether), and trifunctional tris(4-hydroxyphenyl)methane (e.g., tris(4-hydroxyphenyl)methane triglycidyl ether). In aspects, the linker (e.g., polymer) can be substantially free from aromatic groups in the monomer units. In aspects, the linker (e.g., polymer) can be substantially free from fluoride, urethanes, isocyanates, acrylates, and/or polycarbonates. Providing a linker comprising an oxygen atom in a backbone of the polymer can increase a flexibility of the linker, the resulting composition, and the resulting coating, which can increase the ultimate elongation, durability, and/or impact resistance (e.g., pen drop height).

The composition can comprise a first functionalized oligomeric silsesquioxane bonded to a second functionalized oligomeric silsesquioxane by the linker (e.g., polymer) terminated with the first functional group at the first end of the linker and a second functional group at the second end of the linker. As shown on the right side of FIGS. 8-10, the linker can comprise a polymer bonded to the first functionalized oligomeric silsesquioxane by a bond between the first functional group at the first end of the polymer and the functional group functionalizing the first functionalized oligomeric silsesquioxane. Further, as shown, the polymer can be bonded to the second functionalized oligomeric silsesquioxane by a bond between the second functional group at the second end of the polymer and the functional group functionalizing the second functionalized oligomeric silsesquioxane. For example, as shown in FIG. 9, the composition can be formed by reacting the R-group of the functionalized oligomeric silsesquioxane (e.g., first functionalized oligomeric silsesquioxane (e.g., functionalized POSS), second functionalized oligomeric silsesquioxane (e.g., functionalized POSS)) with a functional group X at an end of the polymer (e.g., first functional group X at the first end, second functional group X at the second end) to bond the first functionalized oligomeric silsesquioxane (e.g., functionalized POSS) to the first end of the polymer and the second functionalized oligomeric silsesquioxane (e.g., functionalized POSS) to the second end of the polymer. For example, as shown in FIG. 10, the composition can be formed by reacting a glycidyl functional group (e.g., 3-glycidyloxypropyl functional group) of functionalized oligomeric silsesquioxanes (e.g., functionalized POSS, GPOSS) with a first functional group comprising amine (e.g., aminopropyl) at an end (e.g., first end, second end) of the polymer (e.g., PDMS) to bond a first functionalized oligomeric silsesquioxane (e.g., functionalized POSS, GPOSS) to the first end of the polymer and to bond a second functionalized oligomeric silsesquioxane (e.g., functionalized POSS, GPOSS) to the second end of the polymer.

In aspects, substantially all of the linkers (e.g., polymers) can be bonded to two functionalized oligomeric silsesquioxanes. In aspects, the composition can comprise a third functionalized oligomeric silsesquioxane not bonded to a linker (e.g., polymer) in addition to the first functionalized oligomer silsesquioxane and the second functionalized oligomeric silsesquioxane bonded to the linker (e.g., polymer). In aspects, a weight percent (wt %) of the plurality of functionalized oligomeric silsesquioxanes to a total weight of the plurality of functionalized oligomeric silsesquioxanes and the polymer can be about 20% or more, about 40% or more, about 60% or more, about 80% or more, about 90% or more, about 99% or less, about 97% or less, about 95% or less, or about 93% or less. In aspects, a weight percent (wt %) of the plurality of functionalized oligomeric silsesquioxanes to a total weight of the plurality of functionalized oligomeric silsesquioxanes and the polymer can be in a range from about 20% to about 99%, from about 40% to about 99%, from about 40% to about 97%, from about 60% to about 97%, from about 60% to about 95%, from about 80% to about 95%, from about 80% to about 93%, from about 90% to about 93%, from about 90% to about 97%, from about 90% to about 95%, or any range or subrange therebetween. Providing a low mol ratio (e.g., about 0.06 or less) of the polymer to the plurality of functionalized oligomeric silsesquioxanes can produce polymers bonded to two functionalized oligomeric silsesquioxanes, which can achieve the benefits described herein. An extent of functionalization of the plurality of functionalized oligomeric silsesquioxanes can facilitate the bonding of the polymer to two different functionalized oligomeric silsesquioxanes of the plurality of functionalized oligomeric silsesquioxanes.

In aspects, a ratio of a number of the linkers comprising polymers (e.g., on a mol basis) to a number of functionalized oligomeric silsesquioxanes (e.g., on a mol basis) can be about 0.0005 or more, about 0.001 or more, about 0.005 or more, about 0.01 or more, about 0.02 or more, about 0.08 or less, about 0.06 or less, or about 0.05 or less, or about 0.04 or less, or about 0.03 or less. In aspects, a ratio of a number of the linkers comprising polymers (e.g., on a mol basis) to a number of functionalized oligomeric silsesquioxanes (e.g., on a mol basis) can be in a range from about 0.0005 to about 0.08, from about 0.001 to about 0.08, from about 0.001 to about 0.06, from about 0.005 to about 0.06, from about 0.005 to about 0.05, from about 0.01 to about 0.05, from about 0.01 to about 0.04, from about 0.02 to about 0.04, from about 0.02 to about 0.03, or any range or subrange therebetween.

In aspects, a ratio of a number of the linkers (e.g., non-polymeric linkers) (e.g., on a mol basis) to a number of functionalized oligomeric silsesquioxanes (e.g., on a mol basis) can be about 0.6 or more, about 0.7 or more, about 1 or less, about 0.9 or less, or about 0.8 or less. In aspects, a ratio of a number of the linkers (e.g., non-polymeric linkers) (e.g., on a mol basis) to a number of functionalized oligomeric silsesquioxanes (e.g., on a mol basis) can be in a range from about 0.6 to about 1, from a bout 0.6 to about 0.9, from about 0.6 to about 0.8, from about 0.7 to about 0.8, or any range or subrange therebetween.

In aspects, a wt % of the linker (e.g., plurality of linkers) to a total weight of the plurality of functionalized oligomeric silsesquioxanes and the linker can comprise about 10% or more, about 15% or more, about 20% or more, about 25% or more, about 50% or less, about 45% or less, about 40% or less, or about 30% or less. In aspects, a wt % of the linker (e.g., plurality of linkers) to a total weight of the plurality of functionalized oligomeric silsesquioxanes and the linker can be in a range from about 10% to about 50%, from about 15% to about 50%, from about 15% to about 45%, from about 20% to about 45%, from about 20% to about 40%, from about 25% to about 40%, from about 25% to about 30%, or any range or subrange therebetween. Providing a linker can be used to tune a viscosity of the composition, which can facilitate even application and/or enable lower-cost application techniques while reducing the overall cost of the composition and/or coating. Providing a linker within one or more of the above-mentioned ranges can reduce an overall cost of producing the coated article, for example, by reducing the amount of the plurality of functionalized oligomeric silsesquioxanes used.

In aspects, the linker can comprise a reactive diluent. As used herein, a reactive diluent in a composition is a material that lowers the viscosity of the composition and can react with another material in the composition. Reactive diluents are to be contrasted with solvents, which do not react with another material in the composition. In aspects, the composition can further comprise a reactive diluent. The reactive diluent can comprise a third functional group at a first end and a fourth functional group at a second end opposite the first end. In further aspects, the third functional group and/or the fourth functional group can comprise one or more of the functional groups discussed above with reference to the first functional group and/or the second functional group. In further aspects, the third functional group and/or the fourth functional group can be selected from a group consisting of alcohols, acrylates, and epoxies, and the second functional group is selected from a group consisting of acid alcohols, acrylates, anhydrides, alcohols, epoxies, isocyanates, and ureidos. As discussed above, any of the functional groups can comprise an alkyl, a cycloalkyl, or an aromatic version of the functional group, the functional group itself, or multiple functional groups including the named functional group. In further aspects, the third functional group can be the same as the fourth functional group. In further aspects, the reactive diluent can comprise three or more reactive functional groups (e.g., third functional group, fourth functional group, and another functional group). Providing a reactive diluent (e.g., linker not bonded to a functionalized oligomeric silsesquioxane until curing after the composition is disposed on the substrate) can be used to tune a viscosity of the composition, which can facilitate even application and/or enable lower-cost application techniques while reducing the overall cost of the composition and/or coating. Further, linking the plurality of functionalized oligomeric silsesquioxanes during the curing can reduce the time and resources required to produce a coated article. Exemplary aspects of linkers comprising reactive diluents (e.g., non-polymeric linkers) include 1,6-hexanediamine, trimethylhexamethylenediamine, isophorodiamine, aminoethylpiperazine, 4,4′-methylene-bis-(2-methylcyclohexylamine), N,N′-bis(3-aminopropyl)ethylenediamine, diethtylene glycol bis(3-aminopropyl)ether, 3,4-epoxycyclohexylmethyl 3,4-epoxycyclohexanecarboxylate, 3-ethyl-3-oxetanemethanol, and methylhexahydrophthalic anhydride.

As used herein, TMPO refers to trimethylolpropane oxetane. In aspects, the composition can comprise TMPO. In further aspects, the composition can comprise TMPO in an amount of about 3 wt % or more, about 5 wt % or more, about 8 wt % or more, about 10 wt % or more, about 15 wt % or more, or about 30 wt % or more. In further aspects, the composition can comprise TMPO in a range from about 3 wt % to about 50 wt %, from about 5 wt % to about 30 wt %, from about 8 wt % to about 25 wt %, from about 10 wt % to about 20 wt %, or any range or subrange therebetween. Providing about 10 wt % or more TMPO can improve an adhesion of the resulting coating after 10 days in a 95% relative humidity, 65° C. environment or a 85% relative humidity, 85° C. environment. In further aspects, a ratio of the amount of the linker in wt % to the amount of TMPO in wt % can be about 1 or more, about 1.5 or more, about 2 or more, about 3.3 or less, about 3 or less, or about 2.5 or less. In further aspects, a ratio of the amount of the linker in wt % to the amount of TMPO in wt % can be in a range from about 1 to about 3.3, from about 1 to about 3, from about 1.5 to about 3, from about 1.5 to about 2.5, from about 2 to about 2.5, or any range or subrange therebetween. Providing a composition comprising trimethylolpropane oxetane can increase a hardness of the resulting coating.

In aspects, the composition can comprise a silane coupling agent. In further aspects, the silane coupling agent can comprise an anhydride-functionalized silane, an amine-functionalized silane, a chloro-functionalized silane, a cyano-functionalized silane, an epoxy-functionalized silane, a hydroxyl-functionalized silane, a thiol-functionalized silane, and combinations thereof. In even further aspects, the silane coupling agent can comprise an amine functional group. In further aspects, the silane coupling agent can comprise (3-triethoxysilyl)propylsuccinic anhydride, (3-mercaptopropyl)trimethoxysilane, and/or 2-(3,4-epoxycyclohexyl)ethyltrimethoxysilane. In even further aspects, the silane coupling agent can comprise an epoxy-functionalized silane coupling agent. Exemplary aspects of epoxy-functionalized silanes include 2-(3,4-epoxycyclohexyl)ethyltrimethoxysilane, 2-(3,4-epoxycyclohexyl)ethyltriethoxysilane, 3-(2,3-epoxypropoxy)propyltrimethoxysilane, 5,6-epoxyhex yltriethoxy silane, 2-(2,4-epoxycyclohexyl)ethyltrimethoxysilane, 2-(2,4-epoxycyclohexyl)ethyltriethoxysilane, (3-glycidoxypropyl)trimethoxysilane, (3-glycidoxypropyl)triethoxysilane, (3-glycidyloxypropyl)trimethoxysilane, and (3-glycidyloxypropyl)triethoxysilane. In even further aspects, the silane coupling agent can comprise an amine-functionalized silane coupling agent. Exemplary aspects of amine-functionalized silanes include (3-aminopropyl)trimethoxysilane, (3-aminopropyl)triethoxysilane, (3-aminopropyl)methyldimethoxysilane, (3-aminopropyl)methyldiethoxysilane, m-aminophenyltrimethoxysilane, p-aminophenyltrimethoxysilane, 3-(m-aminophenoxy)propyltrimethoxysilane, 3-(aminophenoxy)propyltriethoxysilane, N-(2-aminoethyl)-3-aminopropyltrimethoxysilane, N-(2-aminoethyl)-3-aminopropyltriethoxysilane, N-(6-aminohexyl)aminomethyltrimethoxysilane, N-(6-aminohexyl)aminomethyltriethoxysilane, N-2-aminoethyl-11-aminoundecyltrimethoxysilane, N-2-aminoethyl-11-aminoundecyltriethoxysilane, aminoethylaminomethylphenethyltrimethoxysilane, aminoethylaminomethylphenethyltriethoxysilane, N-3-(aminopolypropylenoxy)aminopropyltrimethoxysilane, N-3-(aminopolypropylenoxy)aminopropyltriethoxysilane, (3-trimethoxysilylpropyl)diethylenetriaminesilane, (3-triethoxysilylpropyl)diethylenetriaminesilane, 4-amino-3,3-dimethylbutyltrimethoxysilane, and 4-amino-3,3-dimethylbutyltriethoxysilane. Exemplary aspects of chloro-functionalized silanes include 3-chloropropyltrinelhoxyvsilane and 3-chloropropyltrielhoxysilane. Exemplary aspects of cyano-functionalized silanes include 3-isocyanatopropyltrimethoxysilane and 3-isocyanatopropyltriethoxysilane Exemplary aspects of hydroxyl-functionalized silanes include N,N′-bis(2-hydroxyethyl)-N,N′bis(trimethoxysilylpropyl)ethylenediamine, N,N′-bis(2-hydroxyethyl)-N,N′bis(triethoxysilylpropyl)ethylenediamine, N,N-bis(2-hydroxyethyl)-3-aminopropyltrimethoxysilane, N,N-bis(2-hydroxyethyl)-3-aminopropyltriethoxysilane, 2,2-bis(3-trimethyoxysilylpropoxymethyl)butanol, and 2,2-bis(3-triethyoxysilylpropoxymethyl)butanol. Exemplary aspects of thiol-functionalized silanes include 3-mercaptopropylmethyldimethoxysilane, 3-mercaptopropylmethyldiethoxysilane, 3-mercaptopiopyltriethoxysilane, 3-mercaptopropyltrimethoxysilane, 3-mercaptopropyltrimethoxysilane, 3-mercaptopropyltriethoxy-silane, and 11-mercaptoundecyltrimethoxysilane. In further aspects, the composition can comprise the silane coupling agent in a weight % (wt %) of about 0.1 wt % or more, about 0.2 wt % or more, about 0.5 wt % or more, about 5 wt % or less, about 2 wt % or less, or about 1 wt % or less. In further aspects, the composition can comprise the silane coupling agent in a weight % (wt %) ranging from about 0.1 wt % to about 5 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween. Providing a silane coupling agent can increase adhesion of the resulting coating to the substrates (e.g., glass-based substrate, ceramic-based substrate, polymer-based substrate) and improve the durability of the coating and/or coated article.

In aspects, the composition can be substantially free from nanoparticles. In aspects, the composition can be substantially free of silica nanoparticles. As used herein, the composition is substantially free of silica nanoparticles if an amount of silica nanoparticles is about 1 wt % or less. In further aspects, the composition can be free of silica nanoparticles. As used herein, silica nanoparticles refer to particles comprising an effective diameter of at least 20 nm and comprise silica. Silica nanoparticles can comprise solid particles or mesoporous particles. Silica nanoparticles can be larger (e.g., comprise a larger effective diameter) than a functionalized oligomeric silsesquioxane of the plurality of functionalized oligomeric silsesquioxanes. Silica nanoparticles can be formed from colloidal silica and/or via a sol-gel method. Without wishing to be bound by theory, silica nanoparticles can aggregate, especially at elevated temperature, impairing mechanical and/or optical properties of the composition or resulting coating and/or coated article. Providing a composition substantially free and/or free of silica nanoparticles can reduce processing issues (e.g., agglomeration, aggregation, phase separation) with the composition, improve optical properties (e.g., maintain low haze and/or high transmittance even after aging at elevated temperature and/or humidity) of the coating and/or the resulting coating and/or coated article, and reduce mechanical properties (e.g., hardness, modulus, strain) of the resulting coating and/or coated article compared to a corresponding composition, coating, and/or coated article comprising a plurality of functionalized oligomeric silsesquioxanes without silica nanoparticles.

In aspects, the composition can comprise nanoparticles. In further aspects, nanoparticles can comprise silica nanoparticles, alumina nanoparticles, zirconia nanoparticles, titania nanoparticles, carbon black, and/or combinations thereof. In aspects, the composition can comprise silica nanoparticles and/or alumina nanoparticles. In further aspects, a wt % of the silica nanoparticles and/or alumina nanoparticles in the composition can be about 5% or more, about 10% or more, about 15% or more, about 20% or more, about 50% or less, about 40% or less, about 30% or less, or about 25% or less. In further aspects, a wt % of the linker (e.g., plurality of linkers) to a total weight of the plurality of functionalized oligomeric silsesquioxanes and the linker can be in a range from about 5% to about 50%, from about 10% to about 50%, from about 10% to about 40%, from about 15% to about 40%, from about 20% to about 40%, from about 20% to about 30%, from about 20% to about 25%, or any range or subrange therebetween. In further aspects, a mean effective diameter of the silica nanoparticles and/or alumina nanoparticles can be about 20 nm or more, about 30 nm or more, about 100 nm or less, or about 50 nm or less. In further aspects, a mean effective diameter in a range from about 20 nm to about 100 nm, from about 20 nm to about 50 nm, from about 30 nm to about 50 nm, or any range or subrange therebetween. In further aspects, the silica nanoparticles and/or the alumina nanoparticles may not be bonded to a functionalized oligomeric silsesquioxane of the plurality of functionalized oligomeric silsesquioxane in the composition. Providing nanoparticles can increase a hardness and/or an impact resistance of the coated article.

In aspects, a functionalized oligomeric silsesquioxane of the plurality of functionalized oligomeric silsesquioxanes can be directly bonded to only the linker (e.g., polymer) or only the linker (e.g., polymer) and the silane coupling agent. In aspects, all the functionalized oligomeric silsesquioxanes of the plurality of functionalized oligomeric silsesquioxanes can be directly bonded to only the linker (e.g., polymer) or only the linker (e.g., polymer) and the silane coupling agent.

In aspects, the composition can comprise a catalyst. Without wishing to be bound by theory, a catalyst can increase a rate of the curing (e.g., polymerization, reaction), and the catalyst may avoid permanent chemical change as a result of the curing. In aspects, the catalyst can comprise one or more platinum group metals, for example, ruthenium, rhodium, palladium, osmium, iridium, and/or platinum. In aspects, the catalyst can comprise a platinum-based Karstedt's catalyst solution. Exemplary aspects of platinum-based catalysts include chloroplatinic acid, platinum-fumarate, colloidal platinum, metallic platinum, and/or platinum-nickel nanoparticles.

In aspects, the composition can comprise a curing catalyst. As used herein, a curing catalyst refers to a compound comprising a nitrogen bonded to two or more non-hydrogen atoms and cannot function as a linker. In further aspects, the curing catalyst can comprise a secondary amine, a tertiary amine, pyridine, and/or an imidazole. Exemplary aspects of a tertiary amine include 1,8-diazabicyclo[5.4.0]undec-7-ene, triethylamine, tetramethylguanidine, and 2,4,6-tris(dimethylaminomethyl)phenol. In further aspects, the composition can comprise the curing catalyst in an amount of about 0.3 wt % or more, about 0.5 wt % or more, about 0.7 wt % or more, about 1.1 wt % or less, about 1 wt % or less, or about 0.8 wt % or less. In further aspects, the composition can comprise the curing catalyst in a range from about 0.3 wt % to about 1.1 wt %, from about 0.3 wt % to about 1 wt %, from about 0.5 wt % to about 1 wt %, from about 0.5 wt % to about 0.8 wt %, from about 0.7 wt % to about 0.8 wt %, or any range or subrange therebetween. Without wishing to be bound by theory, the curing catalyst can improve properties (e.g., hardness, adhesion, pencil hardness) of a coating where the first functional group and/or the second functional group of the linker comprises an amine functional group.

In aspects, the composition can comprise a photoinitiator. As used herein a photoinitiator is a compound sensitive to one or more wavelengths that upon absorbing light comprising the one or more wavelengths undergoes a reaction to produce one or more radicals or ionic species that can initiate a reaction. In further aspects, the photoinitiator may be sensitive to one or more wavelengths of ultraviolet (UV) light. In further aspects, the photoinitiator can comprise a cationic photoinitiator, which is a photoinitiator configured to initiate a cation reaction (e.g., cationic polymerization). In further aspects, the composition can comprise a cationic photoinitiator and a free radical photoinitiator. Example aspects of photoinitiators sensitive to UV light include without limitation benzoin ethers, benzil ketals, dialkoxyacetophenones, hydroxyalkylphenones, aminoalkylphenones, acylphosphine oxides, thioxanthones, hydroxyalkylketones, and thoxanthanamines. In further aspects, the photoinitiator may be sensitive to one or more wavelengths of visible light. Example aspects of photoinitiators sensitive to visible light include without limitation 5,7-diiodo-3-butoxy-6-fluorone, bis (4-methoxybenzoyl) diethylgermanium, bis(2,4,6-trimethylbenzoyl)-phenylphosphineoxide, 3-methyl-4-aza-6-helicene, and thiocyanide borates. In further aspects, the photoinitiator may be sensitive to a wavelength that other components of the composition and/or the composition is substantially transparent at. In further aspects, the photoinitiator can initiate a cationic reaction (e.g., cationic polymerization), for example, triarylsulfonium hexfluoroantimonate, triphenylsulfonium hexafluoroantimonate, and bis(4-tert-butylphenyl)iodonium perfluoro-1-butanesulfonate. In further aspects, the photoinitiator can comprise a free radical photoinitiator configured to generate one or more free radicals, for example, acetophenone-based compounds (e.g., dimethoxyphenyl acetophenone), azobisisobutyronitrile (AIBN), and aromatic peroxides (e.g., benzoyl peroxide). Commercially available photoinitiators include without limitation the Irgacure product line from Ciba Specialty Chemical. In aspects, the composition can comprise the photoinitiator in a weight % (wt %) of about 0.1 wt % or more, about 0.2 wt % or more, about 0.5 wt % or more, about 6 wt % or less, about 4 wt % or less, about 3 wt % or less, about 2 wt % or less, or about 1 wt % or less. In aspects, the composition can comprise the silane coupling agent in a weight % (wt %) ranging from about 0.1 wt % to about 6 wt %, from about 0.1 wt % to about 4 wt %, from about 0.1 wt % to about 3 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween. In aspects, the composition can be substantially free of fluorine-based compounds. As used herein, the composition can be substantially free of fluorine-based compounds while containing a trace amount of fluorine in a minor component (e.g., about 6 wt % or less of a photoinitiator) of the composition corresponding to an overall wt % of fluorine of about 0.25 wt % or less. In further aspects, the composition can be free of fluorine-based compounds.

In aspects, the composition can comprise a solvent. As used herein, “solvent” excludes the components discussed above, for example, functionalized oligomeric silsesquioxanes, linkers comprising a first functional group at the first end and a second functional group at the second end opposite the first end, silane coupling agents, catalysts, photoinitiators, and combinations and/or products thereof. Solvents can comprise one or more of a polar solvent (e.g., water, an alcohol, an acetate, acetone, formic acid, dimethylformamide, acetonitrile, dimethyl sulfoxone, nitromethane, ethylene carbonate, propylene carbonate, poly(ether ether ketone)) or a non-polar solvent (e.g., pentane, 1,4-dioxane, chloroform, dichloromethane, diethyl ether, hexane, heptane, benzene, toluene, xylene). Example aspects of alcohols include methanol, ethanol, propanol, butanol, cyclohexanol, hexanol, octanol, ethylene glycol, and propylene glycol. Example aspects of acetate include ethyl acetate, propyl acetate, and butyl acetate. In further aspects, the solvent can comprise butyl acetate, propyl acetate, and/or acetonitrile. Providing a solvent can enable the formation of coating using a wider range of compositions than would otherwise be possible.

In aspects, the composition can be substantially free of solvent. As used herein, a composition is “substantially free of solvent” or “substantially solvent-free” if it contains 2 wt % or less of solvent. As used herein, a composition is “free of solvent” or “solvent-free” if it comprises 0.5 wt % or less of solvent. Providing a composition that is substantially free of solvent or substantially solvent-free can increase its curing rate, which can decrease processing time. Further, providing a composition that is substantially free of solvent or solvent-free can reduce (e.g., decrease, eliminate) the use of rheology modifiers and increase composition homogeneity, which can increase the optical transparency (e.g., transmittance) of the resulting coating. Moreover, a solvent-free composition can decrease an incidence of visual defects, for example bubbles from volatile gases as any solvent evaporates, in the resulting coating.

In aspects, the composition can be optically transparent. As used herein, a composition is substantially transparent at a predetermined wavelength if it comprises an average transmittance of 70% or more through a 1.0 mm thick sample of the composition at the predetermined wavelength. As used herein, “optically transparent” or “optically clear” means that the sample (e.g., composition, coating) comprises an average transmittance of 70% or more in the wavelength range of 400 nanometers (nm) to 700 nm through a 1.0 mm thick piece of material. As used herein, an average transmittance of a material is measured by averaging over optical wavelengths in a range from 400 nm to 700 nm through a 1.0 mm thick piece of the material, which comprises measuring the transmittance of whole number wavelengths from 400 nm to 700 nm and averaging the measurements. Unless specified otherwise, “transmittance” of a material refers to the average transmittance of the material. In aspects, an “optically transparent material” or an “optically clear material” may have an average transmittance of 75% or more, 80% or more, 85% or more, or 90% or more, 92% or more, 94% or more, 96% or more in the wavelength range of 400 nm to 700 nm through a 1.0 mm thick piece of the material. The average transmittance in the wavelength range of 400 nm to 700 nm is calculated by averaging transmittance measurements of whole number wavelengths from 400 nm to 700 nm. In aspects, the composition can comprise an average transmittance in the wavelength range of 400 nm to 700 nm of about 80% or more, about 90% or more, about 92% or more, about 98% or less, about 96% or less, or about 94% or less. In aspects, the composition can comprise an average transmittance in the wavelength range of 400 nm to 700 nm in a range from about 80% to about 98%, from about 90% to about 98%, from about 90% to about 96%, from about 92% to about 96%, from about 92% to about 94%, or any range or subrange therebetween. In aspects, the composition can be visually transparent. As used herein, “visually transparent” means that material appears clear and transparent by inspection of a 1 mm sample of the composition with the naked eye.

Methods of forming the composition can comprise reacting a plurality of functionalized oligomeric silsesquioxanes with a linker (e.g., polymer) terminated with a first functional group at a first end of the linker (e.g., polymer) and a second functional group at a second end of the linker (e.g., polymer) opposite the first end of the linker (e.g., polymer). As described above with reference to FIGS. 8-10, the linker can comprise a polymer, and the first functional group at the first end of the polymer can react with a functional group functionalizing the first functionalized oligomeric silsesquioxane to bond the first functionalized oligomeric silsesquioxane to the polymer. Likewise, the second functional group at the second end of the linker (e.g., polymer) can react with a functional group functionalizing the second functionalized oligomeric silsesquioxane to bond the second functionalized oligomeric silsesquioxane to the linker (e.g., polymer). In aspects, a ratio of the plurality of functionalized oligomeric silsesquioxanes on a mol basis to the plurality of linkers comprising polymers on a mol basis can be within one or more of the ranges discussed above for this ratio (e.g., about 0.06 or less, from about 0.0005 to about 0.06). In further aspects, as shown in FIGS. 8-10, the reaction can take place under specific reaction conditions indicated by box 805, 905, and/or 1005. In aspects, the reaction can comprise heating, ultraviolet (UV) irradiation, and/or waiting for a predetermined period of time. In further aspects, the reaction conditions can comprise heating the reactants (left side of FIGS. 8-10) at a first temperature for a first period of time. In even further aspects, the first temperature can be maintained by an electrical resistance heater, an oil bath, or a salt bath that a reaction vessel is in contact with. In even further aspects, the first temperature can be about 90° C. or more, about 100° C. or more, about 110° C. or more, about 120° C. or more, about 160° C. or less, or about 140° C. or less. In even further aspects, the first temperature can be in a range from about 90° C. to about 160° C., from about 100° C. to about 160° C., from about 110° C. to about 140° C., from about 120° C. to about 140° C., or any range or subrange therebetween. In even further aspects, the first period of time can be about 15 minutes or more, about 1 hour or more, about 2 hours or more, about 4 hours or more, about 6 hours or more, about 24 hours or less, about 18 hours or less, about 12 hours or less, or about 10 hours or less. In even further aspects the first period of time can be in a range from about 15 minutes to about 24 hours, from about 1 hour to about 24 hours, from about 1 hour to about 16 hours, from about 2 hours to about 16 hours, from about 4 hours to about 16 hours, from about 4 hours to about 12 hours, from about 6 hours to about 12 hours, from about 6 hours to about 10 hours, or any range or subrange therebetween. In aspects, the reactants can be combined with a catalyst.

In aspects, the specific reaction conditions indicated by box 805, 905, and/or 1005 can further comprise performing the reaction in the presence of a solvent. In further aspects, the solvent can comprise one or more of the solvents discussed above. In even further aspects, the solvent can comprise butyl acetate, propyl acetate, and/or acetonitrile. In further aspects, an amount of the solvent as a weight % (wt %) of a composition during the reaction can be about 5 wt % or more, about 10 wt % or more, about 15 wt % or more, about 80 wt % or less, about 60 wt % or less, about 40 wt % or less, or about 30 wt % or less. In further aspects, an amount of the solvent as weight % (wt %) of a composition during the reaction can be in a range from about 5 wt % to about 80 wt %, from about 5 wt % to about 60 wt %, from about 10 wt % to about 60 wt %, from about 10 wt % to about 40 wt %, from about 15 wt % to about 40 wt %, from about 15 wt % to about 30 wt %, or any range or subrange therebetween. In further aspects, the solvent can be refluxed for the first period of time. In further aspects, after the reaction takes place, the solvent can be removed, for example using increased temperature and/or reduced pressure (e.g., vacuum, rotary evaporator). In even further aspects, the reduced pressure can be about 20 kiloPascals or less, about 10 kPa or less, about 5 kPa or less, about 0.01 kPa or more, about 0.1 kPa or more, about 1 kPa or more, or about 2 kPa or more. In even further aspects, the reduced pressure can be in a range from about 0.01 kPa to about 20 kPa, from about 0.1 kPa to about 20 kPa, from about 0.1 kPa to about 10 kPa, from about 1 kPa to about 10 kPa, from about 1 kPa to about 5 kPa, from about 2 kPa to about 5 kPa, or any range or subrange therebetween. In even further aspects, the increased temperature can be about 35° C. or more, about 45° C. or more, about 50° C. or more, about 80° C. or less, about 70° C. or less, or about 65° C. or less. In even further aspects, the increased temperature can be in a range from about 35° C. to about 80° C., from about 45° C. to about 80° C., from about 45° C. to about 70° C., from about 50° C. to about 70° C., from about 50° C. to about 65° C., or any range or subrange therebetween. In further aspects, the composition can comprise the solvent. In aspects, the reaction can be substantially solvent-free and/or solvent-free.

In aspects, after the reaction takes place, additional functionalized oligomeric silsesquioxanes can be added to the composition. In further aspects, an amount of the additional functionalized oligomeric silsesquioxanes added can be the same, more than, or less than an initial amount of functionalized oligomeric silsesquioxanes present during the reaction. In further aspects, an amount of the additional functionalized oligomeric silsesquioxanes as a percentage (e.g., wt %) of the initial amount of functionalized oligomer silsesquioxanes added can be about 20% or more, about 50% or more, about 80% or more, about 90% or more, about 200% or less, about 150% or less, about 120% or less, or about 110% or less. In further aspects, an amount of the additional functionalized oligomeric silsesquioxanes as a percentage (e.g., wt %) of the initial amount of functionalized oligomer silsesquioxanes added can be in a range from about 20% to about 200%, from about 20% to about 150%, from about 50% to about 150%, from about 50% to about 120%, from about 80% to about 120%, from about 80% to about 110%, from about 90% to about 110%, or any range or subrange therebetween. In aspects, after the reaction takes place, a silane coupling agent can be added to the composition. In aspects, after the reaction takes place, a photoinitiator can be added to the composition. In aspects, additional functionalized oligomeric silsesquioxanes, silane coupling agents, and/or photoinitiators can be added after the reaction takes place but before removing the solvent, in aspects where the reaction takes place in solvent.

In aspects, a solvent can be added to the composition after the reaction takes place. In further aspects, the solvent can comprise one or more of the solvents discussed above. In further aspects, the solvent can be added after the solvent present during the reaction was removed. In further aspects, the solvent can be added after a substantially solvent-free and/or solvent-free reaction. In further aspects, an amount of the solvent in the composition can be about 5 wt % or more, about 10 wt % or more, about 15 wt % or more, about 85 wt % or less, about 70 wt % or less, about 50 wt % or less, about 30 wt % or less, or about 25 wt % or less. In further aspects, an amount of the solvent in the composition can be in a range from about 5 wt % to about 85 wt %, from about 5 wt % to about 70 wt %, from about 5 wt % to about 50 wt %, from about 5 wt % to about 30 wt %, from about 10 wt % to about 30 wt %, from about 15 wt % to about 30 wt %, from about 15 wt % to about 25 wt %, or any range or subrange therebetween. In aspects, the composition can be substantially solvent-free and/or solvent-free. Providing a solvent in the composition can enable a wide range of methods of forming a coating with the composition. It is to be understood that any of the above ranges for the above-mentioned components can be combined in aspects of the disclosure.

In aspects, the composition can comprise a viscosity. As used herein, a viscosity of a liquid is measured at 23° C. using a rotational rheometer (e.g., RheolabQC from Anton Par or a Discovery Hybrid Rheometer (DHR-3) from TA Instruments) at a shear rates of about 0.83 1/second (s) (e.g., 50 revolutions per minutes (rpm)). In further aspects, the composition can comprise a viscosity of about 0.01 Pascal-seconds (Pa-s) or more, about 1 Pa-s or more, about 5 Pa-s or more, about 10 Pa-s or more, about 1,000 Pa-s or less, about 500 Pa-s or less, about 100 Pa-s or less, about 50 Pa-s or less, or about 30 Pa-s or less. In aspects, the composition can comprise a viscosity in a range from about 0.01 Pa-s to about 1,000 Pa-s, from about 0.01 Pa-s to about 500 Pa-s, from about 1 Pa-s to about 500 Pa-s, from about 1 Pa-s to about 100 Pa-s, from about 5 Pa-s to about 100 Pa-s, from about 5 Pa-s to about 50 Pa-s, from about 10 Pa-s to about 50 Pa-s, from about 10 Pa-s to about 30 Pa-s, or any range or subrange therebetween. In even further aspects, the composition can comprise a viscosity of about 0.01 Pa-s or more, about 0.1 Pa-s or more, about 0.5 Pa-s or more, about 30 Pa-s or less, about 10 Pa-s or less, about 6 Pa-s or less, or about 3 Pa-s or less. In even further aspects, the composition can comprise a viscosity in a range from about 0.01 Pa-s to about 30 Pa-s, from about 10 Pa-s, from about 0.01 Pa-s to about 6 Pa-s, from about 0.1 to about 6 Pa-s, from about 0.1 to about 3 Pa-s, from about 0.5 Pa-s to about 3 Pa-s, or any range or subrange therebetween.

Example ranges of combination in aspects of the disclosure are presented in Table 1. R1 and R10 are the broadest of the ranges in Table 1. Examples R2-R5, R8-R9, R11-R13, and R16 are solvent-free compositions while R6-R7 and R14-R15 are compositions comprising a solvent. R1-R3 and R6-R10 can comprise a photoinitiator while R1, R3-R5, and R10-R16 can be free from a photoinitiator. R1-R2, R6-R11, and R14-R16 can comprise a silane coupling agent while R1, R3-R5, R10, and R12-R13 can be free from silane coupling agents. R1-R4 and R8-R16 can comprise a reactive diluent while R5-R7, R9-R10, and R16 can be free from reactive diluents. R1, R9-R10, and R16 can comprise nanoparticles while R1-R8 and R10-R15 can be free of nanoparticles. R10-R16 can comprise TMPO while R1-R10 and R12 can be free of TMPO. R10-R16 can comprise a curing catalyst while R1-R10 and R12 can be free of a curing catalyst. Again, it is to be understood that other ranges or subranges discussed above for these components can be used in combination with any of the ranges presented in Table 1. In aspects, the composition within one or more of the ranges in Table 1, but functionalized oligomeric silsesquioxanes, photoinitiator, silane coupling agent, and/or solvent can be added to the composition before forming a coating, for example, as part of a coated article described below.

TABLE 1
Composition ranges (wt %) of aspects of compositions

| Range | R1 | R2 | R3 | R4 | R5 | R6 | R7 | R8 | R9 |
|---|---|---|---|---|---|---|---|---|---|
| Functionalized | 10-99 | 20-99 | 40-99 | 20-99 | 80-95 | 60-95 | 80-95 | 10-85 | 10-50 |
| Oligomeric | | | | | | | | | |
| Silsesquioxane | | | | | | | | | |
| Polymer | 0-80 | 1-80 | 1-60 | 1-80 | 5-20 | 1-60 | 1-15 | 0-20 | 0-15 |
| Reactive | 0-50 | 0-50 | 15-50 | 0-50 | 0 | 0 | 0 | 15-50 | 0-50 |
| Diluent | | | | | | | | | |
| TMPO | 0 | 0 | 0 | 0 | 0 | 0 | 0 | 0 | 0 |
| Curing Catalyst | 0 | 0 | 0 | 0 | 0 | 0 | 0 | 0 | 0 |
| Photoinitiator | 0-3 | 0.1-3 | 0-3 | 0 | 0 | 0-3 | 0.1-3 | 0-3 | 0-3 |
| Silane | 0-5 | 0.1-5 | 0 | 0 | 0 | 0.1-5 | 0.1-5 | 0.1-5 | 0.1-5 |
| Coupling | | | | | | | | | |
| Agent | | | | | | | | | |
| Nanoparticles | 0-50 | 0 | 0 | 0 | 0 | 0 | 0 | 0 | 15-40 |
| Solvent | 0-85 | 0 | 0 | 0 | 0 | 2-50 | 2-18 | 0 | 0 |

| Range | R10 | R11 | R12 | R13 | R14 | R15 | R16 |
|---|---|---|---|---|---|---|---|
| Functionalized | 10-99 | 10-80 | 20-80 | 10-50 | 10-80 | 10-80 | 10-50 |
| Oligomeric | | | | | | | |
| Silsesquioxane | | | | | | | |
| Polymer | 0-80 | 0-10 | 0-10 | 0 | 0-10 | 0-10 | 0-15 |
| Reactive | 0-50 | 15-50 | 15-50 | 15-50 | 15-50 | 15-50 | 0-50 |
| Diluent | | | | | | | |
| TMPO | 0-50 | 5-30 | 0-30 | 5-30 | 5-30 | 5-30 | 5-30 |
| Curing Catalyst | 0-1.1 | 0.3-1.1 | 0-1.1 | 0.3-1.1 | 0.3-1.1 | 0.3-1.1 | 0.3-1.1 |
| Photoinitiator | 0-3 | 0 | 0 | 0 | 0 | 0 | 0 |
| Silane Coupling | 0-5 | 0.1-5 | 0 | 0 | 0.1-5 | 0.1-5 | 0.1-5 |
| Agent | | | | | | | |
| Nanoparticles | 0-50 | 0 | 0 | 0 | 0 | 0 | 15-40 |
| Solvent | 0-85 | 0 | 0 | 0 | 2-50 | 2-18 | 0 |

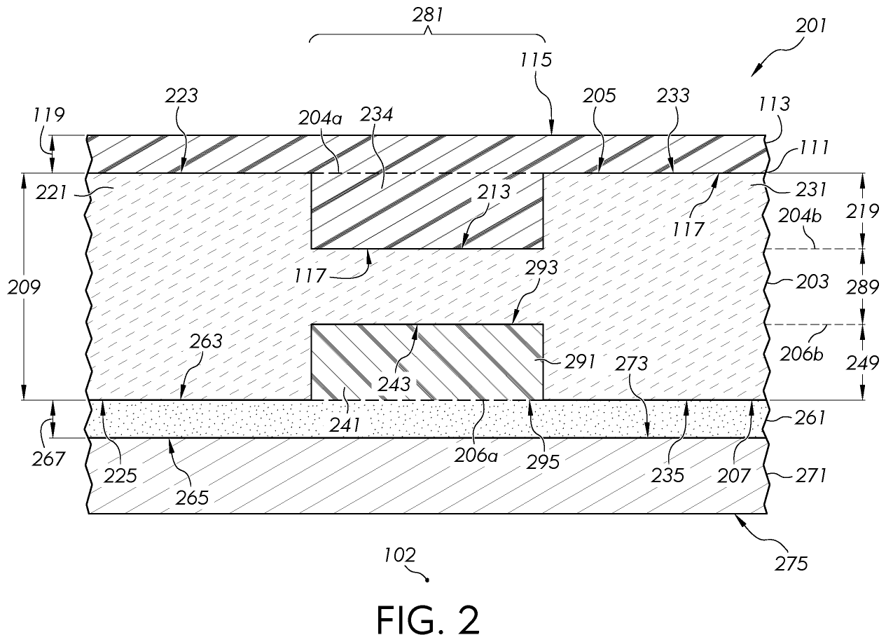

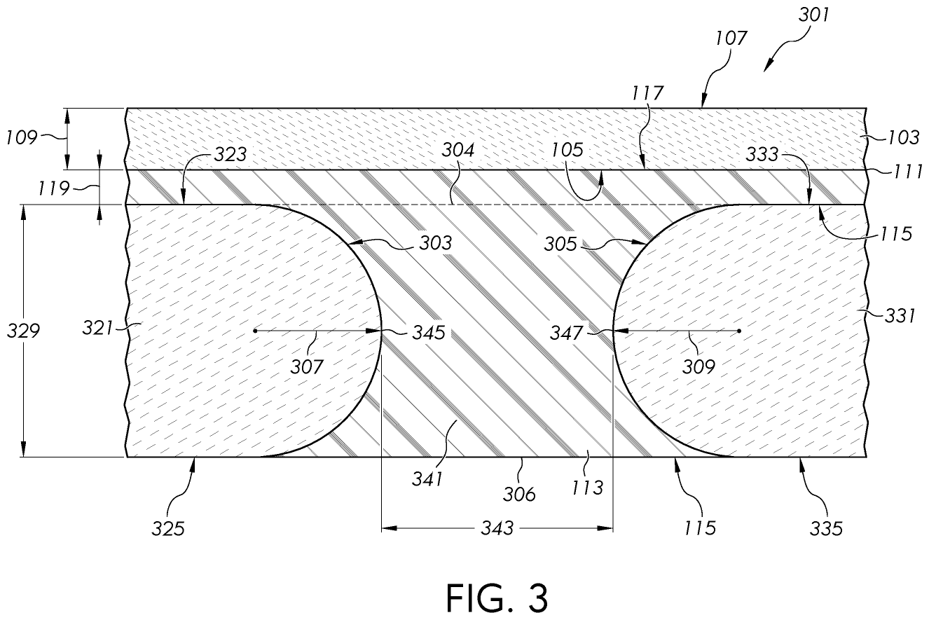

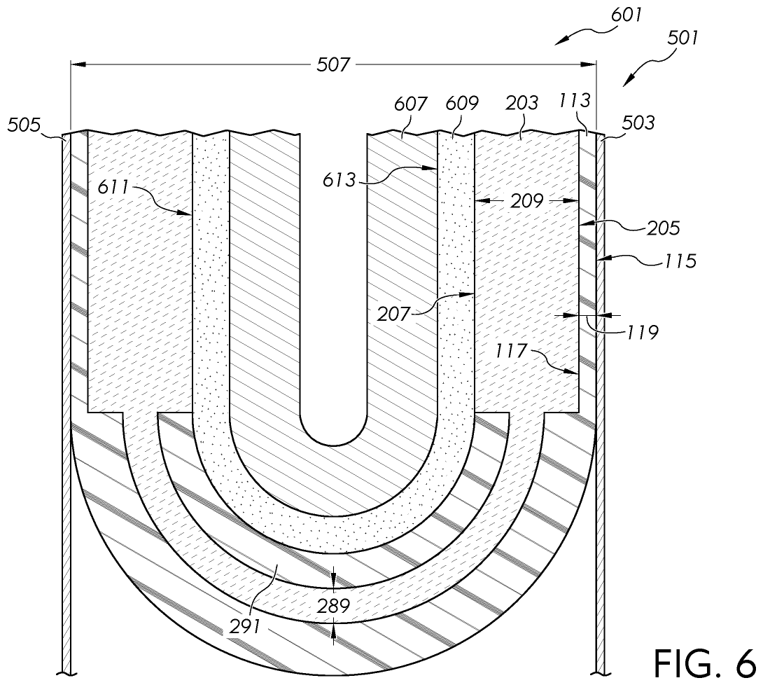

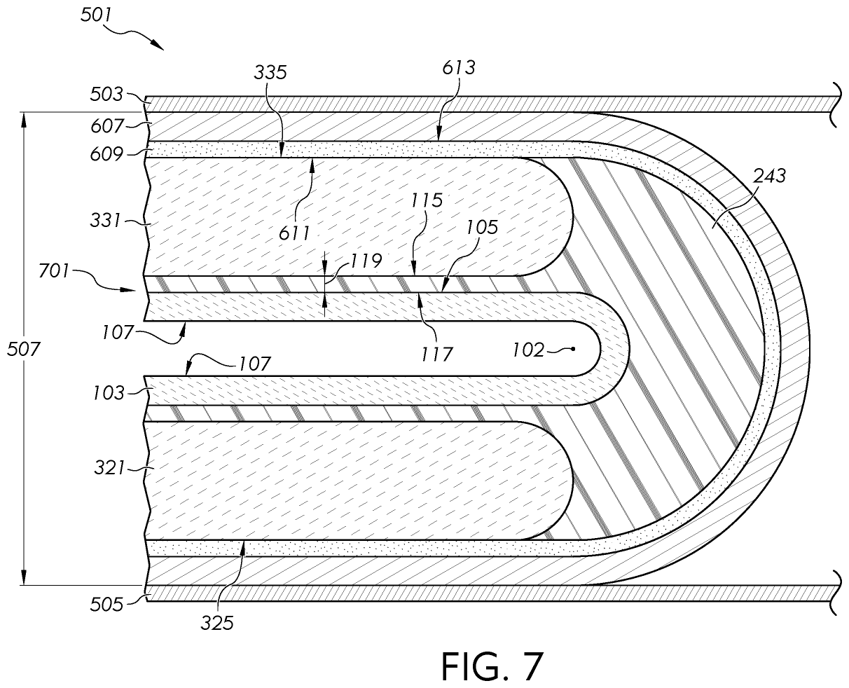

FIGS. 1-3 schematically illustrates an example aspect of a coated article 101, 201, or 301 in an unfolded (e.g., flat configuration) in accordance with aspects of the disclosure while FIGS. 5-7 a schematically illustrates an exemplary aspect of a coated article 401, 601, or 701 in a folded configuration in accordance with aspects of the disclosure. As shown in FIGS. 1 and 5 or 3 and 7, the coated article 101 and 401 or 301 and 701 can comprise a substrate 103 (e.g., foldable substrate). As shown in FIGS. 2 and 6, the coated article 201 and 601 can comprise a substrate 203 (e.g., foldable substrate). As shown in FIGS. 3 and 7, the coated article 301 and 701 can further comprise a first portion 321 and a second portion 331. In aspects, the substrate 103 or 203, the first portion 321, and/or the second portion 331 can comprise a glass-based substrate and/or a ceramic-based substrate having a pencil hardness of 8H or more, for example, 9H or more. As used herein, pencil hardness is measured using ASTM D 3363-20 with standard lead graded pencils. Providing the coating on a substrate increases a durability of the coated article, for example, by filling and/or protecting surface flaws in the substrate from damage. Additionally, the substrate may comprise a glass-based substrate and/or a ceramic-based substrate to enhance puncture resistance and/or impact resistance.

In aspects, the substrate 103 or 203, the first portion 321, and/or the second portion 331 can comprise a glass-based substrate. As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In aspects, glass-based material can comprise an alkali-containing glass or an alkali-free glass, either of which may be free of lithia or not. In aspects, the glass material can be alkali-free and/or comprise a low content of alkali metals (e.g., R₂O of about 10 mol % or less, wherein R₂O comprises Li₂O Na₂O, K₂O, or the more expansive list provided below). In one or more aspects, a glass-based material may comprise, in mole percent (mol %). SiO₂ in a range from about 40 mol % to about 80%, Al₂O₃ in a range from about 5 mol % to about 30 mol %, B₂O₃ in a range from 0 mol % to about 10 mol %, ZrO₂ in a range from 0 mol % to about 5 mol %, P₂O₅ in a range from 0 mol % to about 15 mol %, TiO₂ in a range from 0 mol % to about 2 mol %, R₂O in a range from 0 mol % to about 20 mol %, and RO in a range from 0 mol % to about 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In aspects, a glass-based substrate may optionally further comprise in a range from 0 mol % to about 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. “Glass-ceramics” include materials produced through controlled crystallization of glass. In aspects, glass-ceramics have about 1% to about 99% crystallinity. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including P-quartz solid solution, P-spodumene, cordierite, petalite, and/or lithium disilicate. The glass-ceramic substrates may be strengthened using the chemical strengthening processes. In one or more aspects, MAS-System glass-ceramic substrates may be strengthened in Li₂SO₄ molten salt, whereby an exchange of 2Li⁺ for Mg²⁺ can occur.

In aspects, the substrate 103 or 203, the first portion 321, and/or the second portion 331 can comprise a ceramic-based substrate. As used herein, “ceramic-based” includes both ceramics and glass-ceramics, wherein glass-ceramics have one or more crystalline phases and an amorphous, residual glass phase. Ceramic-based materials may be strengthened (e.g., chemically strengthened). In aspects, a ceramic-based material can be formed by heating a glass-based material to form ceramic (e.g., crystalline) portions. In further aspects, ceramic-based materials may comprise one or more nucleating agents that can facilitate the formation of crystalline phase(s). In aspects, ceramic-based materials can comprise one or more oxides, nitrides, oxynitrides, carbides, borides, and/or silicides. Example aspects of ceramic oxides include zirconia (ZrO₂), zircon (ZrSiO₄), an alkali metal oxide (e.g., sodium oxide (Na₂O)), an alkali earth metal oxide (e.g., magnesium oxide (MgO)), titania (TiO₂), hafnium oxide (Hf₂O), yttrium oxide (Y₂O₃), iron oxides, beryllium oxides, vanadium oxide (VO₂), fused quartz, mullite (a mineral comprising a combination of aluminum oxide and silicon dioxide), and spinel (MgAl₂O₄). Example aspects of ceramic nitrides include silicon nitride (Si₃N₄), aluminum nitride (AlN), gallium nitride (GaN), beryllium nitride (Be₃N₂), boron nitride (BN), tungsten nitride (WN), vanadium nitride, alkali earth metal nitrides (e.g., magnesium nitride (Mg₃N₂)), nickel nitride, and tantalum nitride. Example aspects of oxynitride ceramics include silicon oxynitride, aluminum oxynitride, and a SiAlON (a combination of alumina and silicon nitride and can have a chemical formula, for example, Si₁₂₋ₘ₋ₙAlₘ₊ₙOₙN₁₆₋ₙ, Si₆₋ₙAlₙOₙN₈₋ₙ, or Si₂₋ₙAlₙO₁₊ₙN₂₋ₙ, where m, n, and the resulting subscripts are all non-negative integers). Example aspects of carbides and carbon-containing ceramics include silicon carbide (SiC), tungsten carbide (WC), an iron carbide, boron carbide (B₄C), alkali metal carbides (e.g., lithium carbide (Li₄C₃)), alkali earth metal carbides (e.g., magnesium carbide (Mg₂C₃)), and graphite. Example aspects of borides include chromium boride (CrB₂), molybdenum boride (Mo₂B₅), tungsten boride (W₂B₅), iron boride, titanium boride, zirconium boride (ZrB₂), hafnium boride (HfB₂), vanadium boride (VB₂), Niobium boride (NbB₂), and lanthanum boride (LaB₆). Example aspects of silicides include molybdenum disilicide (MoSi₂), tungsten disilicide (WSi₂), titanium disilicide (TiSi₂), nickel silicide (NiSi), alkali earth silicide (e.g., sodium silicide (NaSi)), alkali metal silicide (e.g., magnesium silicide (Mg₂Si)), hafnium disilicide (HfSi₂), and platinum silicide (PtSi).

In aspects, the substrate 103 or 203, the first portion 321, and/or the second portion 331 can comprise a polymer-based portion comprising a Young's modulus of about 3 GigaPascals (GPa) or more. Exemplary aspects of materials for a polymer-based first portion and/or polymer-based second portion include but are not limited to blends, nanoparticle, and/or fiber composites of one or more of styrene-based polymers (e.g., polystyrene (PS), styrene acrylonitrile (SAN), styrene maleic anhydride (SMA)), phenylene-based polymer (e.g., polyphenylene sulfide (PPS)), polyvinylchloride (PVC), polysulfone (PSU), polyphthalmide (PPA), polyoxymethylene (POM), polylactide (PLA), polyimides (PI), polyhydroxybutyrate (PHB), polyglycolides (PGA), polyethyleneterephthalate (PET), polyethylenenaphthalate (PEN), and/or polycarbonate (PC).

Throughout the disclosure, an elastic modulus (e.g., Young's modulus) of the substrate 103 or 203, the first portion 321, and/or the second portion 331 (e.g., glass-based material, ceramic-based material) is measured using indentation methods in accordance with ASTM E2546-15. In aspects, the substrate 103 or 203, the first portion 321, and/or the second portion 331 can comprise an elastic modulus of about 10 GigaPascals (GPa) or more, about 50 GPa or more, about 60 GPa or more, about 70 GPa or more, about 100 GPa or less, or about 80 or less. In aspects, the substrate 103 or 203, the first portion 321, and/or the second portion 331 can comprise an elastic modulus in a range from about 10 GPa to about 100 GPa, from about 50 GPa to about 100 GPa, from about 50 GPa to about 80 GPa, from about 60 GPa to about 80 GPa, from about 70 GPa ta about 80 GPa, or any range or subrange therebetween.

As shown in FIGS. 1 and 3, the substrate 103 can comprise a first major surface 105 and a second major surface 107 opposite the first major surface 105. As shown in FIG. 1, the first major surface 105 can extend along a first plane 104. As further shown in FIG. 1, the substrate 103 can comprise the second major surface 107 extending along a second plane 106. In aspects, as shown, the second plane 106 can be parallel to the first plane 104. As used herein, a substrate thickness 109 can be defined between the first major surface 105 and the second major surface 107 as a distance between the first plane 104 and the second plane 106. Likewise, as shown in FIG. 2, the substrate 203 can comprise a first major surface 205 that can extend along a first plane 204a and a second major surface 207 that can extend along a second plane 206a. As shown in FIG. 2, the substrate 203 can comprise a substrate thickness 209 defined between the first major surface 205 and the second major surface 207 as a distance between the first plane 204a and a second plane 206a. In aspects, the substrate thickness 109 or 209 can be about 10 micrometers (μm) or more, about 25 μm or more, about 40 μm or more, about 60 μm or more, about 80 μm or more, about 100 μm or more, about 125 μm or more, about 150 μm or more, about 3 millimeters (mm) or less, about 2 mm or less, about 1 mm or less, about 800 μm or less, about 500 μm or less, about 300 μm or less, about 200 μm or less, about 180 μm or less, or about 160 μm or less. In aspects, the substrate thickness 109 or 209 can be in a range from about 10 μm to about 3 mm, from about 10 μm to about 2 mm, from about 25 μm to about 2 mm, from about 40 μm to about 2 mm, from about 60 μm to about 2 mm, from about 80 μm to about 2 mm, from about 100 μm to about 2 mm, from about 100 μm to about 1 mm, from about 100 μm to about 800 μm, from about 100 μm to about 500 μm, from about 125 μm to about 500 μm, from about 125 μm to about 300 μm, from about 125 μm to about 200 μm, from about 150 μm to about 200 μm, from about 150 μm to about 160 μm, or any range or subrange therebetween. In aspects, the substrate thickness 109 or 209 can be in a range from about 80 μm to about 2 mm, from about 80 μm to about 1 mm, from about 80 μm to about 500 μm, from about 80 μm to about 300 μm, from about 200 μm to about 2 mm, from about 200 μm to about 1 mm, from about 200 μm to about 500 μm, from about 500 μm to about 2 mm, from about 500 μm to about 1 mm, or any range or subrange therebetween. In aspects, the substrate thickness can be about 300 μm or less, for example, from about 10 μm to about 300 μm, from 25 μm to about 300 μm, from about 25 μm to about 200 μm, from about 25 μm to about 180 μm, from about 40 μm to about 180 μm, from about 40 μm to about 160 μm, from about 60 μm to about 160 μm, from about 80 μm to about 160 μm, or any range or subrange therebetween.

In aspects, as shown in FIG. 2, the substrate 203 of the coated article 201 can comprise a first portion 221 and a second portion 231. As shown, the first portion 221 can comprise the substrate thickness 209 between a first surface area 223 and a second surface area 225, and the second portion 231 can comprise the substrate thickness 209 between a third surface area 233 and a fourth surface area 235. Similarly, as shown, the second surface area 225 and the fourth surface area 235 can extend along a second plane 206a. In further aspects, as shown, the first surface area 223 and the third surface area 233 can extend along a first plane 204a. In further aspects, the substrate 203 can comprise a central portion 281 positioned between the first portion 221 and the second portion 231. In even further aspects, the central portion 281 can comprise a first central surface area 213 positioned between the first surface area 223 and the third surface area 233 that is recessed from the first plane 204a by a first distance 219 defining a first recess 234. In further aspects, the central portion 281 can comprise a second central surface area 243 positioned between the second surface area 225 and the fourth surface area 235 that is recessed from the second plane 206a by a second distance 249 defining a second recess 241. In even further aspects, the central portion 281 can comprise a central thickness 289 defined between the first central surface area 213 and the second central surface area 243, for example, as a distance between a third plane 204b that the first central surface area 213 can extend along and a fourth plane 206b that the second central surface area 243 can extend along.

In aspects, the central thickness 289 can be about 10 μm or more, about 25 μm or more, about 80 μm or more, about 100 μm or more, about 1 mm or less, about 500 μm or less, or about 200 μm or less. In aspects, the central thickness 289 can be in a range from about 10 μm to about 1 mm, from about 25 μm to about 1 mm, from about 25 μm to about 500 μm, from about 100 μm to about 500 μm, from about 100 μm to about 200 μm, from about 25 μm to about 100 μm, or any range or subrange therebetween. In aspects, the central thickness 289 as a percentage of the substrate thickness 209 can be about 0.5% or more, about 1% or more, about 2% or more, about 5% or more, about 6% or more, about 20% or less, about 13% or less, about 10% or less, or about 8% or less. In aspects, the central thickness 289 as a percentage of the substrate thickness 209 can be in a range from about 0.5% to about 20%, from about 0.5% to about 13%, from about 1% to about 13%, from about 1% to about 10%, from about 2% to about 10%, from about 2% to about 8%, from about 5% to about 8%, from about 6% to about 8%, or any range or subrange therebetween.

In aspects, the second distance 249 can be greater than the first distance 219. In aspects, the first distance 219 can be greater than the second distance 249. In aspects, the first distance 219 and/or the second distance 249 can be less than the central thickness 289. In further aspects, the first distance 219 and/or the second distance 249 as a percentage of the substrate thickness 209 can be about 1% or more, about 2% or more, about 5% or more, about 10% or more, about 12% or more, about 30% or less, about 25% or less, about 20% or less, about 18% or less, or about 15% or less. In further aspects, the first distance 219 and/or the second distance 249 as a percentage of the substrate thickness 209 can be in a range from about 1% to about 30%, from about 1% to about 25%, from about 2% to about 25%, from about 5% to about 25%, from about 5% to about 20%, from about 10% to about 20%, from about 10% to about 18%, from about 12% to about 18%, from about 12% to about 15%, or any range or subrange therebetween.

In aspects, as shown in FIG. 2, the fourth major surface 117 of the coating 113 can contact the first surface area 223 and the third surface area 233. In further aspects, as shown, the coating 113 can extend across the first plane 204a. For example, as shown in FIG. 2, the coating 113 can occupy the first recess 234 between the first portion 321 and the second portion 331, and/or the coating 113 (e.g., fourth major surface 117) can contact the first central surface area 213.

In aspects, as shown in FIG. 2, a polymer-based portion 291 can occupy at least a portion of the second recess 241. For example, the polymer-based portion 291 can comprise a polymer thickness between a fifth major surface 293 and a sixth major surface 295 that can be equal to the second distance 249. In aspects, as shown, the fifth major surface 293 of the polymer-based portion 291 can contact the second central surface area 243. In aspects, as shown, the sixth major surface 295 of the polymer-based portion 291 can comprise a planar surface, for example, being coplanar (e.g., extending along a common, second plane 206a) with the second surface area 225 the fourth surface area 235. In aspects, the polymer-based portion 291 comprises a polymer (e.g., optically transparent polymer). In further aspects, the polymer-based portion 291 can comprise one or more of an optically transparent: an acrylic (e.g., polymethylmethacrylate (PMMA)), an epoxy, silicone, and/or a polyurethane. Examples of epoxies include bisphenol-based epoxy resins, novolac-based epoxies, cycloaliphatic-based epoxies, and glycidylamine-based epoxies. In further aspects, the polymer-based portion 291 can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and/or polyether ether ketone (PEEK). Example aspects of polyolefins include low molecular weight polyethylene (LDPE), high molecular weight polyethylene (HDPE), ultrahigh molecular weight polyethylene (UIMWPE), and polypropylene (PP). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example aspects of elastomers include rubbers (e.g., polybutadiene, polyisoprene, chloroprene rubber, butyl rubber, nitrile rubber), polyurethanes, and block copolymers (e.g., styrene-butadiene, high-impact polystyrene, polydichlorophosphazene) comprising one or more of polystyrene, polydichlorophosphazene, and/or poly(5-ethylidene-2-norbornene). In aspects, the polymer-based portion 291 can further comprise nanoparticles, for example, carbon black, carbon nanotubes, silica nanoparticles, or nanoparticles comprising a polymer. In aspects, the polymer-based portion can further comprise fibers to form a polymer-fiber composite.

In aspects, as shown in FIG. 2, the coated article 201 can further comprise an adhesive layer 261. The adhesive layer 261 can comprise an adhesive thickness 267 defined between a seventh major surface 263 and an eighth major surface 265. In aspects, the adhesive thickness 267 can be about 5 μm or more, about 10 μm or more, about 25 μm or more, about 40 μm or more, about 60 μm or more, about 80 μm or more, about 100 μm or more, about 400 μm or less, about 300 μm or less, about 250 μm or less, about 200 μm or less, about 180 μm or less, about 160 μm or less, or about 160 μm or less. In aspects, the adhesive thickness 267 can be in a range from about 5 μm to about 400 μm, from about 5 μm to about 300 μm, from about 10 μm to about 300 μm, from about 10 μm to about 200 μm, from about 25 μm to about 200 μm, from about 25 μm to about 180 mm, from about 40 μm to about 180 μm, from about 40 μm to about 160 μm, from about 60 μm to about 160 μm, from about 60 μm to about 140 μm, from about 80 μm to about 140 μm, from about 100 μm to about 140 μm, or any range or subrange therebetween.

In further aspects, as shown, the seventh major surface 263 of the adhesive layer 261 can face and/or contact the second surface area 225 and the fourth surface area 235. In even further aspects, as shown, the seventh major surface 263 of the adhesive layer 261 can face and/or contact the sixth major surface 295 of the polymer-based portion 291. In even further aspects, the adhesive layer 261 can occupy the second recess 241 instead of or in addition to the polymer-based portion 291. In aspects, the polymer-based portion 291 can occupy the region shown as being occupied by the adhesive layer 261.

In aspects, the adhesive layer 261 can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). Example aspects of polyolefins include low molecular weight polyethylene (LDPE), high molecular weight polyethylene (HDPE), ultrahigh molecular weight polyethylene (UHMWPE), and polypropylene (PP). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example aspects of elastomers include rubbers (e.g., polybutadiene, polyisoprene, chloroprene rubber, butyl rubber, nitrile rubber) and block copolymers (e.g., styrene-butadiene, high-impact polystyrene, poly(dichlorophosphazene). In further aspects, the adhesive layer 261 can comprise an optically clear adhesive. In even further aspects, the optically clear adhesive can comprise one or more optically transparent polymers: an acrylic (e.g., polymethylmethacrylate (PMMA)), an epoxy, silicone, and/or a polyurethane. Examples of epoxies include bisphenol-based epoxy resins, novolac-based epoxies, cycloaliphatic-based epoxies, and glycidylamine-based epoxies. In even further aspects, the optically clear adhesive can comprise, but is not limited to, acrylic adhesives, for example, 3M 8212 adhesive, or an optically transparent liquid adhesive, for example, a LOCTITE optically transparent liquid adhesive. Exemplary aspects of optically clear adhesives comprise transparent acrylics, epoxies, silicones, and polyurethanes. For example, the optically transparent liquid adhesive could comprise one or more of LOCTITE AD 8650, LOCTITE AA 3922, LOCTITE EA E-05MR, LOCTITE UK U-09LV, which are all available from Henkel.

In aspects, as shown in FIG. 2, the coated article 201 can further comprise a release liner 271. The release liner 271 can comprise a fifth major surface 273 and a sixth major surface 275 opposite the fifth major surface. In further aspects, as shown, the second major surface 207 of the substrate 203 can face the fifth major surface 273 of the release liner 271. In even further aspects, the eighth major surface 265 of the adhesive layer 261 can contact the fifth major surface 273 of the release liner 271. In further aspects, the release liner 271 can comprise a paper and/or a polymer. Exemplary aspects of paper comprise kraft paper, machine-finished paper, poly-coated paper (e.g., polymer-coated, glassine paper, siliconized paper), or clay-coated paper. Exemplary aspects of polymers comprise polyesters (e.g., polyethylene terephthalate (PET)), fluorine-containing polymers (e.g., polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers), and polyolefins (e.g., low-density polyethylene (LDPE), high-density polyethylene (HDPE), polypropylene (PP)). In aspects, as shown in FIG. 3, the coated article 301 may not comprise a release liner. Providing a release liner 271 can provide support for the layer and/or protect the first major surface of the layer from contamination to enable good adhesion in a laminate that the layer (e.g., film) can be incorporated into.

In aspects, as shown in FIG. 3, the coated article 301 can comprise a first portion 321 and a second portion 331. In further aspects, as shown, the first portion 321 can comprise a first surface area 323 opposite a second surface area 325. In further aspects, as shown, the second portion 331 can comprise a third surface area 333 opposite a fourth surface area 335. In further aspects, as shown, the first surface area 323 and/or the third surface area 333 can extend along a third plane 304, and/or the second surface area 325 and/or the fourth surface area 335 can extend along a fourth plane 306. In even further aspects, a portion thickness 329 can be defined between the third plane 304 and the fourth plane 306 and can be within one or more of the ranges discussed above for the substrate thickness 109.

In further aspects, as shown in FIG. 3, the first portion 321 can comprise a first edge surface area 303 extending between the first surface area 323 and the second surface area 325, and/or the second portion 331 can comprise a second edge surface area 305 extending between the third surface area 333 and the fourth surface area 335. In even further aspects, as shown in FIG. 3, the first edge surface area 303 and/or the second edge surface area 305 can comprise a first outwardly convex curved edge surface and/or a second outwardly convex curved edge surface, respectively. In still further aspects, the first edge surface area 303 and/or the second edge surface area 305 can comprise a cross-sectional profile taken perpendicular to the edge surface that is the shape of an arc of a circle, although other shapes, for example, ellipses, are possible. In yet further aspects, the first outwardly convex curved edge surface and/or the second outwardly convex curved edge surface can be characterized by a first radius of curvature 307 and/or a second radius of curvature 309, respectively. In still yet further aspects, the first radius of curvature 307 and/or the second radius of curvature 309 as a percentage of the portion thickness 329 can be about 30% or more, about 40% or more, about 45% or more, about 49% or more, about 70% or less, about 60% or less, about 55% or less, or about 51% or less. In even further aspects, the first radius of curvature 307 and/or the second radius of curvature 309 as a percentage of the portion thickness 329 can be in a range from about 30% to about 70%, from about 30% to about 60%, from about 30% to about 55%, from about 30% to about 51%, from about 40% to about 70%, from about 40% to about 60%, from about 40% to about 55%, from about 40% to about 51%, from about 45% to about 70%, from about 45% to about 60%, from about 45% to about 55%, from about 45% to about 51%, from about 49% to about 70%, from about 49% to about 60%, from about 49% to about 55%, from about 49% to about 51%, or any range or subrange therebetween. In further aspects, although not shown, the first edge surface area and/or the second edge surface area can comprise linear (e.g., planar) edge surfaces, namely, a first linear edge surface and/or a second linear edge surface, respectively.

As shown in FIG. 3, a minimum distance 343 between the first portion 321 and the second portion 331 can be defined between the first edge surface area 303 and the second edge surface area 305. The minimum distance 343 between the first portion 321 and the second portion 331 is equal to the minimum distance between the outer peripheral portion 345 of the first edge surface area 303 and the outer peripheral portion 347 of the second edge surface area 305 when the coated article is in the configuration shown in FIG. 3. In aspects, as shown, the first portion 321 can be a physical distinct structure from the second portion 331 that is separated from the first portion 321 by the minimum distance 343. In aspects, the minimum distance 343 between the first portion 321 and the second portion 331 can be about 1 times or more, about 1.4 times or more, about 1.5 times or more, about 2 times or more, about 3 times or less, about 2.5 times or less, or about 2 times or less the minimum parallel plate distance of the coated article. In aspects, the minimum distance 343 as a multiple of the minimum parallel plate distance can be in a range from about 1.4 times to about 3 times, from about 1.4 times to about 2.5 times, from about 1.4 times to about 2 times, from about 1.5 times to about 3 times, from about 1.5 times to about 2.5 times, from about 1.5 times to about 2 times, from about 2 times to about 3 times, from about 2 times to about 2.55 times, or any range or subrange therebetween. Without wishing to be bound by theory, the length of a bent portion in a circular configuration between parallel plates can be about 0.8 times the parallel plate distance 507. In aspects, the minimum distance 343 can be about 1 mm or more, about 2 mm or more, about 4 mm or more, about 5 mm or more, about 10 mm or more, about 20 mm or more, about 40 mm or more, about 200 mm or less, about 100 mm or less, or about 60 mm or less. In aspects, the minimum distance 343 can be in a range from about 1 mm to about 200 mm, from about 5 mm to about 200 mm, from about 10 mm to about 175 mm, from about 20 mm to about 150 mm, from about 30 mm to about 125 mm, from about 40 mm to about 100 mm, from about 50 mm to about 90 mm, from about 60 mm to about 80 mm, from about 5 mm to about 60 mm, from about 10 mm to about 60 mm, from about 20 mm to about 60 mm, from about 40 mm to about 60 mm, or any range or subrange therebetween. In aspects, the minimum distance 343 can be in a range from about 1 mm to about 100 mm, from about 1 mm to about 60 mm, from about 1 mm to about 40 mm, from about 1 mm to about 30 mm, from about 2 mm to about 30 mm, from about 2 mm to about 20 mm, from about 5 mm to about 20 mm, from about 10 mm to about 20 mm, or any range or subrange therebetween. In aspects, the minimum distance 343 can be in a range from about 1 mm to about 20 mm, from about 1 mm to about 10 mm, from about 2 mm to about 10 mm, from about 2 mm to about 5 mm, or any range or subrange therebetween. By providing a minimum distance between the first portion and the second portion, folding of the coated article without failure can be facilitated.

In aspects, as shown in FIG. 3, the third major surface 115 of the coating 113 can contact the first surface area 323 and the third surface area 333. In further aspects, as shown, the coating 113 can extend across the third plane 304 to contact the first major surface 105 of the substrate 103 while occupying a region 341 between the first portion 321 and the second portion 331. For example, as shown in FIG. 3, the coating 113 can occupy the region 341 between the first portion 321 and the second portion 331, the coating 113 can contact the first edge surface area 303 and/or the second edge surface area 305, and/or the coating 113 can extend to the fourth plane 306 (e.g., a portion of the third major surface 115 can extend along the fourth plane 306).

In aspects, the substrate 103 or 203, the first portion 321, and/or the second portion 331 may comprise a glass-based substrate and/or ceramic-based substrate where one or more portions of the substrate may comprise a compressive stress region. In aspects, the compressive stress region may be created by chemically strengthening the substrate. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the substrate can enable small (e.g., smaller than about 10 mm or less) bend radii because the compressive stress from the chemical strengthening can counteract the bend-induced tensile stress on the outermost surface of the substrate (e.g., first major surface 105 in FIGS. 5 and 7, first major surface 205 in FIG. 6). A compressive stress region may extend into a portion of the substrate for a depth called the depth of compression. As used herein, depth of compression means the depth at which the stress in the chemically strengthened substrates described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate is generated by exchanging potassium ions into the substrate, a surface stress meter, for example, the FSM-6000 (Orihara Industrial Co., Ltd. (Japan)), is used to measure a depth of compression. Unless specified otherwise, compressive stress (including surface CS) is measured by surface stress meter (FSM) using commercially available instruments, for example, the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 75 μm, SCALP is used to measure the depth of compression and central tension (CT). Where the stress in the substrate is generated by exchanging both potassium and sodium ions into the glass, and the article being measured is thicker than about 75 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate (e.g., sodium, potassium). Through the disclosure, when the central tension cannot be measured directly by SCALP (as when the article being measured is thinner than about 75 μm) the maximum central tension can be approximated by a product of a maximum compressive stress and a depth of compression divided by the difference between the thickness of the substrate and twice the depth of compression, wherein the compressive stress and depth of compression are measured by FSM.

In aspects, the substrate 103 may be chemically strengthened to form a first compressive stress region extending to a first depth of compression from the first major surface 105. In aspects, the substrate 103 may be chemically strengthened to form a second compressive stress region extending to a second depth of compression from the second major surface 107. In even further aspects, the first depth of compression (e.g., from the first major surface 105) and/or second depth of compression (e.g., from the second major surface 107) as a percentage of the substrate thickness 109 can be about 1% or more, about 5% or more, about 10% or more, about 30% or less, about 25% or less, or about 20% or less. In even further aspects, the first depth of compression and/or the second depth of compression as a percentage of the substrate thickness 109 can be in a range from about 1% to about 30%, from about 1% to about 25%, from about 5% to about 25%, from about 5% to about 20%, from about 10% to about 20%, or any range or subrange therebetween. In aspects, the first depth of compression and/or the second depth of compression can be about 1 μm or more, about 10 μm or more, about 50 μm or more, about 200 μm or less, about 150 μm or less, or about 100 μm or less. In aspects, the first depth of compression and/or the second depth of compression can be in a range from about 1 μm to about 200 μm, from about 1 μm to about 150 μm, from about 10 μm to about 150 μm, from about 50 μm to about 150 μm, from about 50 μm to about 100 μm, or any range or subrange therebetween. In aspects, the first depth of compression can be greater than, less than, or substantially the same as the second depth of compression. By providing a glass-based substrate and/or a ceramic-based substrate comprising a first depth of compression and/or a second depth of compression in a range from about 1% to about 30% of the first thickness, good impact and/or puncture resistance can be enabled.

In aspects, the substrate 103 can comprise a first depth of layer of one or more alkali metal ions associated with the first compressive stress region and/or a second depth of layer of one or more alkali metal ions associated with the second compressive stress region. In aspects, the first depth of layer and/or second depth of layer as a percentage of the substrate thickness 109 can be about 1% or more, about 5% or more, about 10% or more, about 15% or more, about 20% or more, about 35% or less, about 30% or less, about 25% or less, or about 22% or less. In aspects, the first depth of layer and/or second depth of layer as a percentage of the substrate thickness 109 can be in a range from about 1% to about 35%, from about 5% to about 35%, from about 5% to about 30%, from about 10% to about 30%, from about 10% to about 25%, from about 15% to about 25%, from about 15% to about 22%, from about 20% to about 22%, or any range or subrange therebetween. In aspects, the first depth of layer and/or second depth of layer can be about 1 μm or more, about 10 μm or more, about 50 μm or more, about 200 μm or less, about 150 μm or less, or about 100 μm or less. In aspects, the first depth of layer and/or second depth of layer of layer can be in a range from about 1 μm to about 200 μm, from about 1 μm to about 150 μm, from about 10 μm to about 150 μm, from about 50 μm to about 150 μm, from about 50 μm to about 100 μm, or any range or subrange therebetween.

In aspects, the first compressive stress region can comprise a maximum first compressive stress. In aspects, the second compressive stress region can comprise a maximum second compressive stress. In further aspects, the maximum first compressive stress and/or the maximum second compressive stress can be about 100 MegaPascals (MPa) or more, about 300 MPa or more, about 500 MPa or more, about 700 MPa or more, about 1,500 MPa or less, about 1,200 MPa or less, about 1,000 MPa or less, or about 900 MPa or less. In further aspects, the maximum first compressive stress and/or the maximum second compressive stress can be in a range from about 100 MPa to about 1,500 MPa, from about 100 MPa to about 1,200 MPa, from about 300 MPa to about 1,200 MPa, from about 300 MPa to about 1,000 MPa, from about 500 MPa to about 1,000 MPa, from about 700 MPa to about 1,000 MPa, from about 700 MPa to about 900 MPa, or any range or subrange therebetween. Providing a maximum first compressive stress and/or a maximum second compressive stress in a range from about 100 MPa to about 1,500 MPa can enable good impact and/or puncture resistance.

In aspects, the substrate 103 can comprise a central tension region positioned between the first compressive stress region and the second compressive stress region. In further aspects, the central tension region can comprise a maximum central tensile stress. In aspects, the maximum central tensile stress can be about 50 MPa or more, about 100 MPa or more, about 200 MPa or more, about 250 MPa or more, about 750 MPa or less, about 600 MPa or less, about 500 MPa or less, about 450 MPa or less, about 400 MPa or less, about 350 MPa or less, or about 300 MPa or less. In aspects, the maximum central tensile stress can be in a range from about 50 MPa to about 750 MPa, from about 50 MPa to about 600 MPa, from about 100 MPa to about 600 MPa, from about 100 MPa to about 500 MPa, from about 200 MPa to about 500 MPa, from about 200 MPa to about 450 MPa, from about 250 MPa to about 450 MPa, from about 250 MPa to about 350 MPa, from about 250 MPa to about 300 MPa, or any range or subrange therebetween.

In further aspects, with reference to FIG. 2, the first surface area 223 of the first portion 221 and the third surface area 233 of the second portion 231 can comprise the first compressive stress region, the first depth of compression, the first depth of layer, and/or the maximum first compressive stress discussed above. In further aspects, with reference to FIG. 2, the second surface area 225 of the first portion 221 and the fourth surface area 235 of the second portion 231 can comprise the second compressive stress region, the second depth of compression, the second depth of layer, and/or the maximum second compressive stress discussed above. In further aspects, the central portion 281 can be chemically strengthened to form a first central compressive stress region extending to a first central depth of compression from the first central surface area 213 and/or a second central compressive stress region extending to a second central depth of compression from the second central surface area 243. In even further aspects, the first central depth of compression as a percentage of the central thickness 289 and/or the second central depth of compression as a percentage of the central thickness 289 can be within one or more of the ranges discussed above for the first depth of compression and/or the second depth of compression as a percentage of the substrate thickness. In even further aspects, the first central compressive stress region can comprise a first central depth of layer of one or more alkali metal ions associated with the first central compressive stress region and/or the second central compressive stress region can comprise a second central depth of layer of one or more alkali metal ions associated with the second central compressive stress region. In still further aspects, the first central depth of layer as a percentage of the central thickness 289 and/or the second central depth of layer as a percentage of the central thickness 289 can be within one or more of the ranges discussed above for the first depth of layer and/or the second depth of layer as a percentage of the substrate thickness. In even further aspects, the first central compressive stress region can comprise a maximum first central compressive stress and/or the second central compressive stress region can comprise a maximum second central compressive stress that can be within one or more of the ranges discussed above for the maximum first compressive stress and/or the maximum second compressive stress.

In further aspects, with reference to FIG. 3, the first portion 321 and/or the second portion 331 can comprise a glass-based substrate or a ceramic-based substrate. In aspects, the first portion 321 can be chemically strengthened to form a third compressive stress region extending to a third depth of compression from the first surface area 323 and/or a fourth compressive stress region extending to a fourth depth of compression from the second surface area 325. In aspects, the second portion 331 can be chemically strengthened to form a fifth compressive stress region extending to a fifth depth of compression from the third surface area 333 and/or a sixth compressive stress region extending to a sixth depth of compression from the fourth surface area 335. In even further aspects, the third depth of compression, the fourth depth of compression, the fifth depth of compression, and/or the sixth depth of compression as a percentage of the portion thickness 329, can be within one or more of the ranges discussed above for the first depth of compression and/or the second depth of compression as a percentage of the substrate thickness. In even further aspects, the third compressive stress region can comprise a third depth of layer of one or more alkali metal ions associated with the third compressive stress region, the fourth compressive stress region can comprise a fourth depth of layer of one or more alkali metal ions associated with the fourth compressive stress region, the fifth compressive stress region can comprise a fifth depth of layer of one or more alkali metal ions associated with the fifth compressive stress region, and/or the sixth compressive stress region can comprise a sixth depth of layer of one or more alkali metal ions associated with the sixth depth of compression. In still further aspects, the third depth of layer, fourth depth of layer, fifth depth of layer, and/or sixth depth of layer as a percentage of the portion thickness 329 can be within one or more of the ranges discussed above for the first depth of layer and/or the second depth of layer as a percentage of the substrate thickness. In even further aspects, the third compressive stress region can comprise a maximum third compressive stress, the fourth compressive stress region can comprise a maximum fourth compressive stress, the fifth compressive stress region can comprise a maximum fifth compressive stress, and/or the sixth compressive stress region can comprise a maximum sixth compressive stress that can be within one or more of the ranges discussed above for the maximum first compressive stress and/or the maximum second compressive stress.

In aspects, as shown in FIGS. 1-3 and 5-6, the coated article 101, 201, 301, 401, and 601 can comprise a coating 113. As shown, the coating 113 can comprise a third major surface 115 and a fourth major surface 117 opposite the third major surface 115. A coating thickness 119 can be defined between the third major surface 115 and the fourth major surface 117 as a minimum distance between the third major surface 115 and the fourth major surface 117. In further aspects, the coating thickness 119 can be about 0.1 μm or more, about 1 μm or more, about 3 μm or more, about 5 μm or more, about 10 μm or more, about 15 μm or more, about 20 μm or more, about 25 μm or more, about 40 μm or more, about 50 μm or more, about 60 μm or more, about 70 μm or more, about 80 μm or more, about 90 μm or more, about 200 μm or less, about 150 μm or less, about 100 μm or less, about 80 μm or less, or about 50 μm or less, about 30 μm or less, about 25 μm or less, about 20 μm or less, about 20 μm or less, about 15 μm or less, or about 10 μm or less. In aspects, the coating thickness 119 can be in a range from about 0.1 μm to about 200 μm, from about 1 μm to about 200 μm, from about 1 μm to about 150 μm, from about 5 μm to about 150 μm, from about 5 μm to about 100 μm, from about 10 μm to about 100 μm, from about 20 μm to about 100 μm, from about 20 μm to about 80 μm, from about 30 μm to about 80 μm, from about 40 μm to about 80 μm, from about 50 μm to about 80 μm, from about 60 μm to about 80 μm, or any range or subrange therebetween. In further aspects, the coating thickness 119 can be about 50 μm or less, for example, from about 0.1 μm to about 50 μm, from about 1 μm to about 50 μm, from about 1 μm to about 30 μm, from about 3 μm to about 30 μm, from about 5 μm to about 30 μm, from about 5 μm to about 25 μm, from about 10 μm to about 20 μm, from about 15 μm to about 20 μm, or any range or subrange therebetween. In aspects, the coating thickness 119 can be about 50 μm or more, for example, from about 50 μm to about 200 μm, from about 60 μm to about 200 μm, from about 60 μm to about 150 μm, from about 70 μm to about 150 μm, from about 70 μm to about 100 μm, from about 80 μm to about 100 μm, or any range or subrange therebetween.

As shown in FIGS. 1-2, the coating 113 can be disposed over the substrate 103 or 203. In further aspects, as shown, the coating 113 can be disposed over the first major surface 105 or 205 of the substrate 103 or 203. In even further aspects, as shown, the fourth major surface 117 of the coating 113 can contact the first major surface 105 or 205 at an interface 111. In aspects, the interface 111 can comprise a silane coupling agent bonded to one or both of the first major surface 105 or 205 of the substrate 103 or 205 or the fourth major surface 117 of the coating 113.

The coating 113 can comprise a plurality of functionalized oligomeric silsesquioxanes. In aspects, a functional group functionalizing a first functionalized oligomeric silsesquioxane and/or the second functionalized oligomeric silsesquioxane of the plurality of functionalized oligomeric silsesquioxanes can comprise any of the functional groups discussed above as functionalizing a functionalized oligomeric silsesquioxane. In further aspects, the functional group functionalizing a first functionalized oligomeric silsesquioxane and/or the second functionalized oligomeric silsesquioxane of the plurality of functionalized oligomeric silsesquioxanes can comprise a glycidyl functional group (e.g., glycidyloxypropyl) and/or an epoxy functional group (e.g., epoxycyclohexyl). In aspects, the wherein the plurality of functionalized oligomeric silsesquioxanes can comprise a plurality of functionalized polyhedral oligomeric silsesquioxanes (POSS). In even further aspects, a first functionalized POSS and/or a second functionalized POSS of the plurality of functionalized POSS can be functionalized by a glycidyl functional group (e.g., glycidyloxypropyl) and/or an epoxy functional group (e.g., epoxycyclohexyl).

As discussed above for the composition, the coating 113 can comprise a first functionalized oligomeric silsesquioxane of the plurality of functionalized oligomeric silsesquioxanes is bonded to a second functionalized oligomeric silsesquioxane of the plurality of functionalized oligomeric silsesquioxanes by a linker (e.g., polymer) terminated with a first functional group at a first end of the linker and a second functional group at a second end of the linker opposite the first end of the linker. In aspects, the linker can comprise a polymer comprising any of the polymers discussed above as attaching the first functionalized oligomeric silsesquioxane to the second functionalized oligomeric silsesquioxane. In aspects, the linker can comprise any of the non-polymeric linkers discussed above. In aspects, the linker can comprise an oxygen atom in a backbone of the linker. In further aspects, the oxygen atom can be in a plurality of monomers of the linker comprising a polymer. In further aspects, the polymer can comprise poly(dimethylsiloxane) and/or poly(propylene oxide). In aspects, the linker (e.g., polymer) can be substantially-free of urethanes, acrylates, and/or polycarbonates. In aspects, the linker can comprise a linear polymer, a branched polymer, a star polymer, and/or a dendrimer polymer. In aspects, the linker can comprise a polymer comprising a glass transition temperature (Tg) within one or more of the ranges discussed above for the glass transition of the polymer. In further aspects, the number average molecular weight of the polymer can be within one or more of the ranges discussed above for the number average molecular weight of the polymer. In aspects, substantially all of the linkers (e.g., polymers) can be attached to two functionalized oligomeric silsesquioxane. In aspects, the first functional group and/or the second functional group can comprise one or more of the functional groups discussed above as functional groups at an end (e.g., first end, second end) of the linker (e.g., polymer). In further aspects, the first functional group and/or the second functional group can comprise acid alcohols, anhydrides, amides, amines, alcohols, chlorides, cyanides, epoxies, thiols, and/or magnesium halides. In even further aspects, the first functional group and/or the second functional group can comprise an amine (e.g., aminopropyl). In further aspects, the first functional group and/or the second functional group can be the same as the normal terminal functional group of the polymer. In further aspects, the first group and/or the second functional group can be different than the normal terminal functional group of the polymer. In further aspects, the first functional group can be different than the normal terminal functional group of the polymer and the second functional group can be different than the normal terminal group of the polymer. In aspects, the first functional group and/or the second functional group can comprise alcohols, acrylates, epoxies, ureidos, or combinations thereof.

In aspects, the composition can comprise a third functionalized oligomeric silsesquioxane not bonded to a linker (e.g., polymer) in addition to the first functionalized oligomer silsesquioxane and the second functionalized oligomeric silsesquioxane bonded to the linker (e.g., polymer). In further aspects, the coating 113 can comprise more functionalized oligomeric silsesquioxanes than the composition discussed above. In aspects, a ratio of a number of the linkers (e.g., polymers) (e.g., on a mol basis) to a number of functionalized oligomeric silsesquioxanes (e.g., on a mol basis) can be within one or more of the ranges discussed above (e.g., from about 0.001 to about 0.06). In aspects, a weight percent (wt %) of the plurality of functionalized oligomeric silsesquioxanes to a total weight of the plurality of functionalized oligomeric silsesquioxanes and the linker (e.g., polymer) can be within one or more of the ranges discussed above. In aspects, a weight percent (wt %) of the plurality of functionalized oligomeric silsesquioxanes to a total weight of the plurality of functionalized oligomeric silsesquioxanes and the polymer can be about 20% or more, about 40% or more, about 60% or more, about 80% or more, about 90% or more, about 99% or less, about 97% or less, about 95% or less, or about 93% or less. In aspects, a weight percent (wt %) of the plurality of functionalized oligomeric silsesquioxanes to a total weight of the plurality of functionalized oligomeric silsesquioxanes and the polymer can be in a range from about 30% to about 99%, from about 40% to about 99%, from about 40% to about 97%, from about 50% to about 97%, from about 60% to about 95%, from about 70% to about 95%, from about 80% to about 93%, from about 90% to about 93%, from about 90% to about 97%, from about 90% to about 95%, or any range or subrange therebetween. In aspects, a weight percent (wt %) of the plurality of functionalized oligomeric silsesquioxanes can be within one or more of the wt % ranges discussed earlier in this paragraph. Providing a low mol ratio (e.g., about 0.06 or less) of the polymer to the plurality of functionalized oligomeric silsesquioxanes can produce polymers bonded to two functionalized oligomeric silsesquioxanes, which can achieve the benefits described herein.

In aspects, the coating 113 can comprise a silane coupling agent. In further aspects, the silane coupling agent can comprise one or more of the silane coupling agents discussed above. In even further aspects, the silane coupling agent can comprise (3-triethoxysilyl)propylsuccinic anhydride, (3-mercaptopropyl)trimethoxysilane, and/or 2-(3,4-epoxycyclohexyl)ethyltrimethoxysilane. In aspects, the coating 113 can comprise a photoinitiator. In further aspects, the photoinitiator can comprise one or more of the photoinitiators discussed above. In even further aspects, the photoinitiator can comprise a UV-sensitive photoinitiator. In even further aspects, the photoinitiator can be configured to initiate cationic polymerization. In even further aspects, the photoinitiator can be configured to initiate radical polymerization. Without wishing to be bound by theory, alcohol, acrylate, epoxy, and ureido functional groups readily react (e.g., polymerize) when a free radical photoinitiator is activated while acid alcohol, anhydride, amide, amine, alcohol, chloride, cyanide, epoxy, thiol, and magnesium halide functional groups readily react (e.g., polymerize) when a cationic photoinitiator is activated. In aspects, the coating 113 can comprise a more silane coupling agent and/or photoinitiator than was present in the composition discussed above, for example, if silane coupling agent and/or photoinitiator is added before forming the coating. In aspects, the coating 113 can be substantially free of fluorine-based compounds. As used herein, the coating can be substantially free of fluorine-based compounds while containing a trace amount of fluorine in a minor component (e.g., about 2 wt % or less of a photoinitiator) of the composition corresponding to an overall wt % of fluorine of about 0.5 wt % or less. In further aspects, the coating 113 can be free of fluorine-based compounds. In aspects, the coating 113 can be free of a photoinitiator. Providing coatings free from a photoinitiator can be free from yellowing issues. In aspects, the coating 113 can be free of a silane coupling agent, for example, when the coating comprises a high adhesion value without a silane coupling agent.

In aspects, the coating can be substantially free of nanoparticles. In aspects, the coating can be substantially free of silica nanoparticles. In further aspects, the composition can be free of silica nanoparticles. Providing a coating and/or coated article substantially free and/or free of silica nanoparticles can improve optical properties (e.g., maintain low haze and/or high transmittance even after aging at elevated temperature and/or humidity) and/or reduce mechanical properties (e.g., hardness, modulus, strain) of the resulting coating and/or coated article compared to a corresponding coating, and/or coated article comprising a plurality of functionalized oligomeric silsesquioxanes without silica nanoparticles. In aspects, the composition can comprise silica nanoparticles, alumina nanoparticles, zirconia nanoparticles, titania nanoparticles, carbon black, and/or combinations thereof. In aspects, the composition can comprise silica nanoparticles and/or alumina nanoparticles, which can be present in an amount within one or more of the ranges discussed above for the wt % of the silica nanoparticles and/or alumina nanoparticles. In further aspects, the silica nanoparticles and/or alumina nanoparticles can comprise a mean effective diameter within or more of the ranges discussed above for the mean effective diameter of the silica nanoparticles and/or the alumina nanoparticles. In further aspects, the silica nanoparticles and/or the alumina nanoparticles may not be bonded to a functionalized oligomeric silsesquioxane of the plurality of functionalized oligomeric silsesquioxane in the composition. In aspects, an effective diameter of a functionalized oligomeric silsesquioxane of the plurality of functionalized oligomeric silsesquioxanes, a mean effective diameter of the plurality of functionalized oligomeric silsesquioxanes, and/or substantially all and/or all of the functionalized oligomeric silsesquioxanes can be within one or more of the ranges for the effective diameter of a functionalized oligomeric silsesquioxane discussed above. In aspects, a functionalized oligomeric silsesquioxane of the plurality of functionalized oligomeric silsesquioxanes can be directly bonded to only the linker (e.g., polymer) or only the linker (e.g., polymer) and the silane coupling agent. In aspects, all the functionalized oligomeric silsesquioxanes of the plurality of functionalized oligomeric silsesquioxanes can be directly bonded to only the linker (e.g., polymer) or only the linker (e.g., polymer) and the silane coupling agent.

In aspects, the coating 113 can comprise a pencil hardness. In aspects, the pencil hardness can be about 5H or more, 6H or more, 7H or more, 8H or more, 9H or more, or 9H or less. In aspects, the coating 113 can comprise a pencil hardness in a range from about 5H to about 9H, from about 6H to about 9H, from about 7H to about 9H, from about 8H to about 9H, or any range or subrange therebetween. In aspects, the pencil hardness measured after the coating 113 has been stored at about 25° C. for 72 hours can be within one or more of the ranges discussed above for the pencil hardness (e.g., from about 5H to about 9H, from about 7H to about 9H).

Throughout the disclosure, a tensile strength, ultimate elongation (e.g., strain at failure), and yield point of the coating 113 is determined using ASTM D412A using a tensile testing machine, for example, an Instron 3400 or Instron 6800, at 23° C. and 50% relative humidity with a type I dogbone shaped sample. In aspects, a tensile strength of the coating 113 can be about 2 MegaPascals (MPa) or more, 10 MPa or more, about 20 MPa, about 25 MPa or more, about 30 MPa or more, about 50 MPa or more, about 45 MPa or less, about 40 MPa or less, or about 35 MPa or less. In aspects, a tensile strength of the coating 113 can be in a range from about 2 MPa to about 50 MPa, from about 10 MPa to about 50 MPa, from about 10 MPa to about 45 MPa, from about 20 MPa to about 45 MPa, from about 20 MPa to about 40 MPa, from about 25 MPa to about 40 MPa, from about 25 MPa to about 35 MPa, or any range or subrange therebetween.

In aspects, an ultimate elongation of the coating 113 can be about 3% or more, about 4% or more, about 5% or more, about 6% or more, about 20% or less, about 10% or less, about 8% or less, or about 7% or less. In aspects, an ultimate elongation of the coating 113 can be in a range from about 3% to about 20%, from about 4% to about 20%, from about 5% to about 10%, from about 5% to about 8%, from about 6% to about 8%, from about 7% to about 8%, or any range or subrange therebetween. In aspects, an ultimate elongation of the coating 113 can be in a range from about 3% to about 8%, from about 4% to about 8%, from about 5% to about 8%, from about 6% to about 8%, or any range or subrange therebetween.

Throughout the disclosure, an elastic modulus (e.g., Young's modulus) of the coating is measured using ISO 527-1:2019. In aspects, an elastic modulus of the coating 113 can be about 200 MPa or more, about 500 MPa or more, about 700 MPa or more, about 800 MPa or more, about 900 MPa or more, about 1,200 MPa or more, about 2,500 MPa or less, about 2,000 MPa or less, about 1,500 MPa or less, about 1,400 MPa or less, or about 1,300 MPa or less. In aspects, an elastic modulus of the coating 113 can be in a range from about 200 MPa to about 2,500 MPa, from about 200 MPa to about 2,000 MPa, from about 500 MPa to about 2,000 MPa, from about 500 MPa to about 1,500 MPa, from about 700 MPa to about 1,500 MPa, from about 800 MPa to about 1,500 MPa, from about 900 MPa to about 1,500 MPa, from about 1,200 MPa to about 1,500 MPa, from about 1,300 MPa to about 1,500 MPa, from about 1,300 MPa to about 1,400 MPa, or any range or subrange therebetween. In aspects, an elastic modulus of the coating 113 can be about 800 MPa or more, for example, in a range from about 800 MPa to about 2,500 MPa, from about 800 MPa to about 2,000 MPa, from about 800 MPa to about 1,500 MPa, from about 800 MPa to about 1,400 MPa, from about 900 MPa to about 1,400 MPa, from about 900 MPa to about 1,300 MPa, or any range or subrange therebetween.

In aspects, the coating 113, the substrate 103 or 203, the first portion 321, the second portion 331, and/or the coated article 101, 201, 301, 401, 601, or 701 can be optically transparent. In aspects, the coating 113 and/or the coated article 101, 201, 301, 401, 601, or 701 can comprise an average transmittance measured over optical wavelengths in a range from 400 nm to 700 nm of about 90% or more, about 91% or more, about 92% or more, about 93% or more, 100% or less, about 96% or less, about 95% or less, or about 94% or less. In further aspects, the coating 113 and/or the coated article 101, 201, 301, 401, 601, or 701 can comprise an average transmittance measured over optical wavelengths in a range from 400 nm to 700 nm in a range from about 90% to 100%, from about 90% to about 96%, from about 91% to about 96%, from about 91% to about 95%, from about 92% to about 95%, from about 92% to about 94%, from about 93% to about 94%, or any range or subrange therebetween. In aspects, the coating 113 can be substantially free from crystals and/or air bubbles that are visible under 100× magnification.

In aspects, the coating 113, the substrate 103 or 203, the first portion 321, the second portion 331, and/or the coated article 101, 201, 301, 401, 601, or 701 can comprise a haze. As used herein, haze refers to transmission haze that is measured in accordance with ASTM E430. Haze is measured using a haze meter supplied by BYK Gardner under the trademark HAZE-GUARD PLUS, using an aperture over the source port. The aperture has a diameter of 8 mm. A CIE D65 illuminant is used as the light source for illuminating the coating and/or coated article. Unless otherwise indicated, haze is measured at a direction normal to an angle of incidence of the light on a surface of the sample (e.g., third major surface 115 of the coating 113, the first major surface 105 the substrate 103, and/or the second major surface 107 of the substrate 203). Haze of a coating is measured with the coating mounted on a glass-based article comprising a thickness of 1.0 millimeters (mm). In further aspects, the haze of the coating 113 and/or the coated article 101, 201, 301, 401, 601, or 701 can be about 0.01% or more, about 0.1% or more, about 0.2% or more, about 0.5% or less, about 0.4% or less, or about 0.3% or less. In further aspects, the haze of the coating 113, the substrate 103 or 203, the first portion 321, the second portion 331, and/or the coated article 101, 201, 301, 401, 601, or 701 can be in a range from about 0.01% to about 0.5%, from about 0.01% to about 0.4%, from about 0.1% to about 0.4%, from about 0.1% to about 0.3%, from about 0.2% to about 0.3%, or any range or subrange therebetween. Providing a low haze substrate can enable good visibility through the substrate.

Throughout the disclosure, the coating 113 can comprise CIE (L*, a*, b*) color coordinates measured using a D65 illuminant at an observer angle of 10° using a colorimeter (e.g., tristimulus colorimeter) and/or spectrophotometer, for example, CR-400 Chroma Meter (Konica Minolta) or a TR 520 Spectrophotometer (Lazar Scientific). In aspects, the CIE b* value can be about 1 or less, about 0.5 or less, about 0.4 or less, about 0 or more, about 0.2 or more, or about 0.3 or more. In aspects, the CIE b* value can be in a range from about 0 to about 1, from about 0.1 to about 0.5, from about 0.2 to about 0.4, from about 0.3 to about 0.4, or any range or subrange therebetween.

Throughout the disclosure, an index of refraction may be a function of a wavelength of light passing through a material. Throughout the disclosure, for light of a first wavelength, an index of refraction of a material is defined as the ratio between the speed of light in a vacuum and the speed of light in the corresponding material. Without wishing to be bound by theory, an index of refraction of a material can be determined using a ratio of a sine of a first angle to a sine of a second angle, where light of the first wavelength is incident from air on a surface of the material at the first angle and refracts at the surface of the material to propagate light within the material at a second angle. The first angle and the second angle are both measured relative to a direction normal to a surface of the material. As used herein, the refractive index is measured in accordance with ASTM E1967-19, where the first wavelength comprises 589 nm. In aspects, an index of refraction of the coating 113 may be about 1.4 or more, about 1.45 or more, about 1.49 or more, about 1.50 or more, about 1.53 or more, about 1.6 or less, about 1.55 or less, about 1.54 or less, or about 1.52 or less. In aspects, the index of refraction of the coating 113 can be in a range from about 1.4 to about 1.6, from about 1.45 to about 1.6, from about 1.45 to about 1.55, from about 1.49 to about 1.55, from about 1.50 to about 1.55, from about 1.53 to about 1.55, from about 1.49 to about 1.54, from about 1.49 to about 1.52, or any range or subrange therebetween.

The substrate 103 or 203 can comprise a second index of refraction. In aspects, an index of refraction of the substrate 103 or 203 may be about 1.4 or more, about 1.45 or more, about 1.49 or more, about 1.50 or more, about 1.53 or more, about 1.6 or less, about 1.55 or less, about 1.54 or less, or about 1.52 or less. In aspects, the index of refraction of the substrate 103 or 203 can be in a range from about 1.4 to about 1.6, from about 1.45 to about 1.6, from about 1.45 to about 1.55, from about 1.49 to about 1.55, from about 1.50 to about 1.55, from about 1.53 to about 1.55, from about 1.49 to about 1.54, from about 1.49 to about 1.52, or any range or subrange therebetween. Throughout the disclosure, a magnitude of a difference between two values or an absolute difference between two values is the absolute value of the difference between the two values. In aspects, an absolute difference between the first refractive index of the coating 113 and the second refractive index of the substrate 103 or 203 can be about 0.01 or less, about 0.008 about 0.005 or less, about 0.004 or less, about 0.001 or more, about 0.002 or more, or about 0.003. In aspects, an absolute difference between the first refractive index of the coating 113 and the second refractive index of the substrate 103 or 203 can be in a range from about 0.001 to about 0.01, from about 0.001 to about 0.008, from about 0.002 to about 0.008, from about 0.002 to about 0.005, from about 0.003 to about 0.005, from about 0.003 to about 0.004, or any range or subrange therebetween. In aspects, the first index of refraction can be greater than the second index of refraction.

In aspects, the first portion 321 can comprise a third index of refraction, which can be within one or more of the ranges discussed above for the second index of refraction. In further aspects, the first portion 321 and/or the second portion 231 can comprise substantially the same refractive index. In further aspects, the third index of refraction of the first portion can be substantially equal to the second index of refraction of the substrate 203. In further aspects, an absolute difference between the first refractive index of the coating 113 and the third refractive index of the first portion 321 can be about 0.01 or less, about 0.008 about 0.005 or less, about 0.004 or less, about 0.001 or more, about 0.002 or more, or about 0.003. In aspects, an absolute difference between the first refractive index of the coating 113 and the third refractive index of the first portion 321 can be in a range from about 0.001 to about 0.01, from about 0.001 to about 0.008, from about 0.002 to about 0.008, from about 0.002 to about 0.005, from about 0.003 to about 0.005, from about 0.003 to about 0.004, or any range or subrange therebetween. In aspects, the first index of refraction can be greater than the third index of refraction.

In aspects, the coating 113 can comprise an adhesion to the substrate 103. Throughout the disclosure, adhesion of the coating to the substrate can be measured using a cross-hatch adhesion test in accordance with ASTM D3359-09 Method B using the Crosshatch Paint Adhesion Test kit available from Gardco. In aspects, the coating 113 (e.g., of the coated article 101, 201, 301, 401, 601, and/or 701) can comprise an adhesion of 1B or more, 2B or more, 3B or more, 4B or more, 5B or more, 6B or more, from 1B to 6B, from 1B to 5B, from 1B to 4B, from 1B to 3B, from 1B to 2B, from 3B to 6B, from 3B to 5B, or from 3B to 4B. In aspects, the coating 113 can comprise an adhesion to the substrate of any of the values and/or ranges disclosed when tested as-formed. In aspects, the coating 113 can comprise an adhesion to the substrate of any of the values and/or ranges disclosed above after 10 days in a 50% relative humidity, 25° C. environment. In aspects, the coating 113 can comprise an adhesion to the substrate of any of the values and/or ranges disclosed above after 10 days in a 95% relative humidity, 25° C. environment. In aspects, the coating 113 can comprise an adhesion to the substrate of any of the values and/or ranges disclosed above after 10 days in a 95% relative humidity, 65° C. environment.

In aspects, the coated article 101, 201, 301, 401, 601, and/or 701 can withstand 10 days in a 50% relative humidity at 25° C. environment without visible delamination or visible cracking. As used herein, “visible delamination” refers to a separation (e.g., bubbling, lifting, curling) of the coating from the substrate that is visible with the naked eye. As used herein, “visible cracking” refers to a crack (e.g., breakage, crazing, separation into multiple pieces) of the coating that is visible with the naked eye. In aspects, the coated article 101, 201, 301, 401, 601, and/or 701 can withstand 10 days in a 95% relative humidity at 25° C. environment without visible delamination or visible cracking. the coated article 101, 201, 301, 401, 601, and/or 701 can withstand 10 days in a 95% relative humidity at 65° C. environment without visible delamination or visible cracking. the coated article 101, 201, 301, 401, 601, and/or 701 can withstand 10 days in a 50% relative humidity at 65° C. environment without visible delamination or visible cracking.

In aspects, the coating 113 and/or the coated article 101, 201, 301, 401, 601, and/or 701 can comprise a color shift, for example, as measured by a yellowing index. As used herein, the yellowing index is measured in accordance with ASTM D1925 using a D65 illuminant with an observer angle of 10°. In further aspects, the yellowing index of the coating 113 and/or the coated article 101, 201, 301, 401, 601, and/or 701 can be about 0.2 or more, about 0.3 or more, about 0.4 or more, about 0.45 or more, about 0.48 or more, about 0.8 or less, about 0.6 or less, about 0.55 or less, or about 0.5 or less. In further aspects, the yellowing index of the coating 113 and/or the coated article 101, 201, 301, 401, 601, and/or 701 can be in a range from about 0.2 to about 0.8, from about 0.2 to about 0.6, from about 0.3 to about 0.6, from about 0.4 to about 0.6, from about 0.4 to about 0.55, from about 0.45 to about 0.55, from about 0.48 to about 0.55, from about 0.48 to about 0.5, from about 0.45 to about 0.5, or any range or subrange therebetween. In further aspects, the coating 113 and/or the coated article 101, 201, 301, 401, 601, and/or 701 can comprise a yellowing index within one or more of the ranges for the yellowing index after being held for 10 days in a 50% relative humidity at 25° C. environment. In further aspects, the coating 113 and/or the coated article 101, 201, 301, 401, 601, and/or 701 can comprise a yellowing index within one or more of the ranges for the yellowing index after being held for 10 days in a 95% relative humidity at 25° C. environment. In further aspects, the coating 113 and/or the coated article 101, 201, 301, 401, 601, and/or 701 can comprise a yellowing index within one or more of the ranges for the yellowing index after being held for 10 days in a 95% relative humidity at 65° C. environment.

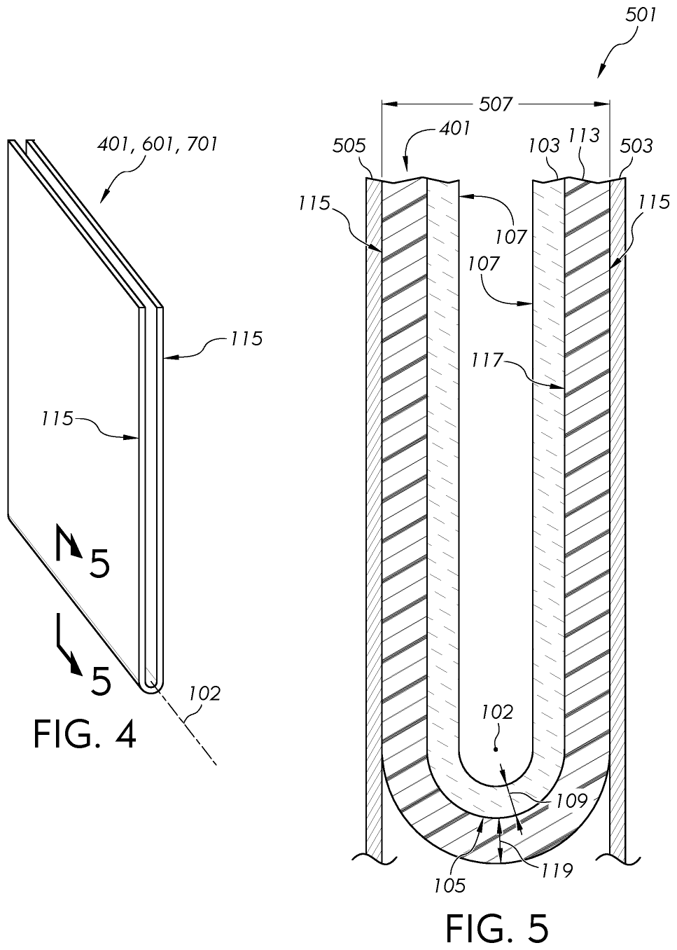

In aspects, the coated article 101 can be folded in a direction 108 (e.g., see FIG. 1) about the fold axis 102 to form the coated article 201 in a folded configuration (e.g., see FIGS. 4-5). As shown, the coated article may include a single fold axis to allow the coated article to comprise a bifold wherein, for example, the coated article may be folded in half. In further aspects, the coated article may include two or more fold axes that can allow the coated article to comprise a trifold or other multi-fold structure.

FIGS. 4-7 schematically illustrate example aspects of the coated article 401, 601, or 701 in accordance with aspects of the disclosure in the folded configuration. Although not shown, the coated article can be folded such that the coating 113 is on the inside of the folded coated article while the second major surface 107 or 207 of the substrate 103 or 203 is on the outside of the folded coated article. If a display device were mounted on the second major surface 107 or 207 of the substrate 103, a user would view a device containing the coated article through the coating 113 and the substrate 103 and, thus, would be viewing from the side of the first major surface 105 of the substrate 103 (e.g., from the side of the third major surface 115 of the coating 113). Alternatively, as shown in FIGS. 5 and 7, the coated article can be folded such that the coating 113 is on the outside of the folded coated article while the second major surface 107 of the substrate 103 is on the inside of the folded coated article. If a display device were mounted on the second major surface 107 of the substrate, a user would view a device containing the coated article through the coating 113 and the substrate 103 and, thus, would be viewing from the side of the first major surface 105 of the substrate 103 (e.g., from the side of the third major surface 115 of the coating 113). In this alternative configuration, the coated article could be bent in a direction so that either the second major surface 107 faces itself (similar to the configuration in FIG. 5 or 7) or in a direction so that the first major surface 105 faces itself (not shown). If a display device were mounted on the test adhesive layer 609 in the location of the PET sheet 607 shown in FIG. 7 or on the eighth major surface 265 of the adhesive layer in the location of the release liner 271, a user would view a device containing the coated article through the coating 113 and the substrate 103 and, thus, would be viewing from the side of the first major surface 205 of the substrate 203.

As used herein, “foldable” includes complete folding, partial folding, bending, flexing, or multiple capabilities. As used herein, the terms “fail,” “failure” and the like refer to breakage, destruction, delamination, or crack propagation. A foldable substrate (e.g., substrate, coating, coated article) achieves a parallel plate distance of “X” or has a parallel plate distance of “X” if it resists failure when the substrate is held at a parallel plate distance of “X” for 24 hours at about 60° C. and about 90% relative humidity.

As used herein, the “parallel plate distance” of a foldable substrate (e.g., substrate 103 or 203, coating 113, coated article 101, 201, 301, 401, 601, and/or 701) is measured with the following test configuration and process using a parallel plate apparatus 501 (see FIGS. 5-7) that comprises a pair of parallel rigid stainless-steel plates 503 and 505 comprising a first rigid stainless-steel plate 503 and a second rigid stainless-steel plate 505. When measuring the “parallel plate distance” for the coated article 401, as shown in FIG. 5, the coated article 401 is placed between the pair of parallel rigid stainless-steel plate 503 and 505 such that the coating 113 (e.g., third major surface 115) is on the outside of the bend (e.g., facing and/or contacting the stainless-steel plates 503 and 505) while the substrate 103 (e.g., second major surface 107) is on the inside of the bend (e.g., facing itself). When measuring the “parallel plate distance” for a coated article (e.g., coated article 201) comprising an adhesive layer 261, the adhesive layer 261 and anything disposed on the adhesive layer (e.g., release liner) is removed and replaced with a test adhesive layer 609 comprising a thickness of 50 μm and an elastic modulus of 0.1 MPa in place of the adhesive layer such that a first major surface 611 of the test adhesive layer 609 contacts the surfaces contacted by the adhesive layer (e.g., second major surface 207 in FIGS. 2 and 6, second surface area 325 and fourth surface area 335 in FIGS. 3 and 7) and a second major surface 613 of the test adhesive layer 609 contacts a 100 μm thick sheet 607 of poly(ethylene terephthalate). When measuring the “parallel plate distance” for the coating 113 independent of a particular substrate, the fourth major surface 117 of the coating 113 is attached to a test adhesive layer comprising a thickness of 50 μm and an elastic modulus of 0.1 MPa, the test adhesive layer is attached to a 100 μm thick sheet of poly(ethylene terephthalate), and the assembled laminate is placed between the pair of parallel rigid stainless-steel plate 503 and 505 such that the coating 113 (e.g., third major surface 115) is on the outside of the bend (e.g., facing and/or contacting the stainless-steel plates 503 and 505). The distance between the parallel plates is reduced at a rate of 50 μm/second until the parallel plate distance 507 is equal to the “parallel plate distance” to be tested. Then, the parallel plates are held at the parallel plate distance to be tested for 24 hours at about 60° C. and about 90% relative humidity. As used herein, the “minimum parallel plate distance” is the smallest parallel plate distance that the foldable substrate (e.g., substrate 103 or 203, coating 113, coated article 101, 201, 301, 401, 601, and/or 701) can withstand without failure under the conditions and configuration described above.

In aspects, the coated article 101, 201, 301, 401, 601, and/or 701 and/or the coating 113 can achieve a parallel plate distance of 100 mm or less, 50 mm or less, 20 mm or less, or 10 mm or less. In further aspects, the coated article 101, 201, 301, 401, 601, and/or 701 and/or the coating 113 can achieve a parallel plate distance of 10 millimeters (mm), or 7 mm, or 5 mm, 4 mm, 3 mm, 2 mm, or of 1 mm. In aspects, the coated article 101, 201, 301, 401, 601, and/or 701 and/or the coating 113 can comprise a parallel plate distance of about 10 mm or less, about 7 mm or less, about 5 mm or less, about 4 mm or less, about 1 mm or more, about 2 mm or more, or about 3 mm or more. In aspects, the coated article 101, 201, 301, 401, 601, and/or 701 and/or the coating 113 can comprise a parallel plate distance in a range from about 1 mm to about 10 mm, from about 2 mm to about 10 mm, from about 3 mm to about 10 mm, from about 3 mm to about 7 mm, from about 3 mm to about 5 mm, from about 3 mm to about 4 mm, or any range or subrange therebetween.

In aspects, the coating 113 can withstand a cyclic bending test. As used herein, the cyclic bending test comprises placing a testing apparatus comprising the material to be tested in the parallel plate apparatus 501 (see FIG. 5) and bending the laminate comprising the coating 113, as described above for the parallel plate test of the coating 113, to achieve a predetermined parallel plate distance, between plates 503, 505, a predetermined number of times at 23° C. with a relative humidity of 50%. The testing apparatus comprises attaching a 100 μm thick portion of the material of the coating 113 to be tested to a 100 μm thick PET sheet with the 50 μm thick adhesive comprising an elastic modulus of 0.1 MPa, where the coating faces the pair of rigid stainless-steel plates 503, 505. In aspects, the coating 113 can withstand 2,000 bending cycles at a parallel plate distance of 3 millimeters. In further aspects, the coating 113 can withstand 20,000 bending cycles at a parallel plate distance of 3 millimeters. In even further aspects, the coating 113 withstands 200,000 bending cycles at a parallel plate distance of 3 millimeters. In aspects, the coating 113 can withstand 2,000 bending cycles at a parallel plate distance of 4 millimeters. In further aspects, the coating 113 can withstand 20,000 bending cycles at a parallel plate distance of 4 millimeters. In even further aspects, the coating 113 withstands 200,000 bending cycles at a parallel plate distance of 4 millimeters.

The coated article may have an impact resistance defined by the capability of coating 113 and/or the coated article 101, 201, 301, 401, 601, and/or 701 to avoid failure at a pen drop height (e.g., 5 centimeters (cm) or more, 8 cm or more, 10 cm or more, 12 cm or more, 15 cm or more), when measured according to the “Pen Drop Test.” As used herein, the “Pen Drop Test” is conducted such that samples of the coated article are tested with the load (i.e., from a pen dropped from a certain height) imparted to an outer surface (e.g., third major surface 115 of coating 113 in FIGS. 1-3, second major surface 107 of the substrate 103 in FIGS. 1 and 3) of the coating and/or coated article configured as in the parallel plate test. During testing, the laminate comprising the coating 113 and/or the coated article 101, 201, 301, 401, 601, and/or 701 is placed on an aluminum plate (6063 aluminum alloy, as polished to a surface roughness with 400 grit paper). No tape is used on the side of the sample resting on the aluminum plate.

In the Pen Drop test, the pen employed is a BIC Easy Glide Pen, Fine comprising a tungsten carbide ballpoint tip of 0.7 mm (0.68 mm) diameter, and a weight of 5.73 grams (g) including the cap (4.68 g without the cap). The ballpoint pen is held a predetermined height from an outer surface (e.g., third major surface 115 of coating 113 in FIGS. 1-3, second major surface 107 of the substrate 103 in FIGS. 1 and 3) of the laminate comprising the coating and/or the coated. A tube is used for the Pen Drop Test to guide the ballpoint pen to the outer surface of the coated article, and the tube is placed in contact with the outer surface of the coated article so that the longitudinal axis of the tube is substantially perpendicular to the outer surface of the coated article. The tube has an outside diameter of 1 inch (2.54 cm), an inside diameter of nine-sixteenths of an inch (1.4 cm), and a length of 90 cm. An acrylonitrile butadiene (“ABS”) shim is employed to hold the ballpoint pen at a predetermined height for each test. After each drop, the tube is relocated relative to the outer surface of the sample to be tested to guide the ballpoint pen to a different impact location on the outer surface of the sample to be tested. It is to be understood that the Pen Drop Test can be used for any of the coatings and/or coated articles of aspects of the disclosure.

For the Pen Drop Test, the ballpoint pen is dropped with the cap attached to the top end (i.e., the end opposite the tip) so that the ballpoint tip can interact with the outer surface (e.g., third major surface 115 of coating 113 in FIGS. 1-3, second major surface 107 of the substrate 103 in FIGS. 1 and 3) of the coating. In a drop sequence according to the Pen Drop Test, one pen drop is conducted at an initial height of 1 cm, followed by successive drops in 0.5 cm increments up to 20 cm, and then after 20 cm, 2 cm increments until failure of the sample to be tested. After each drop is conducted, the presence of any observable fracture, failure, or other evidence of damage to the coated article is recorded along with the particular predetermined height for the pen drop. Using the Pen Drop Test, multiple samples can be tested according to the same drop sequence to generate a population with improved statistical accuracy. For the Pen Drop Test, the ballpoint pen is to be changed to a new pen after every 5 drops, and for each new coated article tested. In addition, all pen drops are conducted at random locations on the coated article at or near the center of the coated article unless indicated otherwise, with no pen drops near or on the edge of the coated article.

For purposes of the Pen Drop Test, “failure” means the formation of a visible mechanical defect in a sample. The mechanical defect may be a crack or plastic deformation (e.g., surface indentation). The crack may be a surface crack or a through crack. The crack may be formed on an interior or exterior surface of a sample. The crack may extend through all or a portion of the coating 113 and/or the coated article 101, 201, 301, 401, 601, and/or 701. A visible mechanical defect has a minimum dimension of 0.2 millimeters or more. In aspects, the coating 113 and/or the coated article 101, 201, 301, 401, 601, and/or 701 can withstand a pen drop height of 1 cm or more, 3 cm or more, 5 cm or more, 7 cm or more, 8 cm or more, 9 cm or more, 10 cm or more, 11 cm or more, 12 cm or more, 13 cm or more, 14 cm or more, 15 cm or more, 16 cm or more, 17 cm or more, 18 cm or more, 19 cm or more, and/or 20 cm or more over the third major surface 115 of the coating 113.

For coated articles comprising one or more recesses (e.g., first recess 234, second recess 241) and/or a minimum distance 343 between distinct portions (e.g., first portion 321 and second portion 331), for example resembling FIGS. 2-3, the coated article can withstand a pen drop height over a portion of the third major surface 115 corresponding to a recess and/or the minimum distance between distinct portions of 5 cm or more, 8 cm or more, 10 cm or more, 12 cm or more, 13 cm or more, 14 cm or more, or 15 cm or more for coated articles comprising a substrate thickness of 30 μm or more. For coated articles comprising one or more recesses, for example resembling FIG. 2, the coated article can withstand a pen drop height over a portion of the third major surface 115 or second major surface 107 not comprising the recess (e.g., first portion 221, second portion 231) of about 10 cm or more, 15 cm or more, 17 cm or more, 18 cm or more, 19 cm or more, or about 20 cm or more for a substrate thickness of 30 μm or more. For coated articles comprising a minimum distance between distinct portions, for example resembling FIG. 3, the coated article can withstand a pen drop height over a portion of the second major surface 107, the second surface area 325, the fourth surface area 335 corresponding to the first portion 321 or the second portion 331, or the third major surface 115 of the coating extending along the fourth plane 306 of about 10 cm or more, 15 cm or more, 17 cm or more, 18 cm or more, 19 cm or more, or about 20 cm or more for a substrate thickness of 30 μm or more and a portion thickness of about 30 μm or more.

In aspects, the coating 113 and/or the coated article 101, 201, 301, 401, 601, and/or 701 can comprise a contact angle of deionized water on the third major surface 115 of the coating 113. Throughout the disclosure, the contact angle is measured in accordance with ASTM D7334-08(2013) at 25° C. In further aspects, the contact angle can be about 100 or more, about 400 or more, about 600 or more, 650 or more, about 700 or more, about, about 1400 or less, about 1100 or less, about 1000 or less, about 950 or less, or about 900 or less. In further aspects, the contact angle can be in a range from about 100 to about 140°, from about 100 to about 110°, from about 400 to about 110°, from about 600 to about 110°, from about 600 to about 100°, from about 650 to about 100°, from about 650 to about 95°, from about 700 to about 95°, from about 700 to about 90°, or any range or subrange therebetween. In further aspects, the coating can be hydrophilic, for example, comprising a contact angle in a range from about 900 to about 140°, from about 900 to about 110° C., from about 900 to about 105°, from about 950 to about 105°, from about 950 to about 100°, or any range or subrange therebetween. In further aspects, the coating can be hydrophobic.

In aspects, the coated article can further comprise an additional coating comprising one or more of an easy-to-clean coating, a low-friction coating, an oleophobic coating, a diamond-like coating, a scratch-resistant coating, or an abrasion-resistant coating. In further aspects, the additional coating can be disposed over the third major surface of the coating. A scratch-resistant coating may comprise an oxynitride, for example, aluminum oxynitride or silicon oxynitride with a thickness of about 500 micrometers or more. In such aspects, the abrasion-resistant layer may comprise the same material as the scratch resistant layer. In aspects, a low friction coating may comprise a highly fluorinated silane coupling agent, for example, an alkyl fluorosilane with oxymethyl groups pendant on the silicon atom. In such aspects, an easy-to-clean coating may comprise the same material as the low friction coating. In other aspects, the easy-to-clean coating may comprise a protonatable group, for example, an amine, for example, an alkyl aminosilane with oxymethyl groups pendant on the silicon atom. In such aspects, the oleophobic coating may comprise the same material as the easy-to-clean coating. In aspects, a diamond-like coating comprises carbon and may be created by applying a high voltage potential in the presence of a hydrocarbon plasma.

Throughout the disclosure, the dynamic coefficient of friction is measured in accordance with ASTM D1894-14. In aspects, the third major surface 115 of the coating 113 can comprise a dynamic coefficient of friction of about 0.1 or more, about 0.3 or more, about 0.4 or more, about 0.8 or less, about 0.6 or less, or about 0.5 or less. In aspects, the third major surface 115 of the coating 113 can comprise a dynamic coefficient of friction in a range from about 0.1 to about 0.8, from about 0.3 to about 0.8, from about 0.3 to about 0.6, from about 0.3 to about 0.5, from about 0.4 to about 0.5, or any range or subrange therebetween.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent the front surface of the housing. The consumer electronic product can comprise a cover substrate disposed over the display. In aspects, at least one of a portion of the housing or the cover substrate comprises the coating and/or coated article discussed throughout the disclosure. The display can comprise a liquid crystal display (LCD), an electrophoretic displays (EPD), an organic light-emitting diode (OLED) display, or a plasma display panel (PDP). In aspects, the consumer electronic product can be a portable electronic device, for example, a smartphone, a tablet, a wearable device, or a laptop.

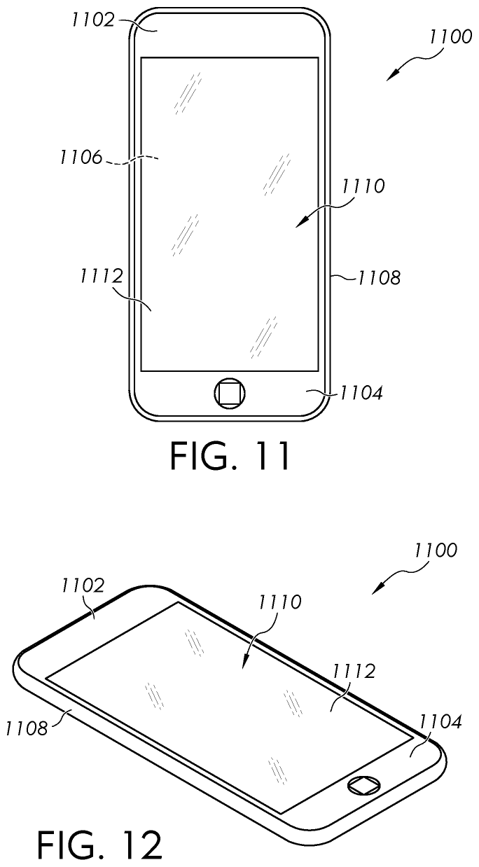

The coated article and/or coating disclosed herein may be incorporated into another article, for example, an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion-resistance or a combination thereof. An exemplary article incorporating any of the coated articles disclosed herein is shown in FIGS. 11 and 12. Specifically, FIGS. 11 and 12 show a consumer electronic device 1100 including a housing 1102 having a front surface 1104, a back surface 1106, and side surfaces 1108. The consumer electronic device 1100 can comprise electrical components (not shown) that are at least partially inside or entirely within the housing and including at least a controller, a memory, and a display 1110 at or adjacent to the front surface of the housing. The consumer electronic device 1100 can comprise a cover substrate 1112 at or over the front surface of the housing such that it is over the display. In aspects, at least one of the cover substrate 1112 or a portion of housing 1102 may include any of the coated article disclosed herein.

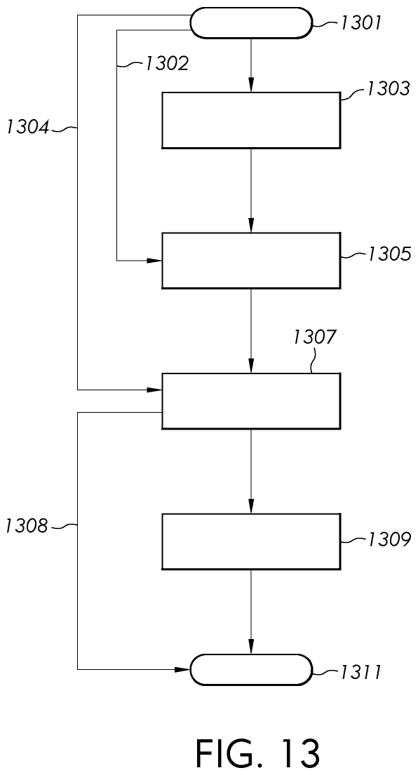

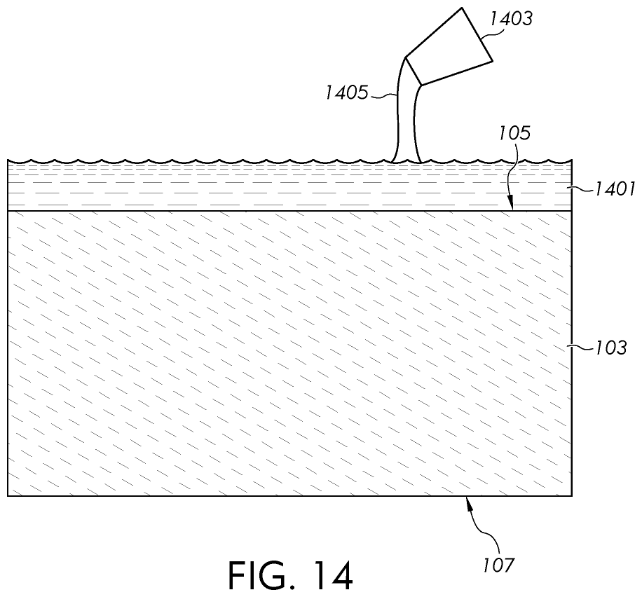

Aspects of methods of making the coated article 101, 201, 301, 401, 601, and/or 701 in accordance with aspects of the disclosure will be discussed with reference to the flow chart in FIG. 13 and example method steps illustrated in FIGS. 14-19. With reference to the flow chart of FIG. 13, methods can start at step 1301. In aspects, step 1301 can comprise providing a substrate. In further aspects, the substrate can resemble the substrate 103 of FIG. 1 or 3 comprising the substrate thickness 109 or the substrate 203 of FIG. 2 comprising the substrate thickness 209. In further aspects, the substrate 103 or 203 can be provided by purchase or otherwise obtaining a substrate or by forming the substrate. In further aspects, the substrate can comprise a glass-based substrate and/or a ceramic-based substrate. In further aspects, glass-based substrates can be provided by forming them with a variety of ribbon forming processes, for example, slot draw, down-draw, fusion down-draw, up-draw, press roll, redraw, or float. In even further aspects, the substrate can be chemically strengthened and comprise a depth of compression (e.g., first depth of compression, second depth of compression), compressive stress (e.g., first maximum compressive stress, second maximum compressive stress), and/or depth of layer (e.g., first depth of layer, second depth of layer) within one or more of the corresponding ranges discussed above.

After step 1301, methods can proceed to step 1303 of preparing the substrate 103 or 203. In aspects, step 1303 can comprise treating at least the first major surface 105 or 205 of the substrate 103 or 203 with a plasma and/or ozone. In further aspects, the first central surface area 213 can be treated with a plasma and/or ozone. In aspects, step 1303 can comprise disposing a silane coupling agent over the first major surface 105 or 205 of the substrate 103 or 203. In further aspects, the silane coupling agent can be disposed over the first central surface area 213. In further aspects, as shown in FIG. 14, step 4603 can comprise disposing a silane coupling agent by depositing a solution 1405 on the first major surface 105 of the substrate 103, for example, as a layer 1401. In even further aspects, disposing the silane coupling agent can comprise dispensing the solution 1405 from a container 1403 (e.g., conduit, flexible tube, micropipette, or syringe). In further aspects, the solution 1405 can consist of the one or more silane coupling agents. In further aspects, disposing the silane coupling agent can further comprise heating the substrate 103 and the solution 1405 at a second temperature for a second period of time. In even further aspects, the second temperature can be about 80° C. or more, about 100° C. or more, about 110° C. or more, about 120° C. or more, about 160° C. or less, about 140° C. or less, or about 130° C. In even further aspects, the second temperature can be in a range from about 80° C. to about 160° C., from about 80° C. to about 140° C., from about 100° C. to about 140° C., from about 100° C. to about 130° C., from about 110° C. to about 130° C., from about 120° C. to about 130° C., or any range or subrange therebetween. In even further aspects, the second period of time can be about 15 minutes or more, about 30 minutes or more, about 45 minutes or more, about 6 hours or less, about 2 hours or less, about 90 minutes or less, about 75 minutes or less, or about 60 minutes or less. In even further aspects, the second period of time can be in a range from about 15 minutes to about 6 minutes, from about 30 minutes to about 6 hours, from about 30 minutes 2 hours, from about 45 minutes to about 2 hours, from about 45 minutes to about 75 minutes, from about 45 minutes to about 60 minutes. In further aspects, the first major surface 105 or 205 of the substrate 103 or 203 can be treated with plasma and/or ozone before disposing the silane coupling agent on the first major surface 105 or 205 of the substrate 103 or 203. In further aspects, the silane coupling agent can comprise any one or more of the silane coupling agents discussed above with reference to the composition. In even further aspects, the silane coupling agent can comprise a thiol-functionalized silane coupling agent. In still further aspects, the silane coupling agent can comprise one or more of (3-triethoxysilyl)propylsuccinic anhydride, (3-mercaptopropyl)trimethoxysilane, and/or 2-(3,4-epoxycyclohexyl)ethyltrimethoxysilane. In even further aspects, the silane coupling agent can comprise an epoxy-functionalized silane coupling agent. In even further aspects, the silane coupling agent can comprise an amine-functionalized silane coupling agent.

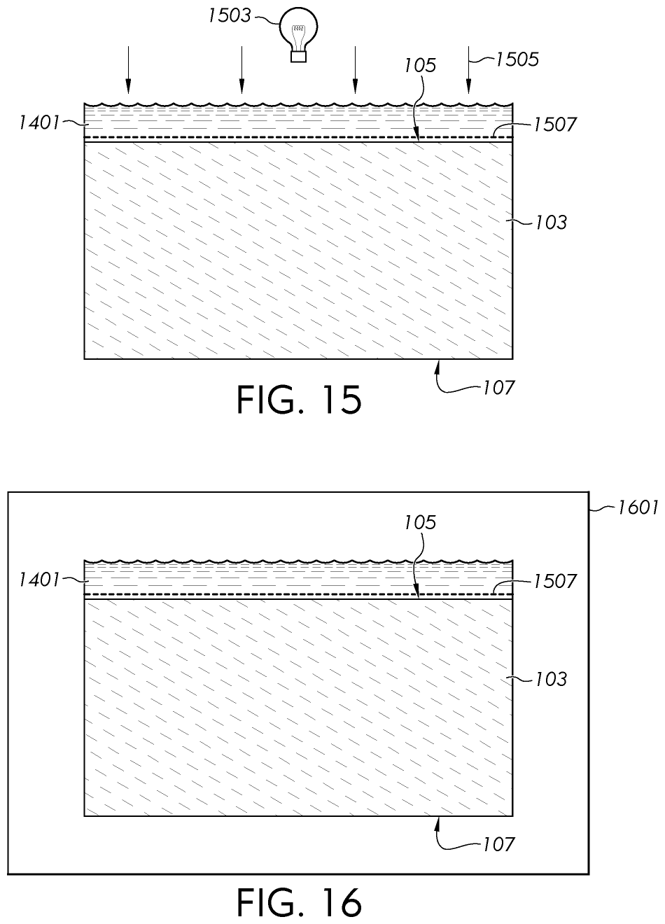

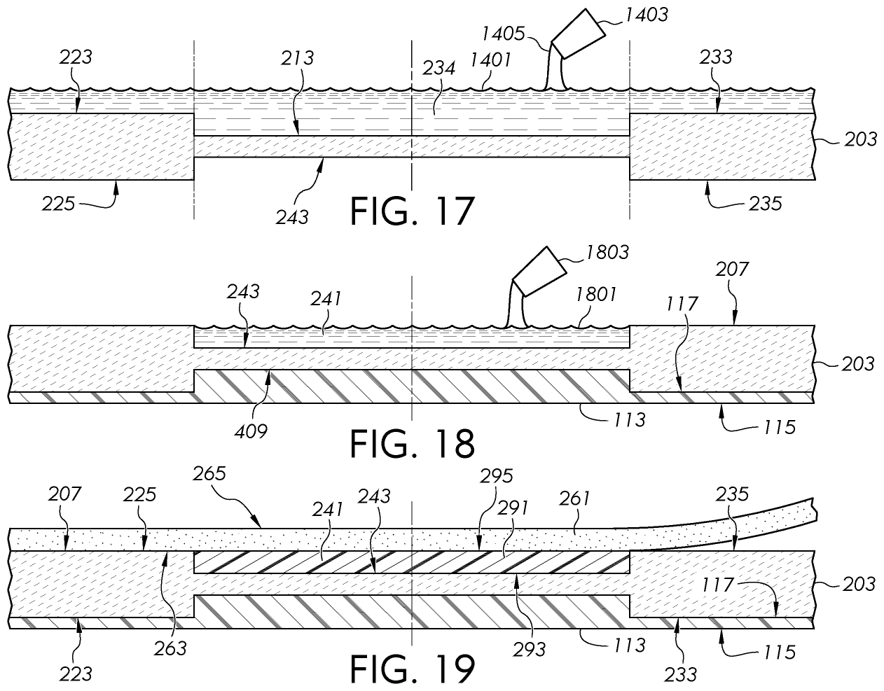

In aspects, after step 1301 or 1303, as shown in FIGS. 15-17, methods can proceed to step 1305 comprising depositing a layer 1401 comprising the composition over the first major surface 105 of the substrate 103. In further aspects, as shown, the layer 1401 comprising the composition can be deposited over the first major surface 105 of the substrate 103 by being disposed on a layer 1507 of the silane coupling agent, shown by the dotted line, which is in turn disposed on the first major surface 105 of the substrate 103. In further aspects, as shown, the layer 1401 comprising the composition can be deposited over the first major surface by being deposited on the first major surface 105 of the substrate 103 without an existing layer 1507, for example, if a silane coupling agent is not to be used or if a silane coupling agent is included in the layer 1401 comprising the composition. In further aspects, as shown in FIG. 17, the composition can be dispensed from a container 1403 (e.g., conduit, flexible tube, micropipette, or syringe) similar to how the silane coupling agent can be dispensed, as described above with reference to FIG. 14. In further aspects, as shown in FIG. 17, the layer 1401 can occupy the first recess 234 and/or contact the first central surface area 213. In further aspects, as discussed above, the composition can comprise the linker comprising a reactive diluent. In further aspects, as discussed above with reference to the composition, the composition can be solvent-free. In even further aspects, the composition can comprise particles that can be disposed over the first major surface 105 or 205 to form a particulate layer over the first major surface 105 or 205. In even further aspects, the composition can comprise a liquid that can spread over the first major surface 105 or 205. In still further aspects, depositing the composition can further comprise drawing an applicator bar across the first major surface 105 or 205 to achieve a layer of a predetermined thickness, for example, by controlling an amount of solvent in the composition and/or by controlling a height of the applicator bar. In still further aspects, depositing the composition can further comprise spin coating the first major surface 105 or 205 to achieve a layer of a predetermined thickness based on the viscosity of the composition. In further aspects, as discussed above with reference to the composition, the composition can comprise a solvent. In even further aspects, the composition can comprise a liquid that can spread over the first major surface 105 or 205. In still further aspects, depositing the composition can further comprise drawing an applicator bar across the first major surface 105 or 205 to achieve a layer of a predetermined thickness. In still further aspects, depositing the composition can further comprise spin coating the first major surface 105 or 205 to achieve a layer of a predetermined thickness based on the viscosity of the composition. In further aspects, a predetermined thickness of the layer can be within one or more of the ranges discussed above with reference to the coating thickness 119. In further aspects, although not shown, depositing the composition can comprise using a knife (e.g., doctor blade or knife over roll coating) to achieve a predetermined thickness. In further aspects, although not shown, depositing the composition can comprise using a roller (e.g., gravure or knife over roll coating). In further aspects, as described above, the composition can comprise a plurality of functionalized oligomeric silsesquioxanes and a linker, where a first functionalized oligomeric silsesquioxane of the plurality of functionalized oligomeric silsesquioxanes is bonded to a second functionalized oligomeric silsesquioxane of the plurality of functionalized oligomeric silsesquioxanes by a linker terminated with a first functional group at a first end of the linker and a second functional group at a second end of the linker opposite the first end of the linker. In even further aspects, the first functionalized oligomeric silsesquioxane can be attached to the second functionalized oligomeric silsesquioxanes by the linker before the composition is deposited in step 1305 and before curing the layer to form the coating in step 1307. In even further aspects, the linker can comprise a polymer. In even further aspects, as discussed above with reference to the composition, the composition can comprise at least one functionalized oligomeric silsesquioxane that is not bonded to a polymer of the plurality of polymers, for example, if the mol ratio of polymer to functionalized oligomeric silsesquioxanes is low and/or if additional functionalized oligomeric silsesquioxanes are added after the reaction, as discussed above with reference to the composition. In even further aspects, as discussed above with reference to the composition, the composition can comprise a photoinitiator (e.g., a cationic photoinitiator, free radical photoinitiator, or both a cationic photoinitiator and a free radical photoinitiator). In even further aspects, as discussed above with reference to the composition, the composition can comprise a silane coupling agent. In still further aspects, the silane coupling agent can comprise one or more of (3-triethoxysilyl)propylsuccinic anhydride, (3-mercaptopropyl)trimethoxysilane, and/or 2-(3,4-epoxycyclohexyl)ethyltrimethoxysilane. In still further aspects, the silane coupling agent can comprise an epoxy-functionalized silane coupling agent. In still further aspects, the silane coupling agent can comprise an amine-functionalized silane coupling agent.

In aspects, after step 1301 or 1305, as shown in FIGS. 15-16, methods can proceed to step 1307 comprising curing the layer 1401 to form the coating. In further aspects, as shown in FIG. 15, curing the layer 1401 to form the coating 113 (see FIGS. 1-3) in step 1307 can comprise impinging the material with radiation 1505 from a radiation source 1503. In even further aspects, the radiation 1505 can comprise a wavelength that the photoinitiator is sensitive to. In even further aspects, the radiation can impinge substantially (e.g., the entire) layer 1401. In even further aspects, the radiation 1505 can comprise ultraviolet radiation and/or visible radiation. In even further aspects, the radiation 1505 can comprise an optical wavelength in a range from about 10 nm to about 400 nm, from about 100 nm to about 400 nm, from about 200 nm to about 400 nm, from about 10 nm to about 300 nm, from about 100 nm to about 300 nm, from about 200 nm to about 300 nm, from about 10 nm to about 200 nm, from about 100 nm to about 200 nm, or any range or subrange therebetween. In even further aspects, the radiation can comprise an optical wavelength in a range from about 315 nm to about 400 nm, from about 280 nm to about 315 nm, from about 100 nm to about 280 nm, or from 122 nm to about 200 nm. In even further aspects, the wavelength of the light beam can be in a range from about 300 nm to about 1,000 nm, from about 350 nm to about 900 nm, from about 400 to about 800 nm, from about 500 nm to about 700 nm, or any range or subrange therebetween. In still further aspects, the optical wavelength of the radiation can be about 365 nm, about 415 nm, or about 590 nm. In even further aspects, the radiation source 1503 can comprise a light-emitting diode (LED), an organic light-emitting diode (OLED), a laser, an incandescent bulb, and/or a fluorescent bulb (e.g., a cold cathode fluorescent lamp (CCFL)). In further aspects, a total energy density of the radiation (e.g., UV radiation) impinging the layer 1401 comprising the composition can be about 1 Joule per centimeter squared (J/cm²) or more, about 2 J/cm² or more, about 4 J/cm² or more, about 6 J/cm² or more, about 30 J/cm² or less, about 15 J/cm² or less, about 10 J/cm² or less, or about 8 J/cm² or less. In further aspects, a total energy density of the radiation (e.g., UV radiation) impinging the layer 1401 comprising the composition can be in a range from about 1 J/cm² to about 30 J/cm², from about 1 J/cm² to about 15 J/cm², from about 2 J/cm² to about 15 J/cm², from about 4 J/cm² to about 15 J/cm², from about 4 J/cm² to about 10 J/cm², from about 6 J/cm² to about 10 J/cm², from about 6 J/cm² to about 8 J/cm², or any range or subrange therebetween. As used herein, the total energy density means the total energy of the radiation impinging (e.g., incident on) the layer per surface area of the layer corresponding to the third major surface 115 of the coating 113 (see FIGS. 1-3) from the entire curing process. For example, the total energy density from an LED radiation source continuously emitting UV radiation at a predetermined power for a predetermined period of time of the curing is equal to the predetermined power times the predetermined time divided by the surface area of the layer. In further aspects, a period of time for the curing by irradiating the layer can be about 30 seconds or more, about 1 minute or more, about 2 minutes or more, about 4 minutes or more, about 30 minutes or less, about 20 minutes or less, about 10 minutes or less, or about 8 minutes to less. In further aspects, a period of time for the curing by irradiating the layer can be in a range from about 30 seconds to about 30 minutes, from about 30 seconds to about 20 minutes, from about 1 minute to about 20 minutes, from about 1 minute to about 10 minutes, from about 2 minutes to about 10 minutes, from about 2 minutes to about 8 minutes, from about 4 minutes to about 8 minutes, or any range or subrange therebetween. It is to be understood that step 1307 discussed herein with reference to FIGS. 15-16 can apply to aspects comprising the substrate 203 or another substrate. During the curing, a reactive diluent, if provided, can react with one or more functionalized oligomeric silsesquioxanes during the during to form a bond between the one or more functionalized oligomeric silsesquioxane and the reactive diluent. In aspects, the plurality of functionalized oligomeric silsesquioxanes may not be bonded to a linker before the curing but are bonded to a linker comprising a reactive diluent during the curing. For example, during the curing, a first functionalized oligomeric silsesquioxane can react with a third functional group of the reactive diluent and a second functionalized oligomeric silsesquioxane can react with a fourth functional group of the reactive diluent such that the first functionalized oligomeric silsesquioxane is bonded to a second functionalized oligomeric silsesquioxane via the reactive diluent. However, the plurality of functionalized oligomeric silsesquioxanes can be bonded to a linker comprising a polymer before the curing and further bonded to a linker comprising a reactive diluent after the curing. Curing the composition comprising a photoinitiator and curing the composition using irradiation can reduce processing time, processing equipment, and the overall cost of production.

In further aspects, as shown in FIG. 16, curing the layer 1401 to form the coating 113 (see FIGS. 1-3) in step 1307 can comprise heating the layer 1401. In even further aspects, as shown, the layer 1401 disposed over the first major surface 105 of the substrate 103 can be heated by placing the layer 1401 and the substrate 103 in an oven 1601 maintained a third temperature for a third period of time. In still further aspects, the third temperature can be about 60° C. or more, about 70° C. or more, about 75° C. or more, about 80° C. or more, about 100° C. or more, about 250° C. or less, about 200° C. or less, about 160° C. or less, about 150° C. or less, or about 130° C. or less. In still further aspects, the third temperature can be in a range from about 60° C. to about 250° C., from about 70° C. to about 250° C., from about 75° C. to about 250° C., from about 80° C. to about 250° C., from about 100° C. to about 250° C., from about 100° C. to about 200° C., from about 100° C. to about 160° C., from about 100° C. to about 150° C., from about 100° C. to about 130° C., or any range or subrange therebetween. In still further aspects, the third period of time can be about 15 minutes or more, about 30 minutes or more, about 45 minutes or more, about 60 minutes or more, about 90 minutes or more, about 16 hours or less, about 8 hours or less, about 6 hours or less, about 4 hours or less, or about 2 hours or less. In still further aspects, the third period of time can be in a range from about 15 minutes to about 16 hours, from about 15 minutes to about 8 hours, from about 15 minutes to about 6 hours, from about 15 minutes to about 4 hours, from about 15 minutes to about 2 hours, from about 30 minutes to about 2 hours, from about 45 minutes to about 2 hours, from about 60 minutes to about 2 hours, from about 90 minutes to about 2 hours, or any range or subrange therebetween. In further aspects, step 1307 can comprise irradiating the layer 1401 followed by heating the layer 1401.

In aspects, as shown in FIGS. 18-19, after step 1307, methods can proceed to step 1309. In further aspects, step 1309 can comprise assembling the coated article. In further aspects, step 1309 can comprise including the coated article in an electronic device, for example, the consumer electronic device shown in FIGS. 11-12. In further aspects, as shown in FIG. 18, a liquid 1801 can be disposed over the substrate 203, for example, occupying the second recess 241 and/or contacting the second central surface area 243 by being dispensed from a container 1803 (e.g., conduit, flexible tube, micropipette, or syringe). The liquid 1801 can be cured (e.g., by heating the liquid, by exposing the liquid to radiation, and/or waiting a predetermined amount of time), which can produce the polymer-based portion 291 shown in FIGS. 2 and 19; however, the liquid could be cured to produce an adhesive layer (e.g., adhesive layer 261). In aspects, although not shown, the polymer-based portion 291 can be disposed over the substrate 203 by depositing a film comprising the polymer-based portion, for example, within the second recess 241. In further aspects, as shown in FIG. 19, an adhesive layer 261 (e.g., optically clear adhesive) can be disposed over the second major surface 207 of the substrate 203. For example, as shown, a film comprising the adhesive layer 261 can be disposed over the second major surface 207 such that it contacts the second surface area 225 and the fourth surface area 235. In even further aspects, a release liner can be disposed over the adhesive layer, wherein the release liner can be removed to subsequently attach the adhesive to a display or other part of an electronic device. In even further aspects, the adhesive layer can be disposed over a display or another part of an electronic device.

After step 1307 or 1309, methods can be complete at step 1311, whereupon methods of making the coated article 101, 201, 301, 401, 601, and/or 701 can be complete. In aspects, the coated article and/or coating can comprise a pencil hardness within one or more of the ranges discussed above for the pencil hardness. In aspects, coated article can comprise an adhesion within one or more of the ranges discussed above for one or more of the conditions discussed above for the adhesion. In aspects, the coating can comprise a tensile strength, ultimate elongation, elastic modulus (e.g., Young's modulus), and/or coating thickness within one or more of the ranges discussed above for the corresponding property of the coating. In aspects, the coating and/or the coated article can comprise a refractive index, transmittance, haze, and/or yellowing index within one or more of the ranges discussed above for the corresponding property. In aspects, the coating can be substantially free of crystals visible under 100× magnification. In aspects, the coating and/or the coated article can achieve a parallel plate distance within one or more of the ranges discussed above for the parallel plate distance.

In aspects, as discussed above with reference to the flow chart in FIG. 13, methods can start at step 1301 and then proceed sequentially through steps 1303, 1305, 1307, 1309, and 1311. In aspects, arrow 1302 can be followed from step 1301 to step 1305, omitting step 1303, for example if a silane coupling agent is not used to form the coated article, only a film is being formed, other preparation of the substrate is not necessary, or if the composition comprises a silane coupling agent. In aspects, arrow 1304 can be followed from step 1301 to step 1307, omitting steps 1303 and 1305, for example, if only a film is being formed and/or the composition is already in place at the end of step 1301. In aspects, arrow 1308 can be followed from step 1307 to step 1311, omitting step 1309, for example, if the coating and/or coated article does not require further assembly after step 1307. Any of the above options may be combined to make a coated article in accordance with aspects of the disclosure.

### EXAMPLES

Various aspects will be further clarified by the following examples. Tables 2-10 present information about aspects of compositions, which may be used to form the coating 113 (e.g., of the coated article 101, 201, 301, 401, 601, and/or 701). Tables 11-20 present information about aspects of coatings. Unless otherwise specified, the substrate used in measuring the properties reported in Tables 11-20 is a glass-based substrate (having a Composition 1 of, nominally, in mol % of: 69.1 SiO₂; 10.2 Al₂O₃; 15.1 Na₂O; 0.01 K₂O; 5.5 MgO; 0.09 SnO₂) having a substrate thickness of 30 μm and resembling substrate 103 shown in FIGS. 1 and 3.

Examples A-G comprised an amount of reactants in wt % presented in Table 2 that is used to form the composition. In Tables 2-10, GPOSS refers to EP0409 available from Hybrid Plastics, PDMS 1 refers to DMS-A11 available from Gelest, PDMS 2 refers to DMS-A21 available from Gelest, PDMS 3 refers to DMS-A214 available from Gelest, and PPO refers to Jeffamine D2000 available from Huntsman. GPOSS is a functionalized oligomeric silsesquioxanes comprising a functionalized polyhedral oligomeric silsesquioxanes (POSS), where the functionalized POSS is functionalized by 3-glycidyloxypropyl and a number average molecular weight (Mn) of GPOSS is about 1,338 Daltons (e.g., grams per mol (g/mol)). PDMS 1, PDMS 2, and PDMS 3 are polydimethylsiloxanes. A number average molecular weight (Mn) of PDMS 1 is about 875 Daltons. A number average molecular weight (Mn) of PDMS 2 is about 5,000 Daltons. PDMS 1 and PDMS 2 are terminated by an aminopropyl functional group at each end of the polymer. A number average molecular weight (Mn) of PDMS 3 is about 900 Daltons. PDMS 3 is terminated by an ethylaminoisobutyl functional group at each end of the polymer. A number average molecular weight (Mn) of PPO is about 2,000 Daltons. PPO is poly(propylene oxide) with amine functional groups at each end of polymer. PDMS 4 comprises mono-(aminopropyl) terminated poly(dimethylsiloxane) available from Gelest as MCR-A11. A number average molecular weight (Mn) of PDMS 4 is about 2,000 Daltons. As used herein, A/B/C means that B links A and C by B being bonded to A and B being bonded to C. For Example, “GPOSS/PDMS 1/GPOSS” indicates that PDMS1 is the linker linking two GPOSS together since PDMS 1 is bonded to the two GPOSS.

As shown in Table 2, Examples A-E comprised a poly(dimethylsiloxane) polymer terminated by an amine functional group while Examples F-G comprised a poly(propylene oxide) polymer terminated by an amine functional group. Examples A-F comprised a solvent during the reaction while Example G was solvent-free. Examples A-G were all visually transparent after the reaction. Examples A-G were also visually transparent after any solvent was removed using a rotary evaporator at 3.8 kPa and 60° C. for 1.5 hours with solvent traps cleaned periodically. Examples A-B and D-F were reacted at 132° C. for 16 hours under reflux in a nitrogen environment. Example C was reacted at 120° C. for 12 hours under reflux and a nitrogen environment. Example G was reacted at 100° C. for 20 minutes under a nitrogen environment.

As shown in Table 2, Examples A-G comprised from 0.98 wt % to 5.59 wt % polymer of the reactants. Example A comprises less than 1 wt % polymer of the reactants. Examples B and G comprised more than 5 wt % polymer of the reactants. Examples A-G comprised from 19.13 wt % to 94.88 wt % GPOSS of the reactants. Examples A-B and F-G comprised more than 40 wt % GPOSS of the reactants. A mass ratio of the polymer (e.g., PDMS 1, PDMS 2, PDMS 3, PPO) to GPOSS is from 0.0229 to 0.1375 for Examples A-G with Example B comprising the highest ratio and Examples A and C-G comprising a mass ratio from 0.0229 to 0.0688 of the reactants. A mol ratio of the polymer (e.g., PDMS 1, PDMS 2, PDMS 3, PPO) to GPOSS is from 0.018 to 0.037 of the reactants for Examples A-G.

TABLE 2
Composition ranges (wt %) of reactants

| Example | A | B | C | D | E | F | G |
|---|---|---|---|---|---|---|---|
| GPOSS | 42.63 | 40.64 | 30.42 | 19.13 | 19.02 | 42.07 | 94.88 |
| PDMS 1 | 0.98 | 0 | 0 | 0 | 0 | 0 | 0 |
| PDMS 2 | 0 | 5.59 | 2.05 | 0 | 0 | 0 | 0 |
| PDMS 3 | 0 | 0 | 0 | 0.72 | 1.31 | 0 | 0 |
| PPO | 0 | 0 | 0 | 0 | 0 | 2.27 | 5.12 |
| Propyl | 0 | 0 | 67.53 | 0 | 0 | 0 | 0 |
| Acetate | | | | | | | |
| Butyl | 56.39 | 53.77 | 0 | 80.15 | 79.67 | 55.66 | 0 |
| Acetate | | | | | | | |

TABLE 3
Final composition ranges (wt %)

| Example | A | B | C | D | E | F | G |
|---|---|---|---|---|---|---|---|
| GPOSS | 93.30 | 86.92 | 93.11 | 93.11 | 93.85 | 84.28 | 93.41 |
| GPOSS/ | 4.17 | 0 | 0 | 0 | 0 | 0 | 0 |
| PDMS 1/ | | | | | | | |
| GPOSS | | | | | | | |
| GPOSS/ | 0 | 8.99 | 4.83 | 0 | 0 | 0 | 0 |
| PDMS 2/ | | | | | | | |
| GPOSS | | | | | | | |
| GPOSS/ | 0 | 0 | 0 | 4.93 | 4.43 | 0 | 0 |
| PDMS 3/ | | | | | | | |
| GPOSS | | | | | | | |
| GPOSS/ | 0 | 0 | 0 | 0 | 0 | 10.94 | 2.57 |
| PPO/ | | | | | | | |
| GPOSS | | | | | | | |
| GPOSS/ | 0 | 0 | 0 | 0 | 0 | 0 | 0 |
| PDMS 4 | | | | | | | |
| TPSHFA | 1.93 | 4.09 | 1.93 | 1.96 | 0.86 | 2.39 | 2.01 |
| Propylene | 0 | 0 | 1.93 | 0 | 0.86 | 2.39 | 2.01 |
| Carbonate | | | | | | | |

Table 3 presents the components in wt % of the composition for Examples A-G. TPSHFA means triphenylsulfonium hexafluoroantimonate, which is a UV-sensitive cationic photoinitiator available from Sigma Aldrich as 654027. Compositions for Examples A-E and G comprised additional GPOSS added after the reaction of the corresponding components presented in Table 2. As discussed above, the solvent during the reaction is removed for Examples A-F with the additional GPOSS added after this solvent was removed. Examples A-B and D are solvent-free with the solvent from the photoinitiator solution removed prior to depositing the composition on the substrate. Examples C and E-G comprised the solvent from the photoinitiator solution.

As used herein, polymer complex means the polymer attached to one or more GPOSS. As used herein, “free GPOSS” refers to GPOSS not attached to a polymer. As used herein, polymer complex refers to a polymer linking GPOSS molecules together. As shown in Table 3, Examples A-F comprised from 2.57 wt % to 10.76 wt % polymer complex of the composition. Examples A, C-E, and G comprised less than 5 wt % polymer of the composition. Examples B and F comprised more than 8 wt % polymer complex of the composition. Examples A-G comprised a weight ratio of the polymer complex to the free GPOSS from 0.0275 to 0.1298 polymer complex of the composition. Examples A, D-E, and G comprised a weight ratio of the polymer complex to the free GPOSS less than 0.05 polymer of the composition. Examples B and F comprised more than 0.1 polymer complex of the composition. Examples A-G comprised a weight ratio of the polymer to all GPOSS from 0.0268 to about 0.115. Examples A-G comprised a mol ratio of the polymer complex to free GPOSS from 0.009 to 0.0361 of the composition. Examples A-E and G comprised a mol ratio of the polymer complex to free GPOSS of less than 0.02. Examples A-G comprised a mol ratio of the polymer to all GPOSS from 0.0077 to 0.0169 of the composition. Examples A and C-G comprised a mol ratio of the polymer to all GPOSS less than 0.01 of the composition. Examples A-G comprised TPSHFA as a cationic photoinitiator comprising from 0.86 wt % to 4.09 wt % of the composition.

As used in Tables 4-6, CAPA 3050 is a linker comprising a polymer. CAPA 3050 refers to a polycaprolactone triol with a number average molecular weight (Mn) of 540 Daltons available from Perstorp as CAPA 3050. M142 is a polymeric, reactive diluent comprising a single acrylate functional group. M142 refers to poly(ethylene glycol) phenyl ether acrylate comprising a number average molecular weight (Mn) of 324 Daltons available from Miwon as Miramer M142. S06E and TMPO comprise a non-polymeric linker comprising reactive diluents with two functional groups. S06E refers to 3,4-epoxycyclohexylmethyl 3,4-epoxycyclohexanecarboxylate available from Synasia as S-06E. TMPO refers to 3-ethyl-3-oxetanemethanol available from Sigma Aldrich as 444197. Curalite OX and IBOA refer to reactive diluents comprising a single functional group. Curalite OX refers to 3-ethyl-3-oxetanemethanol available from Perstorp as Curalite Ox. IBOA refers to isobornyl acrylate available from Miwon and Miramer M1140. P16976 and TPO-L are photoinitiators. PI6976 refers to a mixture of triarylsulfonium hexafluoroantimonate slats available from Synasia as Syna PI 6976. TPO-L refers to diphenyl(2,4,6-trimethylbenozyl)phosphine oxide available from IGM as TPO-L. GOPTMS and ECHETMS refer to silane coupling agents. GOPTMS refers to (3-glycidyloxypropyl)trimethoxysilane available from Sigma Aldrich as 440167, from Momentive as CoatOSil MP200, or from Silquest as SIG5840.0. ECHETMS refers to 2-(2,4-epoxycyclohexyl)ethyltrimethoxysilane available from Gelest as SIE4670.0 or from Momentive as Silquest A186. Nanopox C620 refers to silica nanoparticles comprising a mean effective diameter of 20 nm in a 40 wt % solution in a cycloaliphatic epoxy resin available from Evonik as Nanopox C620.

In Tables 4-5, Examples H-I and O-V comprised from 50 wt % to 96 wt % polymer complex of composition. Examples J-N and W comprised free GPOSS. Examples V-W comprised from 30 wt % to 60 wt % of the nanoparticle solution, Nanopox C620, along with either a polymer complex or free GPOSS. Examples H, J, and L comprised a polymeric linker, namely CAPA 3050, which serves both to link GPOSS and/or polymer complexes and as a reactive diluent. Examples H-P and V-W comprised a non-polymeric linker and reactive diluent, namely S06E, TMPO, and/or Curalite OX, in a total amount from 20 wt % to 48 wt %. Examples H-P and R-S comprised a reactive diluent that is not a linker in an amount from 5 wt % to 9.6 wt % because M142 and IBOA only comprised a single functional group. Examples H-W comprised PI6976 as a cationic photoinitiator in an amount from 2 wt % to 4 wt %. Examples R-U further comprised TPO-L as a free radical photoinitiator. Examples M-N comprised a silane coupling agent. Examples H-U are solvent-free while Examples V-W comprised solvent in the Nanopox C620 solution. Examples H-I, O, and P-V comprised a weight ratio of polymer to all GPOSS of about 0.65 and a mol ratio of polymer to all GPOSS of about 0.5. Example P comprised a weight ratio of polymer to about 0.428.

TABLE 4
Final composition ranges (wt %)

| Example | H | I | J | K | L | M | N | O |
|---|---|---|---|---|---|---|---|---|
| GPOSS | 0 | 0 | 53 | 50 | 55 | 58 | 58 | 0 |
| GPOSS/ | 53 | 50 | 0 | 0 | 0 | 0 | 0 | 58 |
| PDMS 2/ | | | | | | | | |
| GPOSS | | | | | | | | |
| CAPA 3050 | 5 | 0 | 5 | 0 | 3 | 0 | 0 | 0 |
| S06E | 20 | 28 | 20 | 20 | 20 | 15 | 15 | 20 |
| Curalite OX | 20 | 20 | 20 | 28 | 20 | 20 | 20 | 20 |
| PI6976 | 2 | 2 | 2 | 2 | 2 | 2 | 2 | 2 |
| GOPTMS | 0 | 0 | 0 | 0 | 0 | 5 | 0 | 0 |
| ECHETMS | 0 | 0 | 0 | 0 | 0 | 0 | 5 | 0 |

TABLE 5
Final composition ranges (wt %)

| Example | P | Q | R | S | T | U | V | W |
|---|---|---|---|---|---|---|---|---|
| GPOSS | 0 | 0 | 0 | 0 | 0 | 0 | 0 | 26 |
| GPOSS/ | 0 | 96 | 91.1 | 86.6 | 86.6 | 82 | 36 | 0 |
| PDMS 2/ | | | | | | | | |
| GPOSS | | | | | | | | |
| GPOSS/ | 58 | 0 | 0 | 0 | 0 | 0 | 0 | 0 |
| PPO/ | | | | | | | | |
| GPOSS | | | | | | | | |
| Nanopox | 0 | 0 | 0 | 0 | 0 | 0 | 30 | 60 |
| C620 | | | | | | | | |
| S06E | 20 | 0 | 0 | 0 | 0 | 0 | 0 | 0 |
| TMPO | 0 | 0 | 0 | 0 | 0 | 0 | 10 | 10 |
| Curalite OX | 20 | 0 | 0 | 0 | 0 | 0 | 20 | 20 |
| M142 | 0 | 0 | 5 | 9.6 | 0 | 0 | 0 | 0 |
| IBOA | 0 | 0 | 0 | 0 | 9.6 | 14.5 | 0 | 0 |
| PI6976 | 2 | 4 | 3.8 | 3.6 | 3.6 | 3.3 | 4 | 4 |
| TPO-L | 0 | 0 | 0.1 | 0.2 | 0.2 | 0.2 | 0 | 0 |

In Table 6, Examples AA-CC comprise Comparative Examples. Examples AA-BB comprised GPOSS without a linker. Example CC comprised silica nanoparticles and a linker but does not contain any functionalized oligomeric silsesquioxane.

As used in Tables 7-10, DBU, TEA, pyridine, TMG, and DMP are curing catalysts. “DBU” refers to 1,8-diazabicyclo[5.4.0]undec-7-ene available from Sigma Aldrich as 803282. “TEA” refers to triethylamine available from Sigma Aldrich as 808352. Pyridine is available from Sigma Aldrich as 270970. “TMG” refers to tetramethylguanidine available from Sigma Aldrich as 241768. “DMP” refers to 2,4,6-tri(dimethylaminomethyl)phenol available from Sigma Aldrich as T58203. DBU, TEA, TMG, and DMP comprise tertiary amines. As used in Tables 7-10, HAD, TMD, IPDA, AEP, DMDC, MXDA, N4, and MHHPA are non-polymeric linkers. “HAD” refers to refers to 1,6-hexanediamine available from Sigma Aldrich as H11696. “TMD” refers to trimethylhexamethylenediamine available from Spectrum Chemical as TCI-T0600. “IPDA” refers to isophorone diamine available from Sigma Aldrich as 8.14123. “AEP” refers to n-aminoethylpiperazine available from Sigma Aldrich as A55209. “DMDC” refers to 4,4′-methylene-bis(2-methylcyclohexylamine) available from Sigma Aldrich as 369500. “TTD” refers to 4,7,10-trioxa-1,13-tridecanediamine available from Sigma Aldrich as 369519. “MXDA” refers to m-xylenediamine available from Sigma Aldrich as X1202. “N4” refers to N,N′-bis(3-aminopropyl)ethylenediamine available from Fischer Scientific as B195225ML. “MHHPA” refers to methylhexahydrophthalic anhydride available from Sigma Aldrich as 149934. TMD, IPDA, AEP, TTD, MXDA, and N4 are amine functionalized linkers while MHHPA is an anhydride functionalized linker. As used in Tables 7-10, PPO, D400, and T403 are polymeric linkers. “D400” refers to diamino poly(propylene glycol) available from Huntsman as Jeffamine D-400 comprising a number average molecular weight (Mn) of about 430 Daltons. “T403” refers to trimethylolpropane tris[amine terminated poly(propylene glycol)] available from Huntsman as Jeffamine T-403 comprising a number average molecular weight (Mn) of about 440 Daltons. PPO, D400, and T403 are amine functionalized polymeric linkers. T403 is a tri-functional polymeric linker.

TABLE 6
Final composition ranges (wt %)

| Example | AA | BB | CC |
|---|---|---|---|
| GPOSS | 92.55 | 50.00 | 0 |
| Nanopox | 0 | 0 | 56 |
| C620 | | | |
| TMPO | 0 | 0 | 40 |
| TPSHFA | 3.72 | 2.00 | 0 |
| PI6976 | 0 | 0 | 4 |
| Propylene | 3.73 | 0 | 0 |
| Carbonate | | | |
| Butanone | 0 | 30.00 | 0 |
| Methanimine | 0 | 14.00 | 0 |

TABLE 7
Final composition ranges (wt %)

| Example | AAA | BBB | CCC | DDD | EEE | FFF |
|---|---|---|---|---|---|---|
| GPOSS | 98 | 85 | 83 | 83 | 83 | 91 |
| DBU | 2 | 0 | 2 | 0 | 0 | 0 |
| TEA | 0 | 0 | 0 | 0 | 0 | 0 |
| Pyridine | 0 | 0 | 0 | 2 | 0 | 0 |
| TMG | 0 | 0 | 0 | 0 | 2 | 2 |
| HAD | 0 | 15 | 15 | 15 | 15 | 7 |

In Tables 7-10, Examples AAA-YYY and AAAA-FFFF comprised GPOSS (e.g., free GPOSS) from about 24 wt % (Example QQQ) to about 83 wt % (Example PPP) with Examples AAA-PPP, RRR-YYY, and AAAA-FFFF comprised GPOSS from about 50 wt % (Example XXX) to about 83 wt % (Example PPP). Examples GGGG-HHHH comprised cross-linked GPOSS rather than free GPOSS. Example AAA comprises a curing catalyst (i.e., DBU) without a linker. Examples BBB, GGG, IIII, and KKK comprised a linker without a curing catalyst. Examples CCC-FFF, HHH, JJJ, LLL-YYY and AAAA-HHHH comprised at curing catalyst in combination with at least one linker. Examples BBB-XXX, AAAA-DDDD, and FFFF-HHH comprised amine functionalized linkers while Examples YYY and EEEE comprised anhydride functionalized linkers. Examples BBB-EEE, GGG-XXX, AAAA-DDDD, and FFFF-HHHI comprised from about 15 wt % o to about 31 wt % o of the amine-functionalized linker. Examples TTT-XXX and CCCC-DDDD, and FFFF-FHTHH comprised TMIPO. Examples RRR-XXX comprise a mass ratio of polymer to all GPOSS in arange from about 0.288 (Example RRR) to about 0.495 (Example FFFF) and a mol ratio of polymer to all GPOSS in a range from about 1.02 (Example RRR) to about 1.54 (Example XXX) (e.g., about 1 or more). Examples AAAA-DDDD and FFFF comprise a mass ratio of polymer to all GPOS in a range from about 0.28 (Examples AAAA-BBBB) to about 0.33 (Examples CCCC-DDDD and FFFF) and a mol ratio of polymer to all GPOSS in a range from about 0.89 (Examples AAAA) to about 1.01 (Examples CCCC-DDDD and FFFF). Examples FFFF-GGGG comprise a mass ratio of polymer to all GPOSS of about 1.335 and a mol ratio from about 1.65 to about 1.67. Examples GGGG-HHHH comprise about 70 wt % o of a polymer complex.

TABLE 8
Final composition ranges (wt %)

| Example | GGG | HHH | III | JJJ | KKK | LLL | MMM | NNN | OOO |
|---|---|---|---|---|---|---|---|---|---|
| GPOSS | 81 | 80 | 80 | 79 | 79 | 78 | 73 | 84 | 74 |
| DMP | 0 | 1 | 0 | 1 | 0 | 1 | 1 | 1 | 1 |
| TMD | 19 | 19 | 0 | 0 | 0 | 0 | 0 | 0 | 0 |
| IPDA | 0 | 0 | 20 | 20 | 0 | 0 | 0 | 0 | 0 |
| AEP | 0 | 0 | 0 | 0 | 21 | 22 | 0 | 0 | 0 |
| DMDC | 0 | 0 | 0 | 0 | 0 | 0 | 26 | 0 | 0 |
| N4 | 0 | 0 | 0 | 0 | 0 | 0 | 0 | 15 | 0 |
| TTD | 0 | 0 | 0 | 0 | 0 | 0 | 0 | 0 | 25 |

TABLE 9
Final composition ranges (wt %)

| Example | PPP | QQQ | RRR | SSS | TTT | UUU | VVV | WWW | XXX |
|---|---|---|---|---|---|---|---|---|---|
| GPOSS | 82.4 | 24.9 | 77.0 | 69.0 | 69.4 | 63.3 | 58.0 | 53.7 | 49.9 |
| DMP | 0.8 | 0.3 | 0.8 | 0.7 | 0.7 | 0.6 | 0.6 | 0.5 | 0.5 |
| MXDA | 16.8 | 0 | 0 | 0 | 0 | 0 | 0 | 0 | 0 |
| PPO | 0 | 74.8 | 0 | 0 | 0 | 0 | 0 | 0 | 0 |
| D400 | 0 | 0 | 22.2 | 0 | 22.9 | 23.5 | 24.0 | 24.4 | 24.7 |
| T403 | 0 | 0 | 0 | 30.3 | 0 | 0 | 0 | 0 | 0 |
| TMPO | 0 | 0 | 0 | 0 | 7.0 | 12.6 | 17.4 | 21.4 | 24.9 |

TABLE 10
Final composition ranges (wt %)

| Example | YYY | AAAA | BBBB | CCCC | DDDD | EEEE | FFFF | GGGG | HHHH |
|---|---|---|---|---|---|---|---|---|---|
| GPOSS | 53.6 | 76.9 | 76.7 | 69.4 | 69.6 | 53.4 | 69.7 | 0 | 0 |
| GPOSS/ | 0 | 0 | 0 | 0 | 0 | 0 | 0 | 69.6 | 69.7 |
| PDMS 1/ | | | | | | | | | |
| GPOSS | | | | | | | | | |
| DMP | 0.5 | 0.8 | 0.8 | 0.7 | 0.7 | 0.5 | 0.7 | 0.7 | 0.7 |
| D400 | 0 | 22.1 | 22.1 | 22.5 | 22.5 | 0 | 22.6 | 22.5 | 22.6 |
| MHHPA | 45.9 | 0 | 0 | 0 | 0 | 45.8 | 0 | 0 | 0 |
| TMPO | 0 | 0 | 0 | 7.0 | 7.0 | 0 | 7.0 | 7.0 | 7.0 |
| PDMS 1 | 0 | 0.2 | 0.4 | 0.4 | 0.2 | 0.3 | 0 | 0.2 | 0 |

The properties reported in Tables 11, 13-16, and 18 for Examples A-G, M-N, AA-CC, and JJ-RR were measured for coatings formed by curing the corresponding compositions of Tables 3-6 by irradiating the coating with a 365 nm LED with a power density of 2.54 J/cm² by irradiating the composition for 5 minutes followed by being heated in an oven at 100° C. for 30 minutes. The properties reported in Tables 11 and 19 for Examples H-K, O, and Q-W were measured for coatings formed by curing the corresponding compositions of Tables 3-6 by irradiating the coating with a 365 nm LED with a power density of 2.54 J/cm² by irradiating the composition for 5 minutes without any subsequent heat treatment. The properties reported in Table 19 for Examples P and L were measured for coatings formed by curing the corresponding compositions of Tables 3-6 by irradiating the coating with a 365 nm LED with a power density of 2.54 J/cm² by irradiating the composition for 5 minutes followed by being heated in an oven at 65° C. or 85° C., respectively for 30 minutes. The properties reported in Tables 13-14 and 16-17 for Examples AAA-YYY and AAAA-HHHH were heated for 30 minutes at the temperature reported in Tables 16-17 without any irradiation. Unless indicated otherwise, the composition was deposited on the surface by drawing an applicator configured to produce a thickness of 25.4 μm across the surface of the substrate before curing the composition.

As shown in Table 11, Examples A-B and O comprised a tensile strength of about 26 MPa or more (e.g., in a range from about 26 MPa to about 67.5 MPa) while Examples A-B, E and O comprised a tensile strength of greater than 21 MPa. Examples A-B and O comprised an ultimate elongation of 4% or more (e.g., in a range from 4% to 8%) while Example A-B, E and O comprised an ultimate elongation greater than 3%. Example O comprised an elastic modulus of 1,905 MPa, Example A comprises an elastic modulus of 1,270 MPa, Example E comprises an elastic modulus of 829 MPa, and Example B comprises an elastic modulus of 680 MPa.

In Table 12, the viscosity of the compositions before curing is presented. Examples J-K comprised a viscosity of less than 1 Pa-s. Examples E-F and R-T comprised a viscosity from about 7 Pa-s to about 16 Pa-s. Example Q comprises a viscosity of 41.8 Pa-s.

TABLE 11
Properties of coatings

| Example | A | B | E | O | AA | BB |
|---|---|---|---|---|---|---|
| Tensile Strength (MPa) | 36.9 | 26.5 | 21.9 | 67.4 | 55 | — |
| Ultimate Elongation | 4.1 | 5.8 | 3.4 | 8.0 | 6.5 | — |
| (%) | | | | | | |
| Elastic Modulus (MPa) | 1,270 | 680 | 829 | 1,905 | 1,430 | 3,300 |

TABLE 12
Viscosity of compositions

| Example | Viscosity (Pa-s) |
|---|---|
| E | 15.6 |
| F | 14.0 |
| J | 0.3 |
| K | 0.2 |
| Q | 41.8 |
| R | 18.4 |
| S | 9.8 |
| T | 7.7 |

As shown in Table 13, Example AA comprised a contact angle of 62° while Example BB comprised a contact angle of 99°. Examples E-F, PPP-SSS, CCCC-DDDD, and FFFF-HHHH comprised intermediate contact angles (e.g., 98°, 68°, 60°, 60°, 98°, 97°, 60°, 97°, and 93°, respectively). The PDMS polymer of Example E increases the contact angle relative to Examples F, AA, BBBB-DDDD, and GGGG-HHHH while the poly(propylene oxide) polymer of Examples F and FFFF only slightly increases the contact angle relative to Example AA. Examples F and FFFF comprises a rough surface relative to the other examples, which accounts for the lower contact angle than the other Examples with a PDMS polymer (e.g., PDMS 1-PDMS4).

TABLE 13
Contact angles of coatings

| Example | Contact Angle |
|---|---|
| E | 98° |
| F | 68° |
| AA | 62° |
| BB | 99º |
| PPP | 60° |
| SSS | 60° |
| BBBB | 105° |
| CCCC | 98° |
| DDDD | 97º |
| FFFF | 60° |
| GGGG | 97º |
| HHHH | 93º |

In Table 14, optical properties and the dynamic coefficient for Examples A-B, SSS, and CCCC-HHHH are reported. Examples SSS, CCCC-DDDD, and FFFF-HHHH comprised a dynamic coefficient of friction from about 0.38 to about 0.78 (e.g., less than 0.8). Examples CCCC-DDDD and GGGG-HHHH comprised a dynamic coefficient of friction less than about 0.5. As noted above, the rough surface of Example FFFF is responsible for the high dynamic coefficient of friction. Examples A-B, SSS, CCCC-DDDD, and FFFF-HHHH comprised an average transmittance of about 90% or more averaged over optical wavelengths from 400 nm to 700 nm. Examples A-B and FFFF comprised an average transmittance of about 92% or more averaged over optical wavelengths from 400 nm to 700 nm. Examples A-B, CCCC, and FFFF-GGGG comprised a haze from about 0.15% to about 0.9% (e.g., less than about 1%). Examples A-B and FFFF-HHHH comprised a haze from about 0.15% to about 0.3% (e.g., less than about 0.5%, less than about 0.3%). Examples A-B comprised a yellowing index of about 0.6 or less, and about 0.55 or less. Examples SSS, CCCC-DDDD, and FFFF-HHHH comprised a CIE b* value from about 0.2 to about 0.4. Examples SSS and FFF-HHH comprised a CIE b* value from about 0.2 to about 0.3 (e.g., about 0.3 or less) while Examples CCCC-DDDD comprised a CIE b* value from about 0.35 to about 0.4 (e.g., about 0.4 or more).

TABLE 14
Properties of coatings (as-formed)

| | Dynamic | Transmittance | | | Yellowing |
|---|---|---|---|---|---|
| Example | COF | (%) | Haze (%) | CIE b* | Index |
| A | — | 92 | 0.27% | — | 0.52 |
| B | — | 92 | 0.24% | — | 0.49 |
| SSS | 0.685 | 91 | — | 0.26 | — |
| CCCC | 0.382 | 91 | 0.9% | 0.39 | — |
| DDDD | 0.381 | 91 | — | 0.35 | — |
| FFFF | 0.775 | 92 | 0.16% | 0.21 | — |
| GGGG | 0.413 | 91 | 0.28% | 0.22 | — |
| HHHH | 0.436 | 91 | 0.19% | 0.23 | — |

Examples JJ-LL correspond to Examples A-B and AA, respectively, but curing the composition comprises irradiating the coating with a 365 nm LED with a power density of 2.54 J/cm² by irradiating the composition for 5 minutes without subsequently heating the composition. Examples MM-GO correspond to Examples A-B and AA, respectively but curing the composition comprises irradiating the coating with a 365 nm LED with a power density of 13.44 J/cm² by irradiating the composition for 5 minutes without subsequently heating the composition. Examples PP-RR correspond to Examples A-B and AA, respectively, but curing the composition comprises irradiating the coating with a 365 nm LED with a power density of 13.44 J/cm² by irradiating the composition for 5 minutes followed by being heated in an oven at 100° C. for 30 minutes. Examples AAA-YYY and AAAA-HHHH were not irradiated; instead AAA-YYY and AAAA-HHHH were heated in an oven at 150° C. for 30 minutes. Examples FFF-100 through KKK-100 correspond to the composition of Examples FFF-KKK but Examples FFF-100 through KKK-100 were heated in an oven at 100° C. for 30 minutes instead of at 150° C.

The adhesion values reported in Table 15 were measured using the cross-hatch adhesion test, described above, for the samples as-formed without further treating the Examples. Examples B, AA, KK-LL NN-OO, RR, BBB-EEE, GGG-MMM, FFF-100-KKK-100, RRR, TTT-YYY, AAAA-DDDD, and FFFF-HHHH comprised an adhesion of 3B or more. Examples LL, OO, BBB-EEE, GGG-MMM, FFF-100-III-100, RRR, TTT-YYY, CCCC, and FFFF-HHHH comprised an adhesion of 4B or more. Examples GGG-JJJ, FFF-100-JJJ-100, TTT-YYY, and FFFF-HHHH comprised an adhesion of 5B. Examples A-B, AA-BB, JJ-RR, BBB, FFF, LLL-MMM, OOO-PPP, and SSS comprised a pencil hardness of about 5H or more. Examples A-B, AA-BB, JJ-RR, FFF, LLL-MMM, and OOO-PPP comprised a pencil hardness of about 6H or more. Examples A-B, BB, JJ-KK, and MM-QQ comprised a pencil hardness of 7H or more. Examples B, BBB, JJ-KK, and MM-RR comprised a pencil hardness of 8H or more. Examples B, BB, JJ-KK, MM-NN, and PP-QQ comprised a pencil hardness of 9H or more. Examples B, KK-LL, NN, RR, BBB, and LLL-MMM comprised both a pencil hardness of 5H or more and an adhesion of 3B or more. Examples B, KK, NN-OO, and RR comprised both a pencil hardness of 8H or more and an adhesion of 3B or more. Examples LL, OO, BBB, and LLL-MMM comprised both a pencil hardness of 5H or more and an adhesion of 4B or more. Examples LL, OO, and LL-MMM comprised both a pencil hardness of 6H or more and an adhesion of 4B or more. Example BBB comprises both a pencil hardness of 5H or more and an adhesion of 4B or more. Example NNN cracked during curing. Example QQQ phase separated such that a homogeneous coating could not be formed.

Providing a linker increases the pencil hardness of the coating (comparing Example AAA to Examples BBB-FFF). Providing a curing catalyst can increase the pencil hardness of the coating (comparing Examples BBB, III, III-100, KKK, KKK-100 to Examples CCC, JJJ, JJJ-100, LLL). Comparing Examples QQQ-SSS, D400 (Example RRR) of the polymeric linkers provides the highest adhesion. Adding TMPO increases the adhesion and pencil hardness of the coating (comparing Example RRR to Examples TTT-XXX). Examples GGGG-HHHH comprised GPOSS linked by PDMS 1 before curing, which provides a pencil hardness of about 4H or more and an adhesion of 5B or more.

TABLE 15
Hardness, adhesion, and thickness of coatings (as-formed)

| | Pencil | | |
|---|---|---|---|
| Example | Hardness | Adhesion | Curing Conditions |
| A | 7H | 0B | 365 nm 2.54 J/cm² 5 min. + |
| | | | 100° C. 30 min. |
| B | 9H | 3B | 365 nm 2.54 J/cm² 5 min. + |
| | | | 100° C. 30 min. |
| AA | 6H | 3B | 365 nm 2.54 J/cm² 5 min. + |
| | | | 100° C. 30 min. |
| BB | 9H | 0B | 2.54 J/cm² 5 min. + 100° C. |
| | | | 30 min. |
| JJ | 9H | 1B | 365 nm 2.54 J/cm² 5 min. |
| KK | 9H | 3B | 365 nm 2.54 J/cm² 5 min. |
| LL | 6H | 4B | 365 nm 2.54 J/cm² 5 min. |
| MM | 9H | 0B | 365 nm 13.44 J/cm² 5 min. |
| NN | 9H | 3B | 365 nm 13.44 J/cm² 5 min. |
| OO | 8H | 4B | 365 nm 13.44 J/cm² 5 min. |
| PP | 9H | 0B | 365 nm 13.44 J/cm² 5 min. + |
| | | | 100° C. 30 min. |
| QQ | 9H | 0B | 365 nm 13.44 J/cm² 5 min. + |
| | | | 100° C. 30 min. |
| RR | 8H | 3B | 365 nm 13.44 J/cm² 5 min. + |
| | | | 100° C. 30 min. |
| AAA | <6B | 2B | 150° C. 30 min. |
| BBB | 5H | 4B | 150° C. 30 min. |
| CCC | 3H | 4B | 150° C. 30 min. |
| DDD | 3H | 4B | 150° C. 30 min. |
| EEE | 3H | 4B | 150° C. 30 min. |
| FFF-100 | 4H | 5B | 100° C. 30 min. |
| FFF | 6H | 0B | 150° C. 30 min. |
| GGG-100 | 2H | 5B | 100° C. 30 min. |
| GGG | 1H | 5B | 150° C. 30 min. |
| HHH-100 | 2H | 5B | 100° C. 30 min. |
| HHH | 3H | 5B | 150° C. 30 min. |
| III-100 | 2H | 5B | 100° C. 30 min. |
| III | 2H | 5B | 150° C. 30 min. |
| JJJ-100 | 3H | 5B | 100° C. 30 min. |
| JJJ | 3H | 5B | 150° C. 30 min. |
| KKK-100 | 3H | 4B | 100° C. 30 min. |
| KKK | 3H | 4B | 150° C. 30 min. |
| LLL | 6H | 4B | 150° C. 30 min. |
| MMM | 6H | 4B | 150° C. 30 min. |
| NNN | cracked | cracked | 150° C. 30 min. |
| OOO | 6H | 0B | 150° C. 30 min. |
| PPP | 6H | 0B | 150° C. 30 min. |
| QQQ | separate | separate | 150° C. 30 min. |
| RRR | 2H | 4B | 150° C. 30 min. |
| SSS | 5H | 1B | 150° C. 30 min. |
| TTT | 3H | 5B | 150° C. 30 min. |
| UUU | 3H | 5B | 150° C. 30 min. |
| VVV | 3H | 5B | 150° C. 30 min. |
| WWW | 3H | 5B | 150° C. 30 min. |
| XXX | 3H | 5B | 150° C. 30 min. |
| YYY | 3H | 5B | 150° C. 30 min. |
| AAAA | 1H | 3B | 150° C. 30 min. |
| BBBB | 2H | 3B | 150° C. 30 min. |
| CCCC | 1H | 4B | 150° C. 30 min. |
| DDDD | 1H | 3B | 150° C. 30 min. |
| FFFF | 2H | 5B | 150° C. 30 min. |
| GGGG | 4H | 5B | 150° C. 30 min. |
| HHHH | 4H | 5B | 150° C. 30 min. |

The adhesion values reported in Tables 16-17 were measured using the cross-hatch adhesion test, described above, after the coating (e.g., coated article) has been maintained for 10 days in a 95% relative humidity, 65° C. environment. The coatings of the Examples reported in Table 16 were deposited without a surface treatment or silane coupling agent. Examples A-B, JJ-KK, and MM-RR comprised a pencil hardness of 7H or more. Examples B, JJ-KK, MM-NN, and PP-QQ comprised a pencil hardness of 9H. Examples B, JJ-LL, NN-OO, and RR comprised an adhesion of 1B or more. Examples B, KK-LL, NN-OO, and RR comprised an adhesion of 3B or more. Examples LL and OO comprised an adhesion of 4B. Examples A, MM, and PP-QQ comprised an adhesion of OB. Comparing Examples A-B, AA, JJ-LL with Examples MM-RR, the total energy density in irradiating the composition does not significantly change the resulting adhesion, although the hardness may be slightly higher with the higher total energy density. This is unexpected since it was expected that increasing the total energy density up to 10 J/cm² or even 20 J/cm² or more would significantly increase adhesion and/or hardness. Consequently, the pencil hardness and adhesion from the compositions cured by irradiating with a total energy density of 2.54 J/cm² provides the unexpected benefit of reducing the energy and time required while producing the corresponding properties of the coating. The Examples in Table 16 based on Example B (i.e., Examples B, KK, NN, and QQ) comprised a hardness of 9H while the Examples in Table 6 based on Example AA (i.e., Examples AA, LL, OO, and RR) comprised a hardness of 8H or less.

Examples AA-CC are Comparative Examples. Unlike Examples A-W, Example AA does not contain any polymer. It was still possible to form a coating using the methods described above, and the composition is visually transparent. However, the Examples based on Example AA (i.e., Examples AA, LL, OO, and RR) comprised a hardness of 8H or less, which is less than the 9H hardness achieved for the Examples based on Example B (i.e., Examples B, KK, NN, and QQ). Unlike Examples A-W, Example BB comprises a polymer with a functional group at only one end of the polymer chain but not both ends. Consequently, the polymer of Example BB cannot attach a first functionalized oligomeric silsesquioxane to another functionalized oligomeric silsesquioxane. Indeed, the composition for Example BB was not visually transparent when the solvent was removed. Rather, the composition for Example BB when the solvent was removed was an opaque white, which could be the result of aggregation of the functionalized oligomeric silsesquioxanes. Example BB could not be applied in the same method described for Examples A-G to form a coating because an irregular and/or fragmented coating would form. Consequently, a coating based on Example BB needed to be cured using a multi-step heating process to evaporate the solvent mixture over 8 hours or more, which is significantly longer than the 5 minute UV-radiation and even the 30-minute heating that some of Examples A-W and JJ-RR were subjected to. Example BB comprised an adhesion of OB because it could not withstand 10 days in a 95% relative humidity, 65° C. environment without visible delamination or cracking. Unlike Examples A-W, Example CC does not comprise any functionalized oligomeric silsesquioxanes. Instead, Example CC comprises silica nanoparticles and a linker. While Example CC comprises an adhesion of 5B, Example CC comprises a hardness of OH, which is lower than the other examples. Consequently, Example CC would not be suitable as a hard coating.

TABLE 16
Hardness, adhesion, and thickness of coatings
(10 days at 65° C., 95% relative humidity)

| | Pencil | | Coating |
|---|---|---|---|
| Example | Hardness | Adhesion | Thickness (μm) |
| A | 7H | 0B | 48.6 |
| B | 9H | 3B | 24.9 |
| AA | 6H | 3B | 24.8 |
| BB | 9H | 0B | 50.0 |
| JJ | 9H | 1B | 32.6 |
| KK | 9H | 3B | 35.7 |
| LL | 6H | 4B | 33.6 |
| MM | 9H | 0B | 30.0 |
| NN | 9H | 3B | 34.3 |
| OO | 8H | 4B | 41.2 |
| PP | 9H | 0B | 40.9 |
| QQ | 9H | 0B | 33.2 |
| RR | 8H | 3B | 37.5 |

Table 17 presents the adhesion of Examples, A-B, AA-BB, and SS-ZZ as well as the treatment conditions for the surface of the glass substrate before the coating is formed. APTMS refers to (3-aminopropyl)trimethoxysilane available from Sigma Aldrich as 281778. GOPTMS refers to (3-glycidyloxypropyl)trimethoxysilane available from Sigma Aldrich as 440167, from Momentive as CoatOSil MP2OO, or from Silquest as SIG5840.0. ECHETMS refers to 2-(2,4-epoxycyclohexyl)ethyltrimethoxysilane available from Gelest as SIE4670.0 or from Momentive as Silquest A186. TEPSA refers to (3-triethoxysilyl)propyl succinic anhydride available from Gelest as SIT8192.6. MPTMS refers to (3-mercaptopropyl)trimethoxysilane available from Gelest as SIM6476.0. Examples S-Z comprised the coating of Example D attached to the substrate using the treatment indicated in Table 17. The plasma treatment for Examples TT, VV, XX, and ZZ was conducted before any silane coupling agent was deposited and comprised exposing the surface (e.g., first major surface) of the substrate to atmospheric air plasma for 1 minute in a 25° C. environment.

As shown in Table 17, Examples A, BB, SS, UU WW, and YY comprised an adhesion of OB and did not have a plasma treatment prior to depositing the silane coupling agent. Examples TT and ZZ comprised an adhesion of 1B or more with a plasma treatment before depositing the silane coupling agent while Examples VV and XX comprised an adhesion of OB even though there was a plasma treatment prior to depositing the silane coupling agent. This demonstrates an unexpected benefit from APTMS and TEPSA in that those silane coupling agents can improve the adhesion of the coating while other silane coupling agents did not even in combination with the plasma treatment. Also, the results in Table 17 demonstrate that providing a surface treatment (e.g., plasma treatment) before depositing the silane coupling agent can improve the adhesion of the coating.

TABLE 17
Surface treatment, hardness, and adhesion of coatings
(10 days at 65° C., 95% relative humidity)

| | Plasma | Silane Coupling | | | |
|---|---|---|---|---|---|
| Example | Treatment | Agent | Primer | Hardness | Adhesion |
| A | No | No | No | 7H | 0B |
| B | No | No | No | 9H | 3B |
| AA | No | No | No | 6H | 3B |
| BB | No | No | No | 9H | 0B |
| CC | No | No | No | 0H | 5B |
| SS | No | APTMS | No | — | 0B |
| TT | Yes | APTMS | No | — | 1B |
| UU | No | GOPTMS | No | — | 0B |
| VV | Yes | GOPTMS | No | — | 0B |
| WW | No | ECHETMS | No | — | 0B |
| XX | Yes | ECHETMS | No | — | 0B |
| YY | No | TEPSA | No | — | 0B |
| ZZ | Yes | TEPSA | No | — | 3B |

TABLE 18
Surface treatment, hardness, and adhesion of coatings (as formed)

| | Plasma | Silane Coupling | | | |
|---|---|---|---|---|---|
| Example | Treatment | Agent | Primer | Hardness | Adhesion |
| H | No | No | MPTMS | 8H | 4B |
| I | No | No | MPTMS | 8H | 3B |
| J | No | No | No | 7H | 5B |
| K | No | No | No | 8H | 5B |
| L | No | No | No | 7H | 1B |
| M | Yes | GOPTMS | No | 9H | 3B |
| N | Yes | ECHETMS | No | 9H | 1B |
| O | No | No | MPTMS | 9H | 4B |
| P | Yes | No | MPTMS | 9H | 2B |
| Q | No | No | No | 7H | 3B |
| R | No | No | No | 9H | 2B |
| S | No | No | No | 9H | 3B |
| T | No | No | No | 9H | 4B |
| U | No | No | No | 9H | 3B |
| V | No | No | No | 4H | 4B |
| W | No | No | No | 6H | 4B |

Unlike in Table 17, the adhesion and hardness measurements reported in Table 18 were measured on coatings of coated articles as-formed. The substrate of Examples M-N and P were treated with plasma before the composition was deposited. Examples H-I and O were coated with a 2 wt % o solution of the thiol-functionalized silane coupling agent, MPTMS, and heated at 100° C. for 30 minutes. Examples M-N comprised a silane coupling agent in the composition, as shown in Table 4. Examples H-U comprised a hardness of 7H or more. Examples H-I, K, M-P, and R-U comprised a hardness of 8H or more. Examples M-P and R-U comprised a hardness of 9H. Examples H-W comprised an adhesion of 1B or more. Examples H-K, M, and O-W comprised an adhesion of 2B or more. Examples H-K, M, O, Q, and S-W comprised an adhesion of 3B more. Examples H, J-K, O, T, and V-W comprised an adhesion of 4B or more. Examples J-K comprised an adhesion of 5B. Examples H-K, M, and O, Q, S-U comprised both a hardness of 7H or more and an adhesion of 3B or more. Examples H, K, O, and T comprised both an adhesion of 8H or more and an adhesion of 4B or more.

The adhesion values reported in Table 19 were measured using the cross-hatch adhesion test, described above, after the coating (e.g., coated article) has been maintained for 30 minutes in a 85% relative humidity, 85° C. environment. The coatings of the Examples reported in Table 19 were deposited without a surface treatment or silane coupling agent. Examples GGG-RRR, GGG-100-JJJ-100, TTT-XXX, AAAA-DDDD, and FFFF-HHHH comprised an adhesion of 3B or more. Examples GGG-JJJ, GGG-100-JJJ-100, UUU-VVV, XXX, CCCC-DDDD, and FFFF-HHHH comprised an adhesion of 4B or more. Examples GGG-JJJ, GGG-100-JJJ-100, XXX, DDDD, and GGGG-HHHH comprised an adhesion of 5B or more.

TABLE 19
Hardness, adhesion, and thickness of coatings
(30 min. at 85° C., 85% relative humidity)

| | Pencil | | Curing |
|---|---|---|---|
| Example | Hardness | Adhesion | Conditions |
| GGG-100 | — | 5B | 100° C. 30 min. |
| GGG | — | 5B | 150° C. 30 min. |
| HHH-100 | — | 5B | 100° C. 30 min. |
| HHH | — | 5B | 150° C. 30 min. |
| III-100 | — | 5B | 100° C. 30 min. |
| III | — | 5B | 150° C. 30 min. |
| JJJ-100 | — | 5B | 100° C. 30 min. |
| JJJ | — | 5B | 150° C. 30 min. |
| RRR | 4H | 3B | 150° C. 30 min. |
| SSS | 7H | 0B | 150° C. 30 min. |
| TTT | 3H | 3B | 150° C. 30 min. |
| UUU | 4H | 4B | 150° C. 30 min. |
| VVV | 4H | 4B | 150° C. 30 min. |
| WWW | 3H | 3B | 150° C. 30 min. |
| XXX | 4H | 5B | 150° C. 30 min. |
| AAAA | 1H | 3B | 150° C. 30 min. |
| BBBB | 2H | 3B | 150° C. 30 min. |
| CCCC | 3H | 4B | 150° C. 30 min. |
| DDDD | 2H | 5B | 150° C. 30 min. |
| FFFF | 4H | 4B | 150° C. 30 min. |
| GGGG | 4H | 5B | 150° C. 30 min. |
| HHHH | 4H | 5B | 150° C. 30 min. |

In Table 20, pen drop heights are reported for a coated article resembling coated article 301 shown in FIG. 3. The substrate 103 comprised Composition 1 and substrate thickness 109 of 30 μm. The first portion 321 and the second portion 331 comprised Composition 1 and portion thickness 329 of 30 μm. The coating 113 comprised a coating thickness 119 of 30 μm. The coating was formed by curing the composition of Example E. When the pen drop was conducted on the second surface are 325 of the first portion 321, the median pen drop height was 17 cm. When the pen drop was conducted on the third major surface 115 of the coating 113 extending along the fourth plane 306, the median pen drop height was 16 cm. The Control was the 30 μm thick substrate comprising Composition 1, which comprised a median pen drop height of 7.4 cm. Consequently, providing the coating increased the median pen drop height for both of the areas tested. In particular, the median pen drop height over the coating (i.e., third major surface 115 extending along the fourth plane 306) was only 1 cm (6%) less than the median pen drop height over the first portion.

TABLE 20
Pen drop heights for coated articles

| Example | Median Pen Drop Height (cm) |
|---|---|
| Control | 7.4 |
| Over Coating | 16 |
| Over First Portion | 17 |

The parallel plate distance was measured for a coated article resembling coated article 201 shown in FIGS. 2 and 6. The substrate 203 comprises Composition 1 with a substrate thickness 209 of 100 μm and a central thickness 289 of 30 μm. The coating 113 comprised a coating thickness 119 of 30 μm. The coating was formed by curing the composition of Example E. After 10 days in a 50% relative humidity, 25° C. environment, the coated article achieved a parallel plate distance of 3 mm. Additionally, an as-formed coated article was able to withstand 200,000 cycles of bending to a parallel plate distance of 3 mm.

The above observations can be combined to provide compositions, coatings, and coated articles comprising a plurality of functionalized oligomeric silsesquioxanes and methods of making the same. The plurality of functionalized oligomeric silsesquioxanes can provide good scratch resistance and/or a high pencil hardness (e.g., about 5H or more, about 7H or more, about 9H or more). Providing the plurality of functionalized oligomeric silsesquioxanes can react with the first functional group and/or the second functional group of a linker (e.g., polymer). An extent of functionalization of plurality of functionalized oligomeric silsesquioxanes can facilitate the bonding of the linker (e.g., polymer) to two different functionalized oligomeric silsesquioxanes of the plurality of functionalized oligomeric silsesquioxanes. Providing the coating on a substrate increases a durability of the coated article, for example, by filling and/or protecting surface flaws in the substrate from damage. Additionally, the substrate may comprise a glass-based substrate and/or a ceramic-based substrate to enhance puncture resistance and/or impact resistance. Further, the glass-based substrate and/or ceramic-based substrate may be chemically strengthened to further enhance impact resistance and/or puncture resistance of the coated article while simultaneously facilitating good bending performance.

Compositions can comprise a linker (e.g., polymer) with functional groups at opposite ends of the linker (e.g., polymer), where the functional groups reacted with functionalized oligomeric silsesquioxanes. The linker can comprise a polymer, which can reduce (e.g., prevent) aggregation of the plurality of functionalized oligomeric silsesquioxanes, which can provide good optical properties (e.g., high transmittance, low haze) and, as a coating, good durability and/or good adhesion to a substrate. Providing a linker (e.g., polymer) comprising an oxygen atom in a backbone of the linker (e.g., polymer) can increase a flexibility of the linker, the resulting composition, and the resulting coating, which can increase the ultimate elongation, durability, and/or impact resistance (e.g., pen drop height). Providing a linker comprising a polymer with a number-average molecular weight (Mn) in a range from about 400 Daltons to about 30,000 Daltons can prevent agglomeration of the functionalized oligomeric silsesquioxanes attached thereto while reducing entanglement of the polymers, which can inhibit manufacturability of the resulting coating and/or coated article. Providing a low mol ratio (e.g., about 0.06 or less) of the linker (e.g., polymer) to the plurality of functionalized oligomeric silsesquioxanes can produce linkers (e.g., polymers) bonded to two functionalized oligomeric silsesquioxanes, which can achieve the benefits described above. Providing a polymer with a glass transition temperature outside of an operating range (e.g., outside of an operating range from about −20° C. to about 60°) of a coated article can enable the coated article to have consistent properties across the operating range. Providing a reactive diluent (e.g., linker not bonded to a functionalized oligomeric silsesquioxane until curing after the composition is disposed on the substrate) can be used to tune a viscosity of the composition, which can facilitate even application and/or enable lower-cost application techniques while reducing the overall cost of the composition and/or coating.

Providing a linker comprising one or more amine and/or anhydride functional groups can provide a coating with good adhesion (e.g., about 4B or more as formed; about 4B or more after being maintained for 10 days in a 50% relative humidity, 25° C. environment; and/or about 4B or more after being maintained from 10 days in a 95% relative humidity, 65° C. environment) to the substrate whether or not a silane coupling agent is used. Providing curing catalyst can increase a hardness of the resulting coating. Providing a composition comprising trimethylolpropane oxetane can increase a hardness of the resulting coating. Coatings can be hydrophobic, have a low dynamic coefficient of friction (i.e., about 0.8 or less, for example, about 0.5 or less), good abrasion resistance, and/or function as an easy to clean (ETC) coating.

Forming the layer from a substantially solvent-free composition can increase its curing rate, which can decrease processing time. Further, a solvent-free composition can reduce (e.g., decrease, eliminate) the use of rheology modifiers and increase composition homogeneity, which can increase the optical transparency (e.g., transmittance) of the resulting coating. Moreover, a solvent-free composition can decrease an incidence of visual defects, for example bubbles from volatile gases as any solvent evaporates, in the resulting coating. Providing a coating method comprising a solvent can enable a wide variety of compositions to be used to form the coating. Further, curing the layer to form the coating by irradiating the layer for a short period of time, which can increase processing efficiency and reduce manufacturing costs. Providing additional functionalized oligomeric silsesquioxanes with the composition to form the layer can further increase the hardness of the resulting coating and/or coated article. Providing compositions free from a photoinitiator (e.g., thermally curable compositions) can be free from yellowing issues. Providing a silane-coupling agent can increase an adhesion of the coating to the substrates (e.g., glass-based substrate, polymer-based substrate). Additionally, the coating can comprise high transmittance (e.g., about 90% or more), low haze (e.g., about 0.5% or less), and/or low yellowing index (e.g., about 0.6 or less). Providing a composition substantially free and/or free of nanoparticles (e.g., silica nanoparticles, alumina nanoparticles) can reduce processing issues (e.g., agglomeration, aggregation, phase separation) with the composition, improve optical properties (e.g., maintain low haze and/or high transmittance even after aging at elevated temperature and/or humidity) of the coating and/or the resulting coating and/or coated article, and reduce mechanical properties (e.g., hardness, modulus, strain) of the resulting coating and/or coated article compared to a corresponding composition, coating, and/or coated article comprising a plurality of functionalized oligomeric silsesquioxanes without nanoparticles (e.g., silica nanoparticles, alumina nanoparticles).

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

1. A coated article comprising:
a substrate comprising a first major surface; and
a coating disposed over the first major surface comprising a plurality of functionalized oligomeric silsesquioxanes, a first functionalized oligomeric silsesquioxane of the plurality of functionalized oligomeric silsesquioxanes is bonded to a second functionalized oligomeric silsesquioxane of the plurality of functionalized oligomeric silsesquioxanes by a linker terminated with a first functional group at a first end of the linker and a second functional group at a second end of the linker opposite the first end of the linker,
wherein the coating comprises a pencil hardness of about 5H or more.

2. The coated article of claim 1, further comprising a silane coupling agent attaching the coating to the first major surface.

3. The coated article of claim 2, wherein the silane coupling agent is selected from a group consisting of (3-triethoxysilyl)propylsuccinic anhydride, (3-mercaptopropyl)trimethoxysilane, and 2-(3,4-epoxycyclohexyl)ethyltrimethoxysilane.

4. The coated article of claim 1, wherein the coating comprises an adhesion to the substrate of about 1B or more after 10 days in a 95% relative humidity, 65° C. environment.

5. The coated article of claim 1, wherein the first functional group is selected from a group consisting of acid alcohols, anhydrides, amides, amines, alcohols, chlorides, cyanides, epoxies, thiols, and magnesium halides, and the second functional group is selected from a group consisting of acid alcohols, anhydrides, amides, amines, alcohols, chlorides, cyanides, epoxies, thiols, and magnesium halides.

6. The coated article of claim 1, wherein the first functional group is selected from a group consisting of alcohols, acrylates, epoxies, and ureidos, and the second functional group is selected from a group consisting of alcohols, acrylates, and epoxies.

7. The coated article of claim 1, wherein a backbone of the linker comprises an oxygen atom.

8. The coated article of claim 1, wherein the plurality of functionalized oligomeric silsesquioxanes comprises a plurality of functionalized polyhedral oligomeric silsesquioxanes (POSS), the first functionalized oligomeric silsesquioxane comprises a first functionalized POSS of the plurality of functionalized POSS, and the second functionalized oligomeric silsesquioxane comprises a second functionalized POSS of the plurality of functionalized POSS.

9. The coated article of claim 1, wherein the first functionalized oligomeric silsesquioxane and/or the second functionalized oligomeric silsesquioxane is functionalized by a glycidyl functional group or an epoxycyclohexyl functional group.

10. The coated article of claim 1, wherein the linker comprises a polymer.

11. The coated article of claim 1, wherein the coated article can achieve a parallel plate distance in a range from about 3 millimeters to about 10 millimeters.

12. The coated article of claim 1, wherein the coated article can achieve a parallel plate distance of 4 millimeters.

13. A method of making a coated article comprising:
depositing a layer comprising a plurality of functionalized oligomeric silsesquioxanes over a first major surface of a substrate, a first functionalized oligomeric silsesquioxane of the plurality of functionalized oligomeric silsesquioxanes is bonded to a second functionalized oligomeric silsesquioxane of the plurality of functionalized oligomeric silsesquioxanes by a linker terminated with a first functional group at a first end of the linker and a second functional group at a second end of the linker opposite the first end of the linker; and
curing the layer to form the coating.

14. The method of claim 13, wherein the first functional group is selected from a group consisting of acid alcohols, anhydrides, amides, amines, alcohols, chlorides, cyanides, epoxies, thiols, and magnesium halides, and the second functional group is selected from a group consisting of acid alcohols, anhydrides, amides, amines, alcohols, chlorides, cyanides, epoxies, thiols, and magnesium halides.

15. The method of claim 13, wherein the plurality of functionalized oligomeric silsesquioxanes comprises a third functionalized oligomeric silsesquioxane that is not bonded to the polymer, the first major surface, or another functionalized oligomeric silsesquioxane of the plurality of functionalized oligomeric silsesquioxanes prior to the curing.

16. A method of making a coated article comprising:
depositing a layer over a first major surface of a substrate, the layer comprising a plurality of functionalized oligomeric silsesquioxanes and a linker, the linker comprising a reactive diluent; and
curing the layer to form the coating, wherein the linker reacts with the plurality of functionalized oligomeric silsesquioxanes to bond a first functionalized oligomeric silsesquioxane of the plurality of functionalized oligomeric silsesquioxanes to a second functionalized oligomeric silsesquioxane of the plurality of functionalized silsesquioxanes, the linker comprising a third functional group bonded to the first functionalized oligomeric silsesquioxane and a fourth functional group bonded to a second functionalized oligomeric silsesquioxane.

17. The method of claim 16, wherein the third functional group is selected from a group consisting of acid alcohols, acrylates, anhydrides, alcohols, epoxies, isocyanates, and ureidos, and the fourth functional group is selected from a group consisting of acid alcohols, acrylates, anhydrides, alcohols, epoxies, isocyanates, and ureidos.

18. The method of claim 14, wherein the plurality of functionalized oligomeric silsesquioxanes comprises a plurality of functionalized polyhedral oligomeric silsesquioxanes (POSS), the first functionalized oligomeric silsesquioxane comprises a first functionalized POSS of the plurality of functionalized POSS, and the second functionalized oligomeric silsesquioxane comprises a second functionalized POSS of the plurality of functionalized POSS.

19. The method of claim 14, wherein the first functionalized oligomeric silsesquioxane and/or the second functionalized oligomeric silsesquioxane is functionalized by a glycidyl functional group or an epoxycyclohexyl functional group.

20. The method of claim 14, wherein the layer further comprises a silane coupling agent.
